(19) United States
(12) Patent Application Publication
(10) Pub. No.: US 2016/0207497 A1
(43) Pub. Date: Jul. 21, 2016

(54) CHILD RESTRAINT SYSTEM

(71) Applicant: Thorley Industries LLC, Pittsburgh, PA (US)

(72) Inventors: Jacob A. Seal, Pittsburgh, PA (US); Arjit Arora, Pittsburgh, PA (US); Elijah A. Richter, Pittsburgh, PA (US); Sean D. Beaudette, Pittsburgh, PA (US); Daniel A. Kanitz, Pittsburgh, PA (US); Henry F. Thorne, Pittsburgh, PA (US); Robert D. Daley, Pittsburgh, PA (US)

(21) Appl. No.: 14/995,961

(22) Filed: Jan. 14, 2016

Related U.S. Application Data
(60) Provisional application No. 62/103,896, filed on Jan. 15, 2015.

(51) Int. Cl. B60R 22/10; B60R 22/34; B60R 22/46

(52) U.S. Cl. CPC B60R 22/105; B60R 22/46; B60R 22/3416; B60R 2022/4666

(57) ABSTRACT

Child restraint systems are disclosed. The child restraint systems can include a base portion and a seat portion. The child restraint systems can include at least one motor-driven subsystem for installing the child restraint system in a vehicle, such as a motor-driven tensioner and/or motor-driven leveler. The motor-driven subsystem(s) can be coupled to a power source, such as a battery pack. The child restraint systems can also include a microcontroller, which can be coupled to the power source and a motor for the motor-driven subsystem. The base portion and/or the seat portion can include a plurality of sensors in communication with microcontroller. The sensors can detect an installation condition and/or state of the child restraint system.

### CROSS-REFERENCE TO RELATED APPLICATION

This application claims the benefit under 35 U.S.C. §119(e) of co-pending U.S. Provisional Patent Application No. 62/103,896, entitled CHILD RESTRAINT SYSTEM, filed Jan. 15, 2015, which is incorporated by reference herein in its entirety.

### BACKGROUND

The present disclosure is generally directed to a child restraint system (CRS), such as a car seat for use in a vehicle. The proper installation and/or use of certain child restraint systems can be tedious and challenging. Moreover, child restraint systems are frequently installed and/or used improperly, which can undermine the safety features of the system.

The foregoing discussion is intended only to illustrate various aspects of the related art in the field at the time, and should not be taken as a disavowal of claim scope.

### BRIEF DESCRIPTION OF THE DRAWINGS

Various features of the embodiments described herein, together with the advantages thereof, may be understood in accordance with the following description taken in conjunction with the accompanying drawings.

FIG. 1 is a perspective view of a child restraint system, including a base and a seat, according to at least one embodiment of the present disclosure.

FIG. 2 is a perspective view of the base of the child restraint system of FIG. 1, depicting a belt path, according to at least one embodiment of the present disclosure.

FIG. 3 is a plan view of the base of FIG. 2, in which a portion of the base is transparent for illustrative purposes, and depicting a tensioner and a recline mechanism in the base, according to at least one embodiment of the present disclosure.

FIG. 4 is a perspective view of the tensioner of FIG. 3, according to at least one embodiment of the present disclosure.

FIG. 5 is an elevational view of a clutch assembly of the tensioner of FIG. 3, in which a portion of the assembly is transparent for illustrative purposes, according to at least one embodiment of the present disclosure.

FIG. 6 is a perspective view of a ratchet system of the tensioner of FIG. 3, in which a portion of the system is transparent for illustrative purposes, according to at least one embodiment of the present disclosure.

FIG. 7 is another perspective view of the base of FIG. 2, in which a portion of the base is transparent for illustrative purposes, according to various embodiments of the present disclosure.

FIG. 8 is an exploded perspective view of a nut of the leveler of FIG. 2, according to various embodiments of the present disclosure.

FIG. 9 is a schematic of a retractable tether system for a child restraint system, according to at least one embodiment of the present disclosure.

FIG. 10 is a schematic of a child detection system for a child restraint system, according to at least one embodiment of the present disclosure.

FIG. 11 is a perspective view of a child restraint system, including a base and a seat, according to at least one embodiment of the present disclosure.

FIG. 12 is an exploded perspective view of the child restraint system of FIG. 11, according to at least one embodiment of the present disclosure.

FIG. 13 is another exploded perspective view of the child restraint system of FIG. 11, in which a rear cover panel of the base is removed for illustrative purposes, according to at least one embodiment of the present disclosure.

FIG. 14 is a perspective view of the base of FIG. 11, in which a portion of the base is removed for illustrative purposes and depicting a leveler and a tensioner in the base, according to at least one embodiment of the present disclosure.

FIG. 15 is a plan view of the base of FIG. 11, in which a portion of the base shell is removed for illustrative purposes, according to at least one embodiment of the present disclosure.

FIG. 16 is a plan view of the leveler of FIG. 14, including movable rails positioned in mounting tracks of the base, according to at least one embodiment of the present disclosure.

FIG. 17 is a perspective view of a drive system of the leveler of FIG. 14, according to at least one embodiment of the present disclosure.

FIG. 18 is a plan view of the drive system of FIG. 17, according to at least one embodiment of the present disclosure.

FIG. 19 is a cross-sectional view of a portion of the leveler of FIG. 14, according to at least one embodiment of the present disclosure.

FIG. 20 is an elevation view of the base of FIG. 11, in which a portion of the base is removed for illustrative purposes, and the leveler of FIG. 14 is depicted in a first position, according to at least one embodiment of the present disclosure.

FIG. 21 is an elevation view of a portion of the base of FIG. 11, in which a portion of the base is removed for illustrative purposes, and the leveler of FIG. 14 is depicted in a second position, according to at least one embodiment of the present disclosure.

FIG. 22 is an elevation view of a portion of the leveler of FIG. 14, in which various elements are transparent for illustrative purposes, and depicting a manual override lock system in a locked configuration, according to at least one embodiment of the present disclosure.

FIG. 23 is an elevation view of the manual override lock system of FIG. 22, depicting the manual override lock system in an unlocked configuration, according to at least one embodiment of the present disclosure.

FIG. 24 is an elevation view of the base of the child restraint system of FIG. 11, depicting the base mounted to a vehicle seat with an integral belt of the base, according to at least one embodiment of the present disclosure.

FIG. 25 is an elevation view of the base of FIG. 11, depicting the base mounted to a vehicle seat with a vehicle belt, according to at least one embodiment of the present disclosure.

FIG. 26 is a perspective view of the base of FIG. 11, depicting the vehicle belt of FIG. 25 engaged with the base, according to at least one embodiment of the present disclosure.

FIG. 27 is an elevation view of the base of FIG. 11, in which a portion of the base is removed for illustrative purposes, and depicting the vehicle belt of FIG. 26 engaged with the base, according to at least one embodiment of the present disclosure.

FIG. 28 is a perspective view of the tensioner of FIG. 14, depicting a clamp arm of a lock off of the tensioner in an unclamped position, according to at least one embodiment of the present disclosure.

FIG. 29 is an elevation view of the tensioner of FIG. 28, depicting the clamp arm in the unclamped position of FIG. 28, according to at least one embodiment of the present disclosure.

FIG. 30 is a cross-sectional elevation view of the tensioner of FIG. 28, depicting the clamp arm in the unclamped position of FIG. 28, according to at least one embodiment of the present disclosure.

FIG. 31 is a perspective view of the tensioner of FIG. 28, depicting the clamp arm in a clamped position, according to at least one embodiment of the present disclosure.

FIG. 32 is an elevation view of the tensioner of FIG. 28, depicting the clamp arm in the clamped position of FIG. 31, according to at least one embodiment of the present disclosure.

FIG. 33 is a cross-sectional elevation view of the tensioner of FIG. 28, depicting the clamp arm in the clamped position of FIG. 31, according to at least one embodiment of the present disclosure.

FIG. 34 is a perspective view of the tensioner of FIG. 28, in which a gear box shroud has been removed for illustrative purposes, and depicting the clamp arm in the clamped position of FIG. 31 and the lock off of the tensioner in a tensioned orientation, according to at least one embodiment of the present disclosure.

FIG. 35 is a cross-sectional elevation view of the tensioner of FIG. 28, depicting the clamp arm in the clamped position of FIG. 31 and the lock off in the tensioned orientation of FIG. 34, according to at least one embodiment of the present disclosure.

FIG. 36 is a perspective view of the tensioner of FIG. 28, depicting the vehicle belt of FIG. 25 engaged with the tensioner, and further depicting the clamp arm in the unclamped position of FIG. 28, according to at least one embodiment of the present disclosure.

FIG. 37 is a cross-sectional elevation view of the tensioner of FIG. 28, depicting the vehicle belt of FIG. 25 engaged with the tensioner and further depicting the clamp arm in the unclamped position of FIG. 28, according to at least one embodiment of the present disclosure.

FIG. 38 is a perspective view of the tensioner of FIG. 28, depicting the vehicle belt of FIG. 25 engaged with the tensioner, further depicting the clamp arm in the clamped position of FIG. 31, and further depicting the lock off in the tensioned orientation of FIG. 34, according to at least one embodiment of the present disclosure.

FIG. 39 is a cross-sectional elevation view of the tensioner of FIG. 28, depicting the vehicle belt of FIG. 25 engaged with the tensioner, further depicting the clamp arm in the clamped position of FIG. 31, and further depicting the tensioning shaft in the tensioned orientation of FIG. 34, according to at least one embodiment of the present disclosure.

FIG. 40 is an elevation view of the tensioner of FIG. 28, in which portions of the housing are removed to expose a ratchet assembly, depicting the ratchet assembly in the engaged configuration, according to at least one embodiment of the present disclosure.

FIG. 41 is another elevation view of the tensioner of FIG. 28, in which portions of the housing are removed to expose the ratchet assembly of FIG. 40, depicting the ratchet assembly in the disengaged configuration, according to at least one embodiment of the present disclosure.

FIG. 42 is a perspective view of the seat of the child restraint system of FIG. 11, including a five-point harness for securing a child in the seat, according to at least one embodiment of the present disclosure.

FIG. 43 is a perspective view of the seat of FIG. 42, in which a portion of the seat is removed for illustrative purposes, according to at least one embodiment of the present disclosure.

FIG. 44 is a cross-sectional elevation view of the seat of FIG. 42, in which various elements of the seat are removed for illustrative purposes, according to at least one embodiment of the present disclosure.

FIG. 45 is a detail view of the cross-sectional elevation view of FIG. 44, depicting a central strap of the five-point harness in a first, locked position, according to at least one embodiment of the present disclosure.

FIG. 46 is a detail view of the cross-sectional view of FIG. 44, depicting the central strap of the five-point harness in an unlocked position, according to at least one embodiment of the present disclosure.

FIG. 47 is a detail view of the cross-sectional view of FIG. 44, depicting the central strap of the five-point harness in a second, locked position, according to at least one embodiment of the present disclosure.

FIG. 48 is a perspective view of the seat of FIG. 42, in which a portion of the seat is removed for illustrative purposes and depicting a top tether belt system, according to at least one embodiment of the present disclosure.

FIG. 49 is a cross-sectional elevation view of a portion of the seat of FIG. 42, depicting a portion of the top tether belt system of FIG. 48 in a first configuration, according to at least one embodiment of the present disclosure.

FIG. 50 is a cross-sectional elevation view of a portion of the seat of FIG. 42, depicting a portion of the top tether belt system of FIG. 48 in a second configuration, according to at least one embodiment of the present disclosure.

FIG. 51 is an electrical schematic of a portion of a control system for a child restraint system, according to at least one embodiment of the present disclosure.

FIG. 52 is an electrical schematic of another portion of the control system for the child restraint system of FIG. 51, according to at least one embodiment of the present disclosure.

FIG. 53 is a cross-sectional elevation view of the base of FIG. 11, in which various elements are removed for illustrative purposes, according to at least one embodiment of the present disclosure.

FIG. 54 is an elevation view of the lock off mechanism of the tensioner of FIG. 14, in which the lock is transparent for illustrative purposes, and further depicting the integral belt of the child restraint system and the vehicle belt of FIG. 25 engaged with the lock off mechanism, according to at least one embodiment of the present disclosure.

FIG. 55 is a perspective view of the lock off mechanism of FIG. 54, depicting the lock off mechanism in an unlocked, unclamped position, according to at least one embodiment of the present disclosure.

FIG. 56 is an elevation view of the lock off mechanism of FIG. 54, depicting the lock off mechanism in a locked, clamped position, according to at least one embodiment of the present disclosure.

The exemplifications set out herein illustrate various embodiments of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the embodiments as described in the specification and illustrated in the accompanying drawings. Well-known operations, components, and elements have not been described in detail so as not to obscure the embodiments described in the specification. The reader will understand that the embodiments described and illustrated herein are non-limiting examples, and thus it can be appreciated that the specific structural and functional details disclosed herein may be representative and illustrative. Variations and changes thereto may be made without departing from the scope of the claims.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes,” or “contains” one or more elements possesses those one or more elements, but is not limited to possessing only those one or more elements. Likewise, an element of a system, device, or apparatus that “comprises,” “has,” “includes,” or “contains” one or more elements possesses those one or more elements, but is not limited to possessing only those one or more elements.

For convenience and clarity, spatial terms such as “vertical,” “horizontal,” “up,” and “down,” for example, may be used herein with respect to the drawings. However, various devices disclosed herein can be used in different orientations and positions, and these spatial terms are not intended to be limiting and/or absolute.

In certain instances, the systems described herein can provide confidence of installation and use to a user by utilizing automated installation features, sensing intelligence, and/or an interactive user interface. Such features can help guide the user through installation, and notify the user of the installation status of the system at any time.

In certain instances, the child restraint system (CRS) can include: a seat base secured to the seat of the vehicle; a child receiving portion, or seat, supported by the seat base; a belt tensioning system incorporated into the seat base for receiving at least one belt that couples the seat base to the seat of the vehicle; and a leveling system incorporated into the seat base for proper leveling of the CRS. The CRS can also include a controller operatively connected to the systems in the base and in the child receiving portion to automatically actuate the belt tensioning system, the leveling system, and/or to communicate with sensors in the child receiving portion.

In various instances, the CRS can include at least one sensor connected to or associated with the child seat and operatively connected to the controller. The controller can be configured to actuate the belt tensioning system to increase tension of the at least one belt if the tension of the at least one belt is determined to be below a threshold value. Similarly, the controller may be configured to stop the belt tensioning system if the tension of the at least one belt exceeds a threshold value. The controller can also be configured to actuate the leveling system to bring the child receiving portion to an appropriate seat back angle. The controller can compare the angle of the child receiving portion to the angle of the base to arrive at the appropriate position. The controller can also send and receive sensor signals from the child receiving portion to provide information to the user via an interactive user interface.

The belt tensioning system can be operable in a state that provides tension to the LATCH (Lower Anchor Tether for Children) belts and in another state in which the lap and shoulder belts of a vehicle are tensioned. These two tensioning states can occur independently from each other through a directional clutch with a LATCH position, lap/shoulder position, and a disengaged position. The belt tensioning system may include but is not limited to one or more of the following structural elements: at least one drive system; a spindle connected to the at least one belt and rotatable in a pay-in direction or in a payout direction; and a clutch configured to transfer torque generated by the drive system to the spindle to drive the spindle in the pay-in direction. The at least one drive system may be, for example, one or more electric motors, one or more hydraulic motors, or combinations thereof. The belt tensioning system may also include but is not limited to a ratchet and pawl mechanism with a pawl configured to selectively engage the spindle to prevent rotation of the spindle in the payout direction. The belt tensioning system may include a lap/shoulder belt lock-off used to secure the lap/shoulder belt to the tensioning system. In addition, the at least one belt can include at least one connector configured to releasably connect to a corresponding anchor system on the seat of the vehicle.

A leveling system may be incorporated into the CRS for leveling the child receiving portion relative to the seat of the vehicle. Optionally, the leveling system may include a screw drive and an automated drive system coupled to the screw. The drive system may be configured to move a nut along the screw that is configured to move coupling points on the base to which the child receiving portion attaches. The coupling points can consist of bars in the base and hooks/latches in the seat. The child receiving portion can then be moved to a safe and secure position. The leveling system may also have a manual adjustment mechanism.

The child receiving portion of the CRS may be a rear-facing infant carrier, a forward facing infant carrier, a forward facing convertible child seat, a rear facing convertible child seat, a combination seat, or a booster seat, for example. The child receiving portion incorporates various mechanisms and sensors to ensure proper installation of the CRS. Mechanisms can include headrest/harness position adjustment mechanism(s), crotch strap position adjustment mechanism(s), and/or a top tether mechanism. Sensors can include harness tension sensor(s), harness position sensor(s), top tether tension sensor(s), and child presence sensor(s). All of these sensors can communicate wirelessly with the base and/or through direct connections to provide sensor status to the controller. Depending on the state of the sensors, a user interface in the base can communicate directives to the user for proper installation, or alert the user when something needs to be addressed.

The CRS may also include an energy source such as a battery for supplying power to the various systems, and a controller and/or monitor for determining a power level of the battery or other energy source. Optionally, the battery monitor can be configured to prevent the controller from installing the seat base to the seat of the vehicle when the power level is below a predetermined level. The power may be supplied through a direct connection to the vehicle power such as, for example, through a direct current device, such as a USB connector or a “cigarette lighter” connection.

The CRS may also include at least one user interface device. Further, the controller may be configured to provide installation instructions via the user interface device and may select a specific installation instruction based on feedback from the at least one sensor or a user. The user interface device may be integrally connected to the CRS.

Alternatively, the user interface device may be remote from the CRS and configured to wirelessly receive data from the CRS. For example, the user interface device may be a dedicated mobile electronic device, a multi-purpose electronic device, a smartphone, a computer, a laptop computer, or a tablet computer.

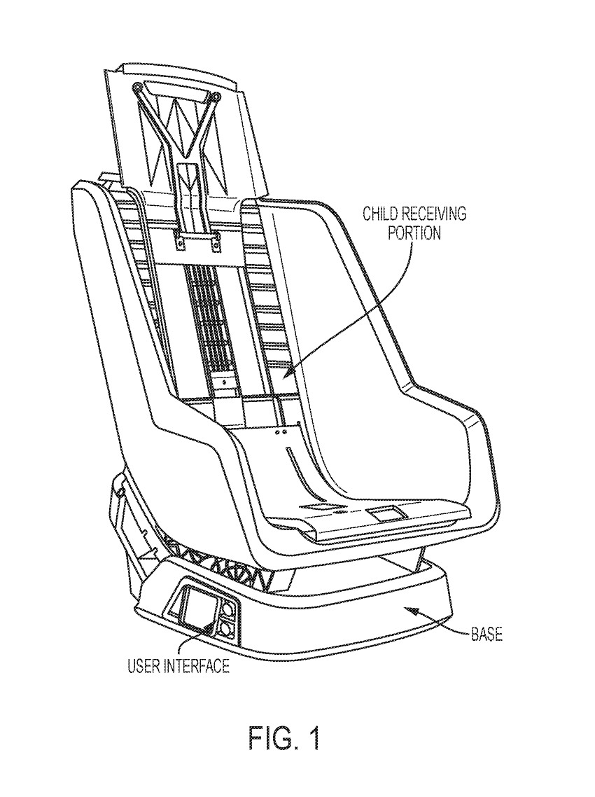

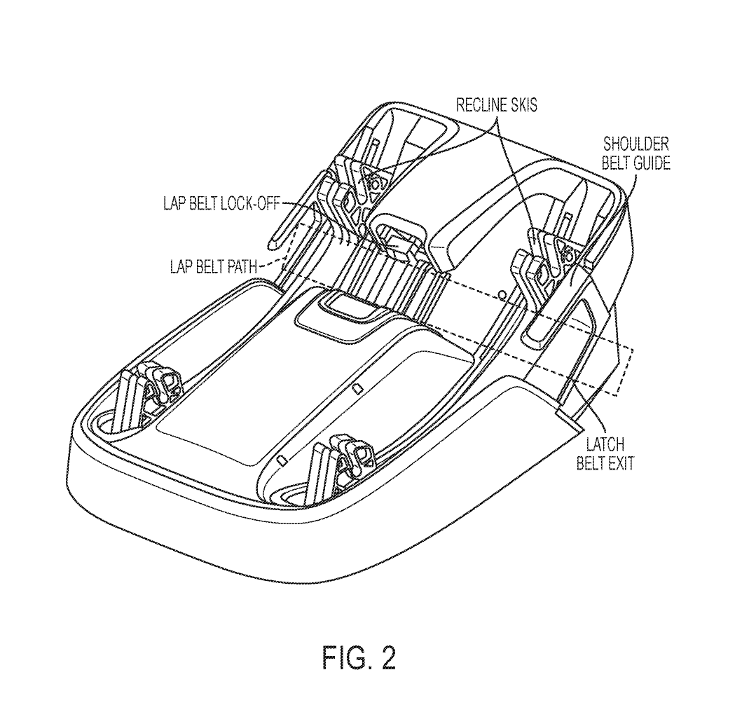

The CRS, according to the present disclosure, can be firmly attached to a vehicle seat by at least one belt. With reference to FIGS. 1 and 2, an embodiment of a CRS designed to provide a safe and secure seating location for an infant or small child is illustrated. The CRS includes a child receiving portion and a seat base. The child receiving portion includes a padded interior region and a strap or harness for securing the infant or child thereto. The exterior of the child receiving portion may include a hard, rigid housing. The child receiving portion is configured to engage the seat base to create a secure, yet releasable connection therewith. In an alternate embodiment, the child receiving portion is fixed to the seat base. The seat base includes a rigid housing formed from plastic or similar high strength material. In an example embodiment, the seat base includes a pair of coupling skis which contain spring loaded hooks that interact with corresponding latches on the child receiving portion to create a secure connection.

The seat base may further include at least one control center or user interface, such as a computer or other multimedia interface for providing functionality for controlling installation and release of the seat base from the vehicle seat. For example, as will be described in greater detail below, the interface could be used to provide instructions or status updates concerning the CRS system to the user and may be interactive. The interface may be any sort of visual display, including an LED screen, LCD screen, or touch screen, as well as other tactile or audio interfaces. The interface could also use a wireless connection to a computer, tablet, smartphone, vehicle system, or other electronic display.

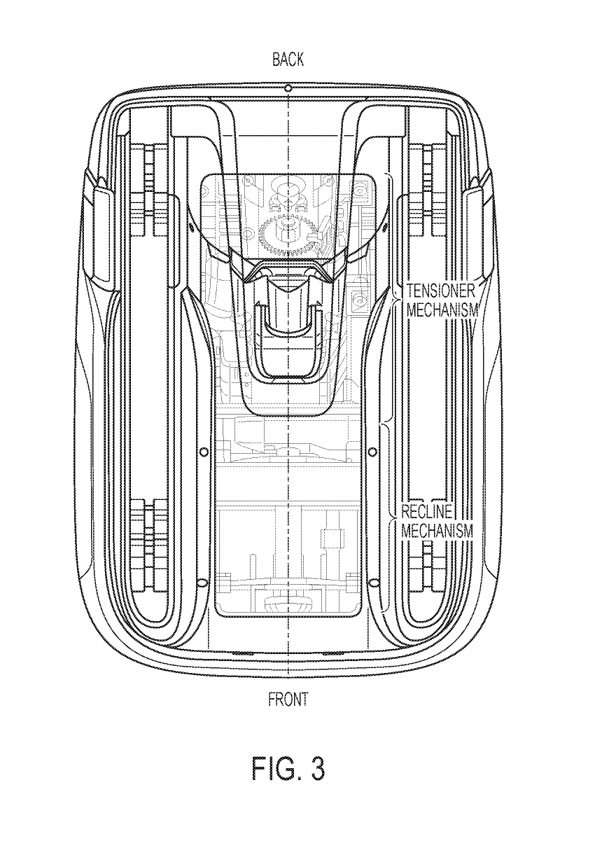

With reference to FIGS. 2 and 3, the base is a cradle-shaped structure adapted to receive and hold the child receiving portion, a LATCH belt for anchoring the base to the vehicle seat, and/or an alternative belt path for placing the lap/shoulder belt across the base. In example embodiments, the lap/shoulder belt is placed across the base, through the belt lock-off, under the shoulder belt guides, and secured to the vehicle with the vehicle belt buckle. The LATCH belts extend through holes located on the side of the base structure to a tensioning mechanism. The lap/shoulder belt lock-off can also be connected to the tensioning mechanism. The CRS can also contain a leveling mechanism that levels the child receiving portion relative to the base thereby ensuring that the child receiving portion is held at a level orientation. The tensioning and leveling system will be explained in further detail below.

Most child restraining systems (CRS) require a user to generate the required tension on the vehicle seat belt or the LATCH belt manually. The CRS of the present disclosure can include a tensioning mechanism, hereinafter the tensioner, which can automatically tension the vehicle lap and shoulder belt and/or the LATCH belt. If necessary, the system can also be operated in a manual mode.

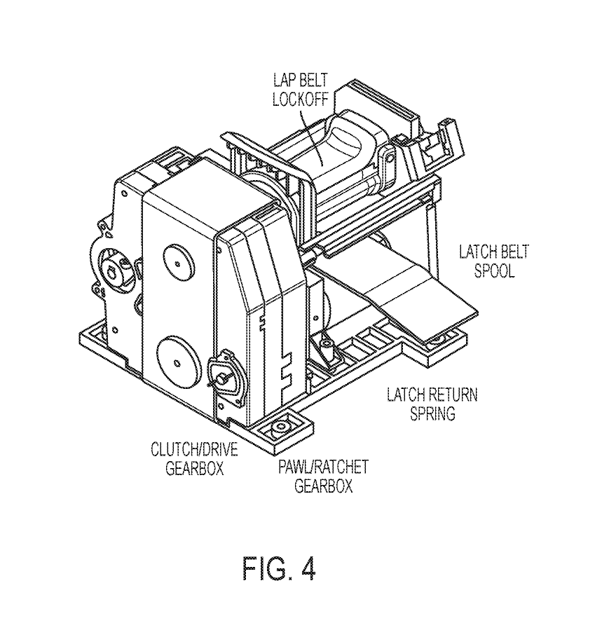

With reference to FIG. 4, in one embodiment, the lap/shoulder belt may be tensioned by inserting the belt in a rotatable belt lock-off that is opened by pressing a button, for example. The lock-off can comprise a position sensor, which notifies the CRS whenever it is in an unlocked position. The release button for the lock-off can ensure that it can only be opened in one correct orientation. When auto-tensioning is engaged, the belt lock-off can rotate about its axis, wrapping the belt around it and tightening the belt and CRS into the vehicle seat.

In another embodiment, the LATCH belt may be wound up as a spool on a shaft within the tensioner with the connectors, the only parts visible externally on the base, within easy reach of the user. To install, both ends of the LATCH belt can be pulled out from the tensioner, and the connectors at the ends of the LATCH belt can be attached to the LATCH anchor hooks located within the vehicle seat. A coil spring or a constant force spring can pull the excess slack inside the tensioner once the connectors have been connected. When auto-tensioning is engaged, the shaft can rotate and the LATCH belt can wrap around the spool, tightening the belt and the CRS into the vehicle seat.

The auto-tensioning actuation can be caused by a drive train that is driven by at least one motor, such as a DC motor. The drive train can comprise a series of gears, a clutch, and a dual ratchet system, all enclosed within a single enclosure. In an alternate arrangement, the lock-off flap can be actuated. In other embodiments, the required tension may be attained by moving either the lock-off or the surrounding area perpendicular to the belt path.

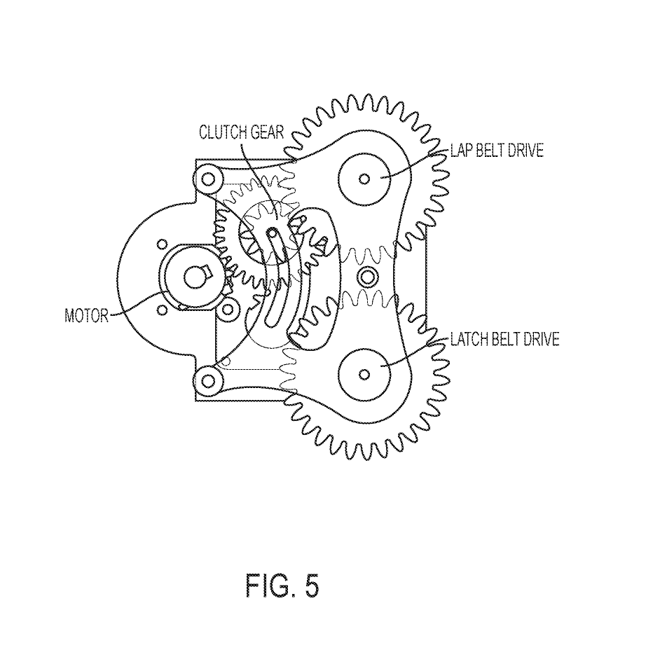

With reference to FIG. 5, the tensioner includes a clutch that enables it to tension either the lap/shoulder belt or the LATCH belt using a single drive motor. The clutch in FIG. 5 comprises a stacked spur gear arrangement bonded to a common shaft. The shaft can be movable and its motion can be constrained through an arc-shaped slot. This arc is concentric with the center of the motor shaft. One of the clutch gears depicted in FIG. 5 is linked to the output gear on the motor shaft while the other rides on a guiding track. This arrangement can cause the stack to travel along the slot in different directions based on the direction of motion of the drive motor. The two drive systems, one for each of the belts, can be located on the ends of the slots. Depending on the requirement, the direction of motion of the motor shaft can be controlled to link the drive gear to either one of the belt drive systems via the clutch. There can also be a third neutral position in which neither the lap/shoulder nor the LATCH belt drives are engaged.

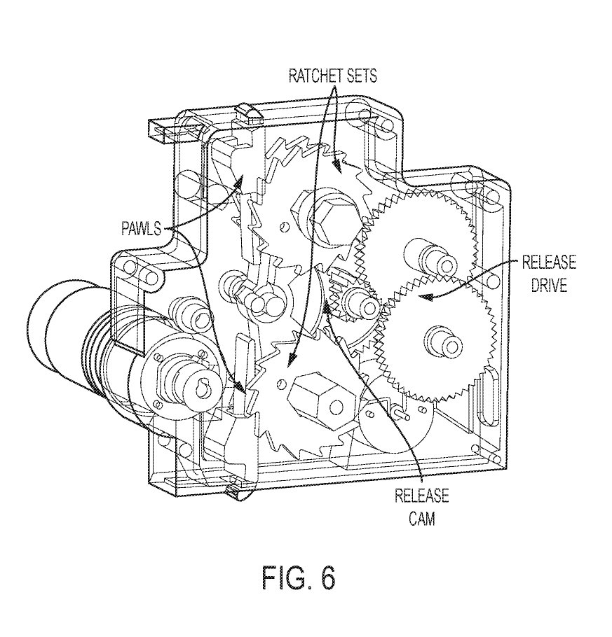

With reference to FIG. 6, each of the belt drive systems also comprises a pair of dual ratchets along their respective output shafts, and a single pawl that engages with these ratchets. In other instances, the tensioner can include at least one ratchet and at least one pawl. The pawl and ratchet mechanism in FIG. 6 maintains the tension value in the belts, and prevents the lock-off from rotating or the LATCH belts from extending in the event of a crash. In such circumstances, the load from the pawls is transferred to the metal structure encasing the ratchet and pawl assembly. The pawls can be spring loaded to be in the engaged position.

In various instances, the pawls can be disengaged manually. Manual disengagement may be achieved by a mechanical linkage connected to the pawl. This can be used for instant release of the base from the vehicle if needed. The mechanical linkage can be designed so as to disengage both the pawls with a single user action. Action could include pushing a button, sliding a button, rotating a lever, and/or toggling a knob, for example. In another embodiment, the disengagement could be by a powered device.

In the embodiment of FIG. 6, a single cam acts as a release for either of the two pawls. The cam does not make contact with either of the two pawls in its default position. It is spring loaded to be in this position by two counter-acting springs. Alternatively, a torsion spring can also be used to achieve similar results. The direction of rotation of the cam can control which of the two pawls is forced to disengage. The central portion of the cam has a gear profile, through which it is connected to its own drive gear train, which can be actuated via another DC motor. In the event that one of the pawls has to be disengaged, the motor can drive the gear train, which, in turn can rotate the cam. The direction of rotation of the motor shaft can select the pawl which becomes disengaged. Once disengaged, the motor can be powered at a substantially lower duty cycle to hold the pawl in the open position while it counters the force from the pawl spring, as well as the two springs on the cam. In the event the motor loses power, both the spring systems can act concurrently to push the pawl back into the locked state, thereby ensuring the safety of the system. Alternatively, other types of actuators, such as solenoids, can be used which can reduce the need of a complex gear train. In this case, the solenoid can disengage the pawl only when it is electrically charged. Once discharged, the spring forces can push the pawl back into the locked position. This system may also include an auto-release mechanism for the two pawls.

The tensioner can use a series of sensors and algorithms to ensure safe operation at all times. Sensors can be included in the lock-off to ensure it is closed and determine the rotational position of the tensioner. The tensioner can ensure that it never runs in an auto mode unless the lock-off is in a closed position. Multiple sensors may also be used to achieve a pre-determined safe value of tension on the belts at the time of auto install. In an embodiment, there are two primary force sensors for the LATCH belt. At least one of these sensors can have an extension piece attached to it so that it makes contact with the lap/shoulder belt path when used for installation. The tensioner sensing system can also use rotational position of the shafts and current draws of the motor to get the appropriate tension values. For a vehicle seat belt installation, inputs from shoulder belt sensors (located within the shoulder guides) may also be used. Multiple sensors may be used within the pawl and ratchet system for precise measurement of the location of the pawl and the cams. This series of sensors can provide feedback to the auto pawl release mechanisms. They can also continually monitor the pawl position to ensure it is engaged at all times. A sensor may also be used to determine the position of the clutch. To ascertain when the system changes because of user interaction, a sensor may also monitor the use of manual release for disengaging pawls.

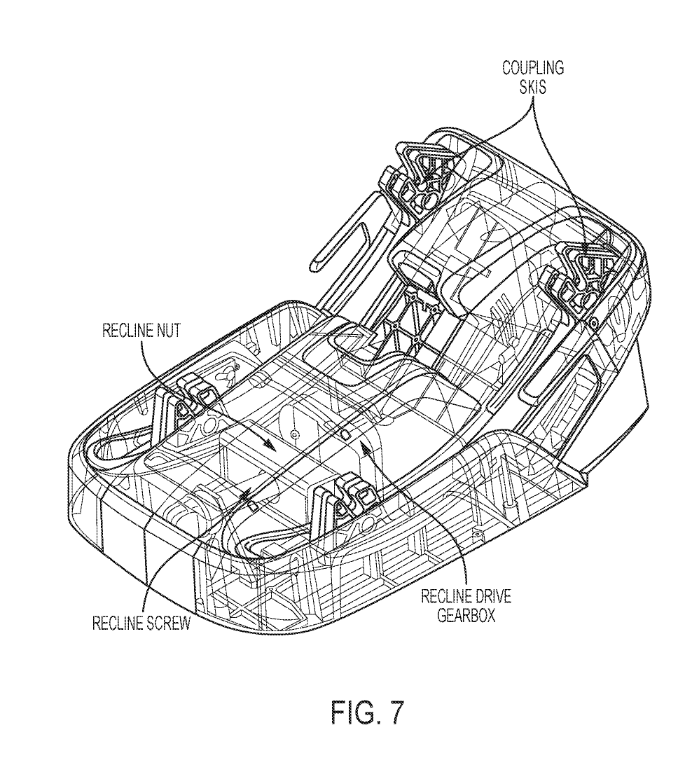

One of the most common factors resulting in an unsafe installation of a child restraining system is the child receiving portion being placed at an unsafe angle relative to level ground. With reference to FIG. 7, another embodiment of the present disclosure includes an auto recline feature, which adapts to the vehicle seat in which it is installed to ensure a safe angle for the child in both front and rear facing positions. Whereas most other CRSs offer a fairly limited number of positions for recline adjust, the embodiment depicted in FIG. 7 potentially has an infinite number of positions. This is achieved via a drive system such as, but not limited to, a linear screw drive mechanism. The screw used can have acme, standard, or any other type of thread profile used in lead screws. In another embodiment, the base can also be leveled so that when the seat is coupled to the base, the seat is at an appropriate angle.

In an example, the screw can be driven by a motor and transmission such as a DC motor actuator and a gearbox. The system can use a nut, which traverses linearly along the screw. The nut can be connected to the coupling system that interfaces with the child receiving portion via metal bars. As the nut travels back and forth along the length of the screw, the metal bars can move the coupling system along a set of curved slots in the base. The child receiving portion angle can change as the coupling system moves along the slots. The self-locking capabilities of the screw can prevent it from being back driven even when under high loads. The gearbox may have curved walls to reduce operational noise while in operation. Other noise reduction features such as lining the walls of the gearbox with foam/rubber, or using rubber mounts and washers at the mounting points for the gearbox can also be added. The motor mount inside the gearbox can use a bearing at one of the ends of the motor shaft for increased efficiency. Alternatively, a bearing can be used on either end of the exposed motor shaft with the drive gear being held between them. The entire mechanism, screw, nut, and gearbox may be housed in a cavity inside the base that further aids in noise reduction.

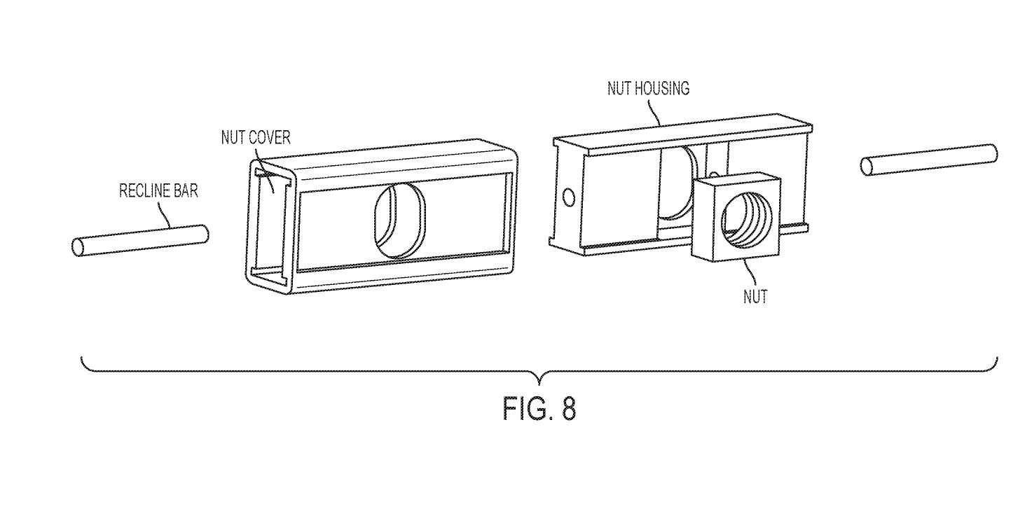

With reference to FIG. 8, the nut mentioned above can include three parts. It can minimize contact with external features and surfaces, thereby reducing friction. The innermost piece depicted in FIG. 8 includes a threaded portion being made of sufficiently strong materials such as, for example, aluminum or steel. Multiple threads can be engaged between the nut and the screw for better load distribution. The innermost piece can be free to move along the vertical direction inside the middle piece. The middle piece (or nut housing) can house a slot for the inner nut to travel in. It can also house the ends of the recline bars, which link the recline nut to the coupling system. The outermost part (nut cover) of the nut can house the nut assembly. This design can help to distribute the linear load from the innermost piece onto the faces of the other two pieces. It can also ensure that the offset between the linking bar and the center of the screw is minimal, which can load the screw uniformly.

In further embodiments, a linking bar can be connected to coupling skis, which ride in guiding slots along the length of the base. The profile of the guiding slots can be designed to provide maximum angular change with the least amount of linear displacement. The profile also ensures that the top part of the seat maintains a similar horizontal position in both front and rear facing positions. In a front facing position, this can ensure that the back of the child receiving portion always makes contact with the vehicle seat back in any recline position. In a rear facing position, it can ensure that the top of the child receiving portion is more or less at the same horizontal distance from the back of the vehicle seat.

In an example embodiment, the coupling skis house attachment points for the child receiving portion to be coupled to the base. The child receiving portion of the CRS can have four spring-loaded, pivotable hooks located near the four corners of the underbody. These hooks can engage with the pins located in the coupling skis once the child receiving portion is placed onto the base in the proper position. Alternatively, the hooks can be located on the base and fixed pins can be located on the child receiving portion. The engagement between the hook and pin can be designed to be always locked in all circumstances unless the user manually releases it by using the release handle. The release handle can be located either on the seat or the base. The coupling skis may have rollers at the bottom to reduce the friction when the skis move. These rollers can also be placed on the child receiving portion.

The recline system can also be operated manually in case the user does not desire, or is unable, to use the auto-recline feature. For the manual system to work, the system can require the screw to be disengaged from the motor drive. For example, opening a flap located in the front of the base can disconnect the drive gear from the rest of the drive train. The flap can be spring loaded to be closed, thus, if the flap is let go, the drive gear mesh can mesh back with the rest of the drive train. The front flap can also act as an access door to the screw handle. This handle can be used to rotate the screw when it is in the manual mode. In another example, the recline system can also be manually adjusted by pulling the handle to disengage the nut threads from the screw and sliding the nut along the screw to the desired position. When the handle is released, the nut threads can re-engage the screw.

In another embodiment, the recline angle can be controlled via a smart phone, tablet, or other wireless device or can be controlled by the user with a button on the user interface, for example.

At least one sensor can be used to ensure autonomous and consistent operation of the recline system. Leveling can require an accurate measurement of the base and child receiving portion angles relative to level ground. A fixed angle measurement device, such as an accelerometer, which provides a gravity reference, can be used to measure the angle of the base. The angle of the seat can be computed by measuring the absolute linear position of the nut on the screw. This arrangement can simplify the overall system by avoiding having another sensor in the seat. Limit switches at the end of the screw can be used for a second layer of safety, and to calibrate the angle measurement devices many times. A sensor on the front flap can monitor every instance the system is used in the manual mode. In an alternate embodiment, an accelerometer may also be in the seat to directly measure the seat's angle.

At least one sensor may also be used to ensure safe and proper coupling. In an example embodiment, small switches are used to determine the position of hooks. Alternatively, non-contact sensors such as Hall Effect, magnetometers, etc. can also be used. In another example embodiment, a proximity sensor may be used between the seat and the base that is triggered only when the seat is directly above and close to the base.

In the present disclosure, the child receiving portion can contain a padded area to place a child and/or a five-point no-rethread harness with adjustable crotch strap. The crotch strap may be manually adjusted. The child receiving portion may have an adjustable head rest which positions the headrest and the shoulder straps of the harness to the correct position. The headrest may have multiple positions and lock in place when a headrest handle is released.

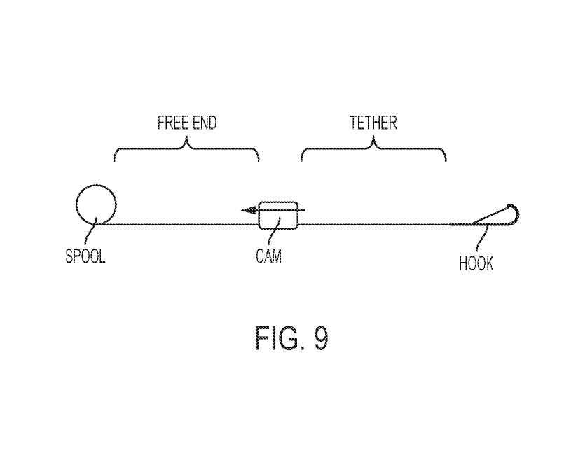

With reference to FIG. 9, use of a top tether is shown. The top tether is a length of webbing, which can be used on a CRS to prevent the child receiving portion from rotating forward in the event of a vehicle crash. The top tether is secured to a mounting point on the vehicle by means of a hook or latching mechanism, then slack is removed from the webbing to complete installation. A common method of top tether adjustment can leave a significant length of unused webbing loses within the vehicle, which must either be manually stowed, or left visible after installation. The present disclosure includes a top tether adjustment method that automatically manages the loose, unused webbing after installation, as well as locates the tensioning and release mechanism integral with the child receiving portion.

The top tether length is adjustable to accommodate various top tether anchor locations within a vehicle and to allow tightening to complete installation. Reduction of top tether length can be accomplished by pulling the webbing through a spring loaded cam-lock mechanism, which allows the webbing to be pulled in the direction of the free end, but locks when the webbing is pulled in the top tether direction. A section of the top tether webbing on the spool side of the cam-lock is positioned in a user accessible section of the seat so that the user can grasp the webbing and directly pull in through the cam lock to reduce the top tether length. Lengthening of the top tether can be accomplished by opening the cam-lock and pulling the webbing in the top tether direction. Excess webbing on the free end can be routed through the child receiving portion and wound on a spring loaded take-up spool. The cam-lock may be actuated open directly or remotely either by mechanical or electro-mechanical means. The free end of the top tether can be routed through the child receiving portion such that it can be easily accessed by the user for the purposes of tightening. Another embodiment can place the top tether system in the base.

In various embodiments, the top tether length can be adjusted by pulling the webbing through a spring loaded cam-lock mechanism, which allows the webbing to be pulled in the direction of the free end, but locks when the webbing is pulled in the top tether direction. Unused webbing can be wound around a spring-loaded spool. A separate length of webbing can be connected to the top tether webbing via a shuttle mechanism, which can be used to pull the top tether webbing at a point between the cam-lock and the spool. A mechanism in the spool or between the spool and shuttle can prevent the webbing from being unwound from the spool, and therefore the top tether webbing can only be pulled through the cam-lock mechanism thereby reducing the effective top tether length. Lengthening of the top tether webbing is affected by the user opening both the cam-lock mechanism and the spool lock, either directly or via remote actuation, allowing the webbing to be freely fed from the spool. Alternate methods of managing the top tether slack, such as a linear convoluted path, may also be used. In such instances, the tether can extend between a pulley system.

In embodiments of the current disclosure, the top tether system is fully contained within the seat portion of the CRS, however, an alternate embodiment may use similar mechanisms contained in the base portion of the CRS.

When not in use, such as when top tether installation is not appropriate or the vehicle does not have an available top tether anchor, the top tether may be fully retracted within the seat, where the hook/latch mechanism is locked into a home position. When in the home position, the hook/latch mechanism can remain accessible to the user, such that the top tether can be pulled out for installation while the CRS is otherwise installed.

In addition to unique features in the child receiving portion, the CRS may also contain a system of sensors which communicate with the base to aid the user in the confidence of installation. The sensors in the child receiving portion may include, for example, child presence sensor(s), shoulder harness position sensor(s), harness slack sensor(s), crotch strap slack sensor(s), top tether slack sensor(s), and combinations thereof.

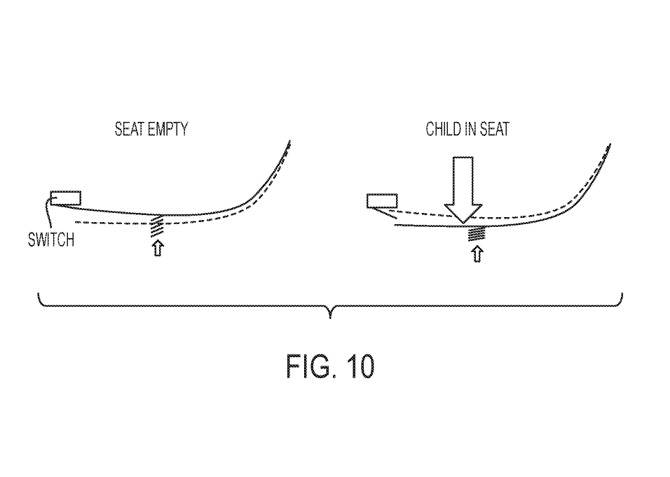

In an embodiment, a child presence sensor may include a spring-loaded plate integrated with the base of the child receiving portion, which is moved when a child is placed in the child receiving portion (see FIG. 10). For example, in the embodiment depicted in FIG. 10, at least one switch is located such that when the plate is unloaded, the switch will be in its actuated state, held so by a spring force in the plate assembly. When a child is placed in the child receiving portion, the plate can be moved downwards to release the switch, sending a signal that a child is present in the child receiving portion. For example, the plate can be configured to move an actuator arm of the switch downward when a child is placed in the seat, which can move the switch to an open position or non-actuated state. In other instances, the switch can be in a non-actuated state when the seat is unloaded, and can be moved to an actuated state when a child is placed in the child receiving portion. The design of the plate can be such that pressure placed anywhere within the seating area will trigger the switch. In an alternate embodiment, the spring-loaded plate may also be used to trigger an angle sensing device (accelerometer or magnetometer). The plate can be connected via linkages to the sensor, where a change in position of the plate can cause a change in angle of the sensor. Other sensors, such as non-contact sensors that detect changes in an electric/magnetic field (based on variance in induction or capacitance) due to the presence of a human body, or pressure sensitive materials and/or systems nearby, for example, can also be used.

Child presence sensing can be used both to activate the CRS for child installation checks, and when in combination with a buckling sensing system, to alert the user if a child is placed in the child receiving portion but not buckled. The non-buckled child alert may be activated either on a timed basis, or on sensed motion of the vehicle.

There are safety guidelines on the angle of the shoulder belt harness with respect to the shoulder of the occupant. In the rear facing orientation, the current guidelines recommend that the point of origination be below the shoulder height of the child. In the front facing orientation, the current guidelines recommend that the point of origination be above the shoulder of the child. Although highly critical for the safety of the child, many parents are unaware of this guideline. It may be desirable to include an active measurement device for the angle of the shoulder harnesses. In another embodiment, the CRS in the present disclosure may include a shoulder harness angle measurement sensor. These sensors may be housed in a sleeve that is located at the point where each of the shoulder harnesses exits the child receiving portion shell. The sensors may be accelerometers used to measure the relative vertical angle of the harness with respect to gravity, which can be compared to the seat back angle as measured by a separate sensor. Alternatively, other sensors like potentiometers or magnetometers can also be used for similar purposes. For example, the angle between the harness belts and the seat back can be directly measured via sensors such as potentiometers, magnetometers, and/or opto-mechanical systems. Once the child has been buckled into the child receiving portion, these sensors can measure the exit angle of the harnesses. Since the CRS can already sense whether it is in the front or rear facing orientation, it can advise the user whether the harnesses are at the correct height.

Using child presence sensing as a trigger for child installation guidance can allow the CRS to be started without manual initiation from the user, and can ensure that installation checks are performed each time a child is placed in the seat. Child presence awareness can also enable the system to check for correct installation upon beginning a trip and alert the user to any unsafe conditions. Child presence awareness can also prevent nuisance alarms by not alerting for conditions such as “harness not buckled” when the seat is not occupied.

The present disclosure may include at least one sensor for detecting that a child has been correctly buckled when placed in the child receiving portion. Sensors may be located at one or more portions of the harness. For example, sensors can be placed on each of the two shoulder harnesses and also the crotch strap. The sensors are triggered once the threshold for the tension value in the harnesses has been reached, thereby ensuring that the child has been adequately tightened into the seat. In one embodiment, spring loaded micro-switches may be used. Alternatively, any force measuring device, such as a load cell, for example, can be used for similar purposes. Since each of the two shoulder harnesses can be sensed independently, the system may also detect when the child manages to slip out of one of the shoulder harnesses. When this happens, that harness can lose tension, thereby triggering the sensor, which in turn can alert the user via any mode of communication. A similar sensing method may be used to detect top tether use and status.

In various instances, to encourage installation of a top tether, sensors can be included in the CRS to detect the installed state of the head tether. This system may use a tension measuring system integrated into the head tether webbing, together with a sensor that detects the presence of the head tether latch in its stowed position. The presence sensor can detect that the latch has been removed from its home position, and the tension sensor can detect that the tether has been secured to the vehicle and tightened. Another embodiment can design the head tether tension sensor such that the tension sensor is mechanically bypassed when the latch is in the stowed position. A further embodiment could include a sensor connected to the head tether latch, which is actuated when the latch connector is secured to an anchor point.

In an embodiment of the present disclosure, the separate sensing systems in the base and the child receiving portion can communicate back and forth alerting the user to the installation status of the system, and also aiding the user through the process of the CRS/child installation into a vehicle. In an example embodiment, the base sensing system monitors the status of the belt tension, recline position, and the presence of a child receiving portion. The child receiving sensing system can monitor the status of whether an object is present in the child receiving portion, the tension and position of the harness straps, top tether tension/use, proper coupling to the base, and orientation relative to the base. The child receiving portion may communicate the sensing status to the base via a wireless form of communication. This information can be used to actively alert the user to the status of the car seat system, and also to aid in system installation into a vehicle.

Various embodiments of the present disclosure can include multiple protocols for wireless communication, both within the system and to external devices. For example, a wireless communication channel can exist between the base and the child receiving portion of the CRS, which negates the need of having separate User Interfaces (UI), one on each of the two components representing their safety status. Alternatively, a unidirectional mode of communication using Infra-Red (IR) can exist between the base and the child receiving portion. In an example, the child receiving portion may be the transmitter and the receiver may be in the base. Messages can be sent via encoded IR pulses. To avoid having the receiver on at all times, and thus consuming extra power, a separate low power detector can be used to wake up the receiver system when communication needs to be established. If needed, the communication system can be modified to have a bi-directional setup. Alternatively, other modes of communication such as RF (434 MHz, 2.4 Ghz and others), Near Field Communication (NFC), Bluetooth, or Bluetooth Low Energy can also be used. Other wake-up systems using ultra low power or low-frequency detectors can be used to supplement any of these systems. A setup to wirelessly transfer power between the two components may be added to the communication system.

In at least one instance, the system can use at least one contact switch between the seat and the base to transfer both data and power. Depending on which combination of switches are in contact, the system can also determine whether a seat is facing-forward or rearward-facing.

An interactive user interface having a control center such as a visual display for displaying visual data for a user may be included. Relevant data can include, for example, an indicator light and/or visual icon display informing the user of whether the seat is level, whether the base is securely anchored to the vehicle seat, and/or whether the child receiving portion is properly installed. The control center may also include input devices allowing a user to input data regarding the child to be secured to the CRS, and/or a button to select various options on the user interface. Display options can include images and videos to guide the user through installation, informing the user along the way if anything needs to be corrected. The user interface may also be used as an informational tool to educate the user on any specific changes that may require change(s) to the installation status of the seat, such as a child's age, height, and weight.

The CRS of the present disclosure may also communicate to other external UI devices, for example, a user's smartphone or UI in vehicles using Bluetooth Low Energy (BLE). This provides a separate channel for communicating with the user. In another application, the CRS can wirelessly communicate with any external device that is connected to the vehicle and can provide real-time status information. This can be used to devise a warning system for cases when a child is accidentally left behind in the car when it is locked.

The CRS of the present disclosure can be used to safely secure a child to a vehicle seat by means of a child restraint system (CRS). More importantly, the CRS of the present disclosure can use automated systems and sensors to give assistance to the user that the CRS is properly installed. The CRS can be able to communicate with the user via an interactive user interface in which information is provided to the user, and the user can use a button to provide input to the CRS. The CRS of the present disclosure can aid in CRS installation and, once installed, can regularly provide CRS status checks and feedback to the state of the CRS.

In an example embodiment, during installation, the user presses a button on the user interface. This can begin the installation instruction sequence utilizing visible icons and sounds to aid the user through installation. The user can be instructed to ensure that the vehicle is parked on level ground and to place the base onto the vehicle seat. The user interface can then prompt the user to use the button to select whether a LATCH belt or lap/shoulder belt is being used for the base installation. Once the user selects his or her choice of installation, the system can lock out the belt system that was not selected to ensure that the user cannot install the base in an unsafe manner with both belts engaged. If the lap/shoulder belt is selected, the user interface can prompt the user to proceed with opening the belt lock-off, placing the lap/shoulder belt in the proper position on the belt path, and closing the lock off. If the LATCH belt is selected, the user interface can prompt the user to extend the LATCH belts and connect them to the vehicle LATCH anchors. After proper belt connection is completed, the user can be prompted to push the user interface button to initiate the auto-tensioning system. The auto tensioning can stop once the tensioning system sensors indicate that the belt is positioned properly and adequate belt tension has occurred. The user interface can then indicate a correct base installation has been achieved, or indicate to the user what needs to be corrected.

Once the base is installed correctly, the user interface can prompt the user to install the child receiving portion onto the coupling points of the base. Once the CRS has sensed that the coupling hooks are fully engaged, it can prompt the user to press the user interface button to begin the auto-recline sequence. The CRS can use the angle sensor of the base, the position sensor of the recline nut, and/or the orientation (forward or rear facing) of the child receiving portion to automatically determine and position the child receiving portion to the correct angle relative to level ground. If the child receiving portion orientation sensor indicates that it is in the forward facing orientation, the user interface can prompt the user to install the top tether to the correct LATCH anchor point. At this point, the user interface can also give the user the option to opt out of using the head tether since not every vehicle has top tether anchor points located in the vehicle. Top tether installation can be verified with the top tether slack sensor. Once installation is completed, the user interface can then indicate a correct child receiving portion installation has been achieved, or indicate to the user what needs to be corrected.

Once the child receiving portion is installed correctly, the user interface can prompt the user to place the child into the child receiving portion of the CRS. Once the child presence sensor indicates a child in the seat, the user interface can prompt the user to adjust the head rest to the proper position depending on the child receiving portion orientation, and how to properly secure and buckle the harness around the child. The child receiving portion can then check that the child presence sensor is engaged, the shoulder portion of the harness is in the right position, harness slack is removed, and/or crotch strap slack is removed. This can ensure a proper and safe installation of the child and buckling of the harness. Once installation is completed, the user interface can then indicate a correct child installation has been achieved, or indicate to the user what needs to be corrected.

The CRS can then conduct a final system sensor check and provide an indication to the user via the user interface that the installation is complete. Once the CRS has reached a final state of installation, there are at least three manners in which the system may continually check its installation state and indicate status to the user. Periodic, timed system checks can be automatically conducted by the CRS, the user can press the user interface button at any time to conduct a CRS check, and/or, each time the child is placed into the child receiving portion, the CRS can conduct a system check. This continual monitoring system can ensure confidence to the user that the CRS is safe to use at all times.

A child restraint system can provide a secure place for a child to sit in a vehicle. Child restraint systems can be installed in many different vehicles. For example, a child restraint system can be installed in a variety of motor vehicles, such as cars and vans, in airplanes, and/or in public transit vehicles, such as buses and trains. A user of a child restraint system may need to install the child restraint system in a vehicle and subsequently uninstall the child restraint system from the vehicle. Thereafter, the child restraint system may be installed in a different vehicle.

In various instances, a child restraint system can be configured for installation in vehicles in a variety of ways. For example, a child restraint system can be installed in a vehicle using a belt that is part of the vehicle, i.e., a vehicle belt, such as the seat belt or safety belt of a motor vehicle. Alternatively, the child restraint system can be installed in a vehicle using a belt system that is integral to the child restraint system, i.e., an integral belt, such as a LATCH belt or an ISOFIX belt. ISOFIX is the international standard for attachment points for child restraint systems in passenger cars. In the United States, such standards are often referred to as Lower Anchors and Tethers for Children, or LATCH. It can be suggested to install a particular child restraint system with a vehicle belt under certain circumstances, and suggested to install a particular child restraint system with an integral belt under other circumstances.

Certain vehicles may require installation with a certain belt system and other vehicles may permit installation with more than one belt system. Though a child restraint system can be installed using different belt systems, a child restraint system can be designed for use with a single belt system at a time.

The recommended belt system (e.g. a vehicle belt or an integral belt) for installing a child restraint system can depend on the size of the child and/or the facing direction of the seat of the child restraint system. Child restraint systems can be sized and configured to fit children of predefined size ranges. For example, a particular child restraint system can be sized and configured to hold young infants, such as newborns, and another child restraint system can be sized and configured to hold larger children, such as toddlers. It can be desirable to provide a child restraint system that fits a large size range of children, including young infants and toddlers, for example. Such child restraint systems may include accessories, such as a newborn insert, for use with the child restraint system depending on the size of the child that is using the child restraint system at a particular time. Adjustment features can be important for child restraint systems that are designed to accommodate a large size range of children.

In various instances, a child restraint system can be installed in a first manner for children up to a predefined size or size range, and installed in a second manner for children over a predefined size or size range. For example, when used for a smaller child, a seat of the child restraint system can be installed in a rearward-facing position and, when used for a larger child, the seat of the same child restraint system can be installed in a forward-facing orientation. Such child restraint systems are often referred to as convertible car seats.

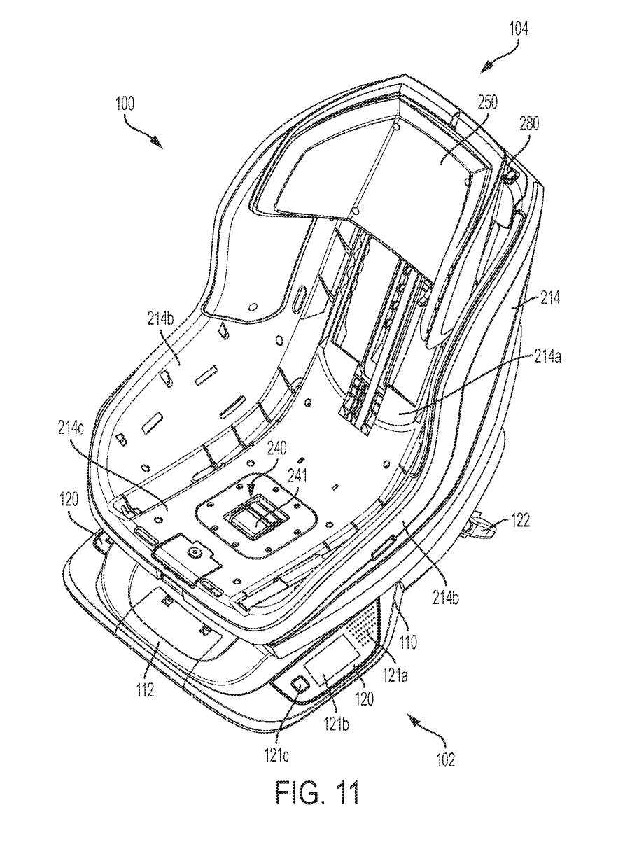

Referring now to FIGS. 11-13, a child restraint system 100 is depicted. The child restraint system 100 includes a base 102 and a child receiving portion or seat 104. The base 102 is configured to be installed in a vehicle, and the seat 104 is configured to releasably engage the base 102. As described herein, the base 102 can be installed in a vehicle using an integral belt or a vehicle belt, for example. Additionally, the seat 104 is configured to releasably lock to the base 102 in different orientations. For example, the seat 104 can engage the base 102 in a forward-facing orientation, as shown in FIG. 11. In other instances, the seat 104 can engage the base 102 in a rearward-facing orientation. In at least one embodiment, to permit engagement between the base 102 and the seat 104 in different orientations, the mechanical couplings between the base 102 and the seat 104 are reversible.

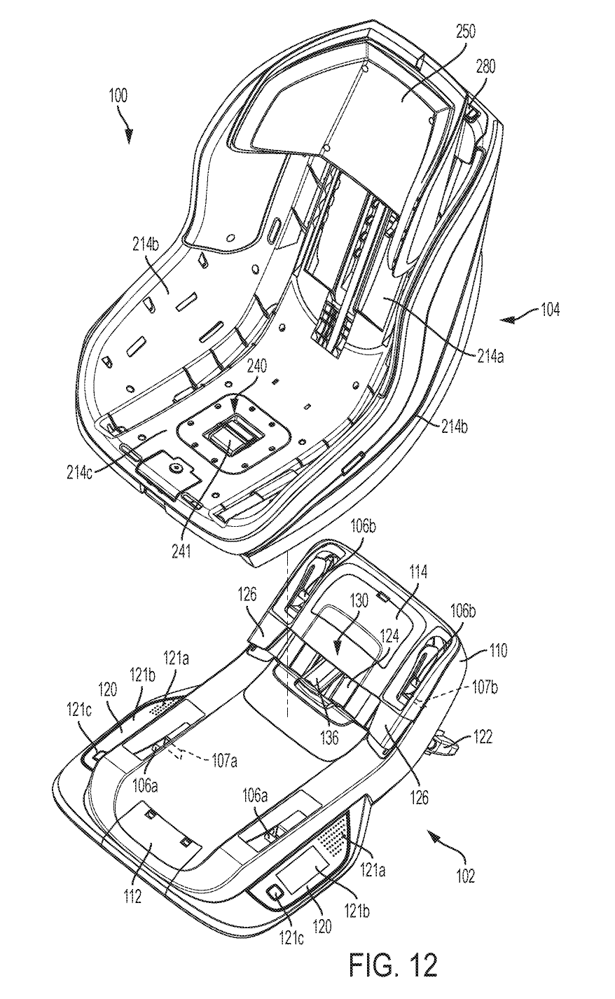

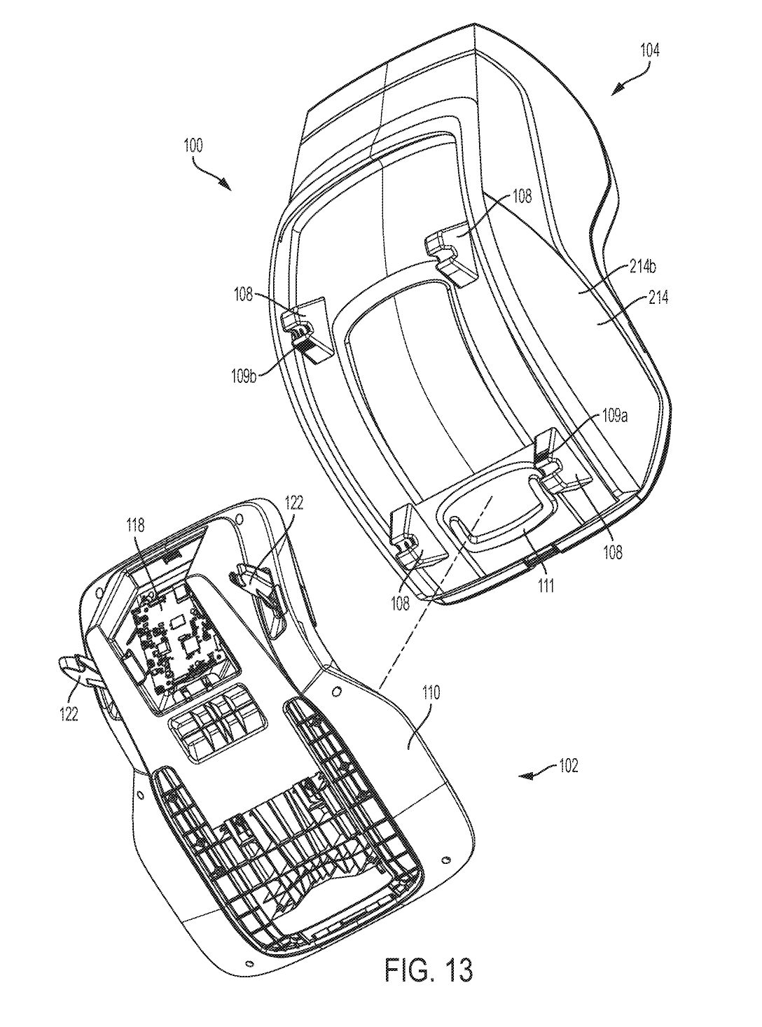

Referring primarily to FIGS. 12 and 13, the base 102 includes coupling rods 106a, 106b (FIG. 12) and the seat 104 includes coupling hooks 108 (FIG. 13). The coupling hooks 108 are configured to releasably engage the coupling rods 106a, 106b to releasably hold the seat 104 relative to the base 102. When the coupling rods 106a, 106b are moved into engagement with the coupling hooks 108, the coupling hooks 108 can snap or spring around the coupling rods 106a, 106b. For example, the coupling hooks 108 can be spring-loaded toward a locked or engaged position.

Referring primarily to FIG. 13, the seat 104 includes a release lever or handle 111 for releasing the coupling hooks 108 from the coupling rods 106a, 106b. The release handle 111 is connected to a mechanical linkage in the seat 104 and the mechanical linkage is connected to each coupling hook 108. In use, a user can activate the release handle 111 on the seat 104 to overcome the spring-loaded bias of the coupling hooks 108 and move the coupling hooks 108 to an unlocked or disengaged position. When in the unlocked position, the coupling hooks 108 can be moved out of engagement with the coupling rods 106a, 106b such that the seat 104 can be released and removed from the base 102.

In other instances, the base 102 can include coupling hooks and/or the seat 104 can include coupling rods. In still other instances, the seat 104 can be fixedly coupled to the base 102. For example, the seat 104 and the base 102 can form an integrated assembly.

In certain instances, the base 102 and/or the seat 104 can comprise a “smart” component. For example, the base 102 and/or the seat 104 can include at least one electronic component, such as a sensor. Such an electronic component can be electrically coupled to a power source, such as a battery pack, for example. In certain instances, at least one electrical component can be in the seat 104, and the power source can be in the base 102. Additionally or alternatively, at least one electrical component can be in the base 102, and the power source can be in the seat 104.

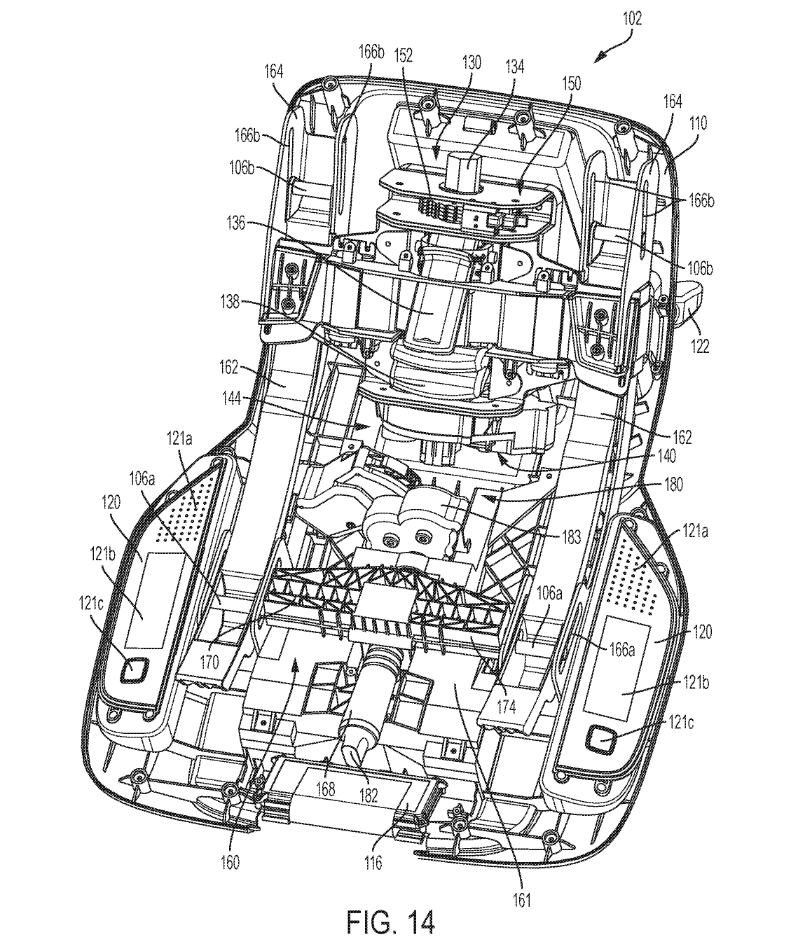

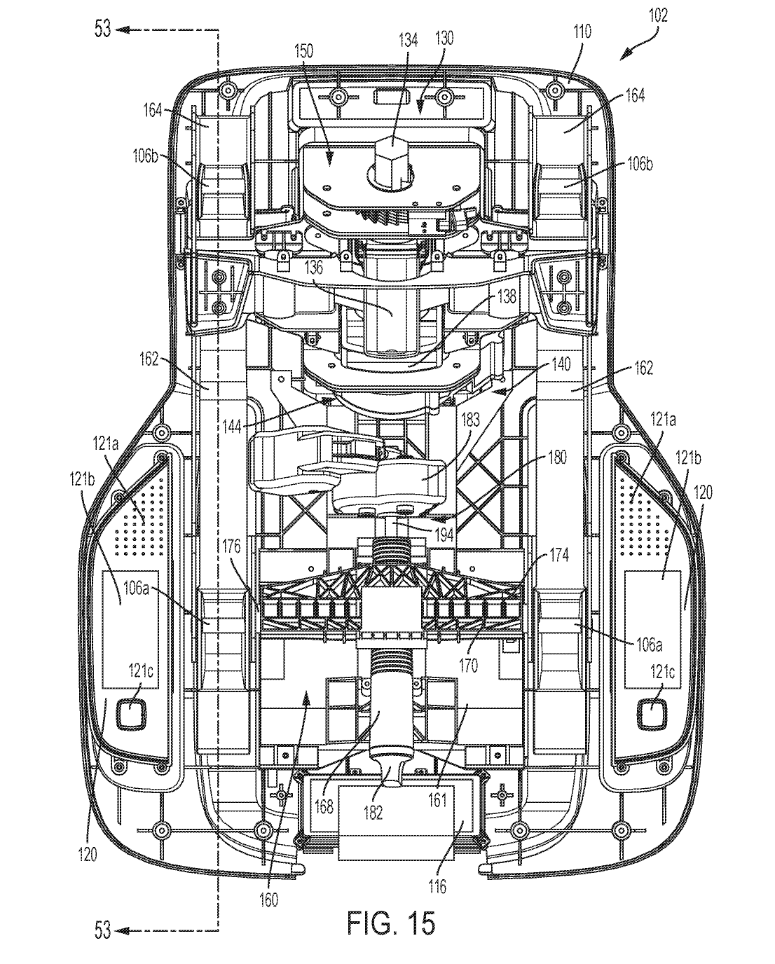

To power the electronic component(s), the child restraint system 100 can include electrical couplings between the base 102 and the seat 104. For example, the base 102 and the seat 104 can include electrical contacts that are in mating contact when the seat 104 is engaged with the base 102. The electrical contacts on either the base 102 or the seat 104 can be coupled to the power source. For example, when a battery pack 116 is in the base 102, as shown in FIGS. 14 and 15, electrical contacts in the base 102 can be hardwired to the battery pack 116. Moreover, the electrical contacts on either the base 102 or the seat 104 can be coupled to the electronic component(s). For example, electrical contacts in the seat 104 can be hardwired to the electronic component(s) in the seat 104.

In certain instances, the coupling rods 106 and/or the coupling hooks 108 can include the electrical contacts, which are configured to mate when the seat 104 is releasably locked to the base 102. For example, the base 102 can include electrical contacts 107a, 107b (FIG. 12), and the seat 104 can include electrical contacts 109a, 109b (FIG. 13) on the coupling hooks 108. The electrical contacts 107a, 107b can be electrically coupled to the battery pack 116, and the electrical contacts 109a, 109b can be electrically coupled to the electronic component(s) in the seat 104, which are described in greater detail herein. The electrical contacts 107a, 107a, 109a, 109b are in mating contact when the seat 104 is engaged with the base 102, and current can flow across the mating electrical contacts 107a, 107b, 109a, 109b to power the electronic components.

In various instances, the child restraint system 100 can include an orientation sensor. When the seat 104 is forward-facing, the electrical contact 107a can be in mating contact with the electrical contact 109a, and the electrical contact 107b can be in mating contact with the electrical contact 109b. Similarly, when the seat 104 is rearward-facing relative to the base 102, the electrical contact 107a can be in mating contact with the electrical contact 109b and the electrical contact 107b can be in mating contact with the electrical contact 109a.

The arrangement of the electrical contacts 107a, 107b, 109a, 109b can be configured to detect the orientation of the seat 104 relative to the base 102. In at least one instance, either the electrical contact 107a or the electrical contact 107b can be powered. When the seat 104 is coupled to the base 102, the electrical contact 107a or 107b in the base 102 that is powered will make contact with either the electrical contact 109a or the electrical contact 109b in the seat 102. Based on which of the mating connector pairs is powered, the child restraint system 100 can detect the orientation of the seat 104 relative to the base 102.

Additionally or alternatively, the arrangement of electrical contacts between the seat 104 and the base 102 can be configured to detect the orientation of the seat 104 relative to the base 102. In certain instances, when the seat 104 is forward-facing, a first pattern of electrical contacts can mate and, when the seat 104 is rearward-facing, a second pattern of electrical contacts can mate. Based on the mating pattern of the electrical contacts, the microcontroller 118 (FIG. 13) of the child restraint system 100 can determine the orientation of the seat 104 relative to the base 102.

In certain instances, the base 102 and the seat 104 can include more than four or less than four coupleable electrical contacts. Additionally or alternatively, the electrical contacts can be positioned on the outer shell 110 of the base 102 and/or the outer shell 214 of the seat 104, for example. In still other instances, the electrical contacts can be positioned on the coupling rods 106a, 106b and/or coupling hooks 108 and/or the latches within the coupling hooks 108, for example.

In certain instances, the orientation of the seat 104 relative to the base 102 can be detected with a sensor that is actuated by a feature on the seat. For example, the orientation sensor can comprise a switch, an optical sensor, and/or a magnetic sensor. Such a sensor can be positioned on the base 102. A feature on the seat 104 can be configured to engage the sensor when the seat 104 is in a particular orientation relative to the base 102. For example, a feature on the seat 104 can be configured to engage the sensor when the seat 104 is in the rearward-facing orientation, and the feature may not engage the sensor when the seat 104 is in the forward-facing orientation. Additionally or alternatively, a feature on the seat 104 can be configured to engage the sensor when the seat 104 is in the forward-facing orientation, and the feature may not engage the sensor when the seat 104 is in the rearward-facing orientation.

In various instances, the coupling hooks 108 can include sensors, which are configured to detect if the coupling hooks 108 are engaged with the coupling rods 106a, 106b. For example, when the coupling hooks 108 spring around the coupling rods 106a, 106b to lock the seat 104 to the base 102, sensors in the coupling hooks 108 can detect the engagement. The sensors can include switches, for example. As further described herein, the engagement sensors in the coupling hooks 108 can be in communication with the microcontroller 118 (FIG. 13) and can communicate the engaged state to the microcontroller 118. Similarly, when the coupling hooks 108 disengage the coupling rods 106a, 106b, the sensors can communicate the disengaged state to the microcontroller 118.

Additionally or alternatively, the coupling rods 106a, 106b can include coupling sensors. In still other instances, the frame 110 of the base 102 and/or the frame 214 of the seat 104 can include coupling sensors.

The base 102 includes an outer shell 110, which houses various mechanical and electrical components. The outer shell 110 includes at least one access door, which provides access to at least one mechanical and/or electrical component in the base 102. Referring primarily to FIG. 12, the base 102 includes a front access door 112 and a rear access door 114. The access doors 112, 114 provide access to various manual override features, as described in greater detail herein. The front access door 112 also provides access to the battery pack 116 (FIGS. 14 and 15), which is configured to power the child restraint system 100.

In certain instances, a battery pack can be positioned in the seat 104 of the child restraint system 100. Additionally or alternatively, the child restraint system 100 can include a power cord, which can be connected to an external power source, such as a battery in a motor vehicle, for example.

Referring again to FIG. 13, the microcontroller 118 is positioned in the base 102. In other instances, the microcontroller 118 can be positioned in the seat 104. The microcontroller 118 is powered by the battery pack 116. In various instances, the microcontroller 118 is configured to operate an installation and/or startup sequence. The sequence can include various steps and/or status checks to confirm that the base 102 is properly installed in a vehicle and/or can include a complete automatic or semi-automatic installation procedure. Throughout the startup and/or installation procedure(s), the microcontroller 118 can receive feedback from various sensors regarding conditions for installation and/or the state of the child restraint system 100. For example, the microcontroller 118 can receive feedback from various sensors to confirm that the seat 104 is properly engaged with the base 102 and/or that the child is properly secured in the seat 104. In certain instances, the microcontroller 118 can initiate a tensioning operation followed by a leveling operation. In other instances, the microcontroller 118 can initiate a leveling operation followed by a tensioning operation and/or can initiate either a leveling operation or a tensioning operation. As described in greater detail herein, the base 102 includes a motor-driven leveler 160 and a motor-driven tensioner 130 (see, e.g., FIGS. 14 and 15). Based on the feedback from the sensors and/or the input to the microcontroller 118, the microcontroller 118 can automatically level the base 102 using the leveler 160 and automatically tension the engaged belt system using the tensioner 130. Exemplary startup and installation procedures are described in greater detail herein.

The base 102 also includes a user interface 120, which is in communication with the microcontroller 118. The base 102 includes a user interface 120 on each side of the base 102 such that a user interface 120 is easily accessible regardless of which side of a vehicle (e.g. the driver's side or the passenger's side) the base 102 has been installed. In other instances, the base 102 can include a single user interface 120 and/or the user interface 120 can be positioned on a front side of the base 102. In still other instances, the seat 104 of the child restraint system 100 can include the user interface 120 and/or a user interface can be integrated into an application program, which can be operated on a mobile device, such as a “smart” mobile phone or tablet, for example.

The user interface 120 can include at least one screen, at least one light, such as an LED, for example, at least one speaker, and/or at least one button or switch, for example. In various instances, the user interface can include at least one wired and/or physical connection, such as a port and/or dock for a “smart” mobile phone and/or tablet. Referring to FIGS. 11-15, in at least one example, each user interface 120 includes a speaker 121a, a screen 121b, and a button 121c. An operator can provide input to the user interface 120 to install and/or uninstall the base 102 of the child restraint system 100. For example, an operator can press the button 121c on the user interface 120 to initiate a startup sequence, as further described herein.

Referring primarily to FIGS. 14 and 15, in at least one example, the child restraint system 100 includes at least one motor-driven system for facilitating installation of the child restraint system 100 in a vehicle. For example, the child restraint system 100 includes the motor-driven tensioner 130 for tensioning the belt system that is used to install the child restraint system 100 in the vehicle (i.e., the engaged belt system). Additionally, the child restraint system 100 includes the motor-drive leveler 160 for leveling the child restraint system 100 in the vehicle. The motors of the tensioner 130 and the leveler 160 can be controlled by the microcontroller 118 (FIG. 13) and can be implemented based on user input to the user interface 120. In various instances, at least one motor-driven system can include a manual override feature for optional, manual operation of the system.

In certain instances, a child restraint system can include a combination of motor-driven systems and manually-operated systems for installing the child restraint system in a vehicle. For example, a child restraint system can include one of the motor-driven tensioner 130 and the motor-driven leveler 160. The other system can be manually operated, for example.

Referring primarily to FIGS. 14 and 15, the base 102 includes the leveler 160, which is configured to level the child restraint system 100 relative to the vehicle. For example, the leveler 160 can pivot the seat 104 relative to the base 102. In other instances, a leveler can pivot the base 102 relative to the vehicle seat. The leveler 160 is a motor-driven leveler. Additionally, the leveler 160 is configured for optional, manual operation, as further described herein. In other instances, a leveling mechanism could be incorporated into the seat 104 of the child restraint system 100.

Referring still to FIGS. 14 and 15, the base 102 includes the tensioner 130, which is configured to tension the belt system that is engaged to install the child restraint system 100 in the vehicle. For example, the tensioner 130 can tension a vehicle belt or an integral belt. In other instances, a tensioner can be configured for use with a single belt system. The tensioner 130 is a motor-driven tensioner. The tensioner 130 is configured for optional, manual operation, as further described herein.

Referring primarily to FIGS. 14-16, the leveler 160 includes a pair of rails 162, a pair of guide tracks 164, a drive system 180, a central drive screw 168, and a nut 170. The drive system 180 is configured to rotate the drive screw 168, which moves the nut 170 along the drive screw 168. The nut 170 is coupled to the rails 162 and, thus, movement of the nut 170 moves the rails 162 relative to the guide tracks 164 and within the base 102. In various instances, the drive screw 168 includes a threaded portion and a unthreaded portion. The nut 170 is configured to move along the threaded portion. In certain instances, the drive screw 168 can be threaded along the length thereof.

More particularly, the tracks 164 are fixed relative to the base 102. For example, the tracks 164 can be fastened to the shell 110 of the base 102 or be integrally formed therewith. When the base 102 is installed in a vehicle seat, the tracks 164 remain substantially fixed relative to the vehicle seat. As a result, the rails 162 are configured to move relative to the tracks 164 and the vehicle seat. Movement of the rails 162 affects pivoting of the seat 104 relative to the base 102, as further described herein.

The nut 170 is threadably engaged with the central drive screw 168 such that the nut 170 can move along the central drive screw 168 as the screw 168 rotates. In various instances, the central drive screw 168 can be driven by the drive system 180. In other instances, the central drive screw 168 can be manually operated with a knob 182.

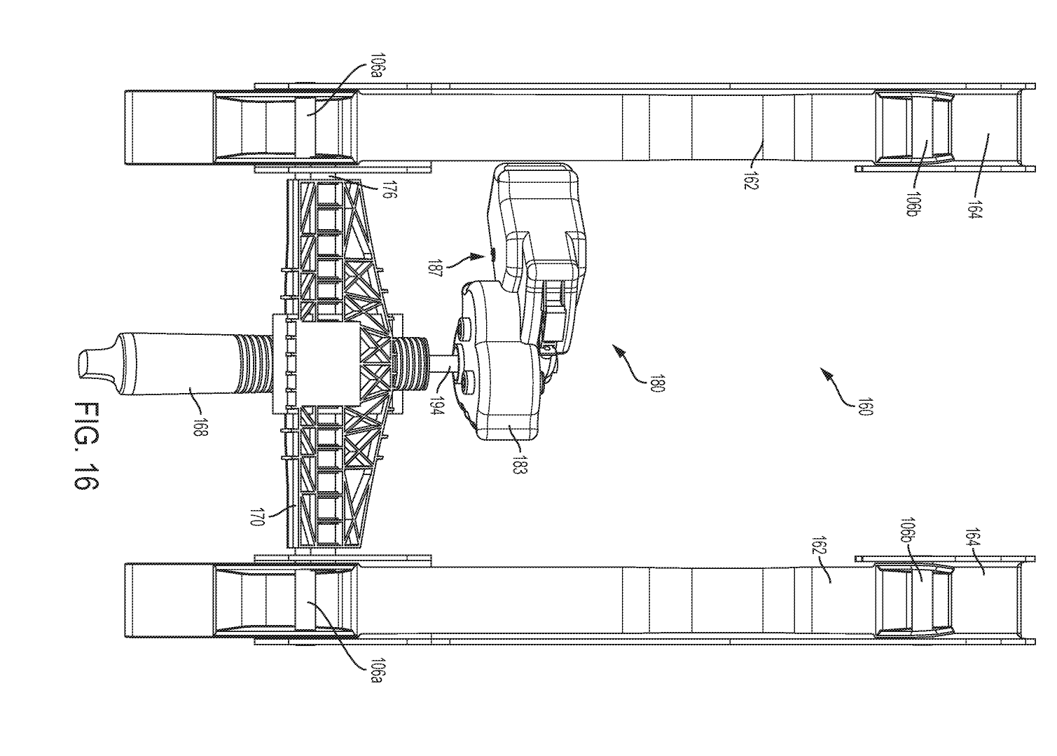

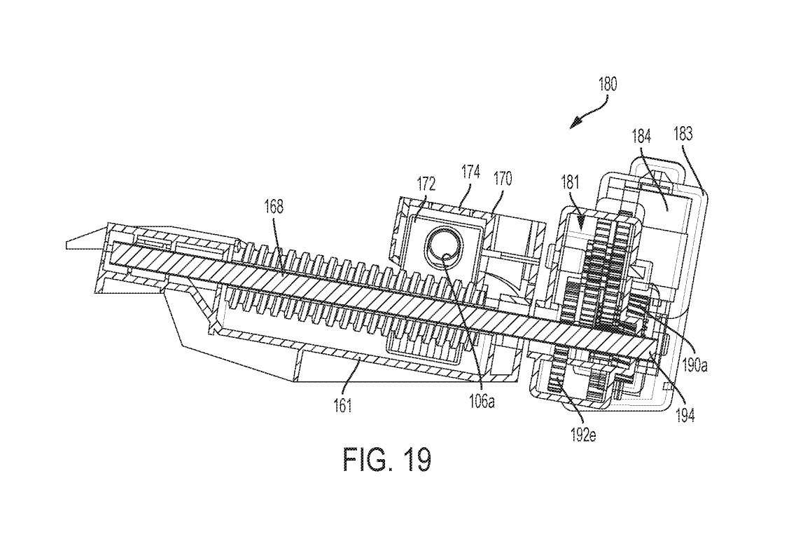

Referring primarily to FIG. 19, the nut 170 includes a threaded portion 172 and a body portion 174. The threaded portion 172 comprises internal threads, which threadably engage external threads of the central drive screw 168. The nut 170 also includes a support bar 176 extending through the body portion 174 (see FIG. 16). The support bar 176 is engaged with the rails 162. For example, the ends of the support bar 176 can be held in apertures in the rails 162. Because the nut 170 is connected to the rails 162, the rails 162 and the coupling rods 106a, 106b are configured to move through the base 102 as the nut 170 moves along the central drive screw 168. The threaded engagement between the drive screw 168 and the nut 170 can permit the nut 170 to be positioned in one of an infinite number of positions relative to the drive screw 168. As a result, the angle of the seat 102 can be selected with precision. Moreover, the drive screw 168 can be self-locking.

In other instances, the leveler 160 can include an alternative drive mechanism for moving the rails 162 within the tracks 164. For example, the leveler 160 could include another mechanical driver, such as a hydraulic piston, a rack and pinion, a cable and pulley system, and/or a belt, for example. Such alternative drive mechanisms could engage a lock to hold the leveler 160 in the selected position. In various instances, such mechanical drivers can be motor-driven and/or manually operated.

Referring again to FIGS. 14 and 15, the rails 162 include the coupling bars 106a, 106b. For example, each rail 162 includes a rear coupling bar 106b and a front coupling bar 106a. In certain embodiments, the front coupling bars 106a can extend between the rails 162. For example, a single bar 106a can connect the rails 162 on either side of the base 102. The rails 162 can be linked together by a coupling bar and/or the nut 170, such that the coupling bars 106a, 106b on either side of the base 102 move in unison. In the depicted arrangement, the nut 170 extends between the rails 162, and the front coupling bar 106a extends through the nut 170.

In at least one instance, the threaded portion 172 of the nut 170 and the drive screw 168 can be comprised of metal, such as aluminum, for example, and the body portion 174 of the nut 170 can be comprised of plastic.

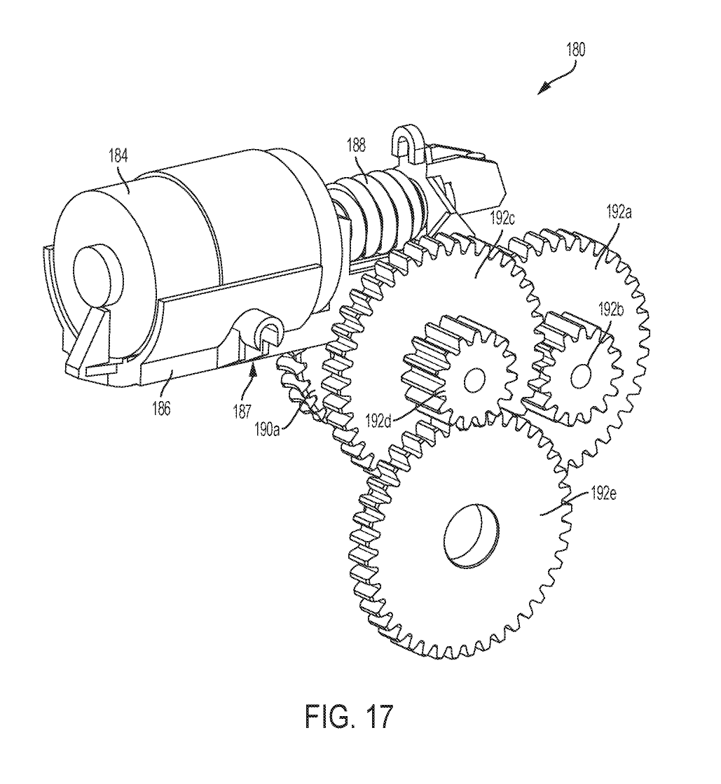

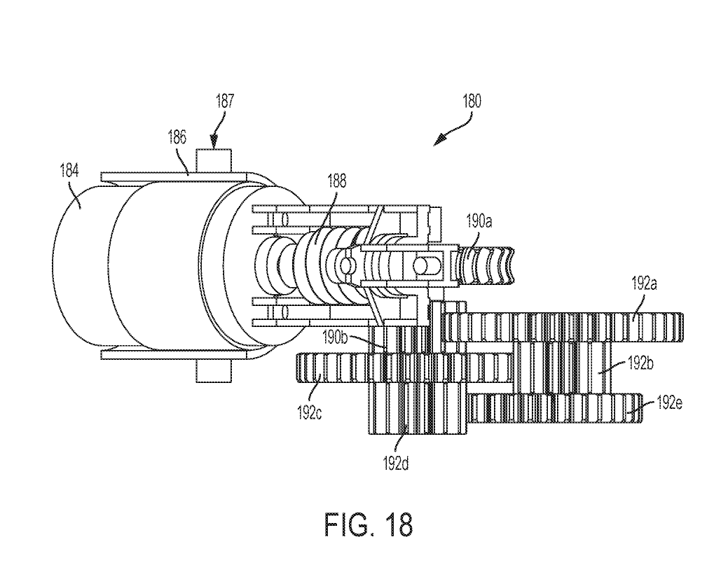

Referring primarily now to FIGS. 17 and 18, the leveler 160 includes the drive system 180, which includes a gear assembly 181 and the motor 184. The gear assembly 181 and the motor 184 are covered by a shroud 183 (FIGS. 14-16), and the motor 184 is held in a shiftable support 186. The shiftable support 186 can be supported in the gear assembly shroud 183. As further described herein, the shiftable support 186 can shift in order to move the motor 184 into and out of driving engagement with at least a portion of the gear assembly 181. In still other instances, the leveler 160 may not include a motor. For example, the leveler 160 can be manually operated.

When the motor 184 is in driving engagement with the gear assembly 181, an output shaft of the motor 184 drives a worm gear 188. The worm gear 188 is configured to drivingly engage the gear assembly 181. For example, the worm gear 188 is configured to rotate a worm wheel 190a, which drives a first output gear 190b. The first output gear 190b is drivingly engaged with a speed-reducing, torque-increasing gear assembly that includes a first driven gear 192a, a first driving gear 192b, a second driven gear 194c, a second driving gear 192d, and a third driven gear 192e. The third driven gear 192a drives an output shaft 194 (FIGS. 15 and 16) of the gear assembly 181 to rotate the central drive screw 168 and move the nut 170. In various instances, the gear reduction ratio can be 500:1. In other instances, the gear reduction ratio can be greater than 500:1 or less than 500:1.

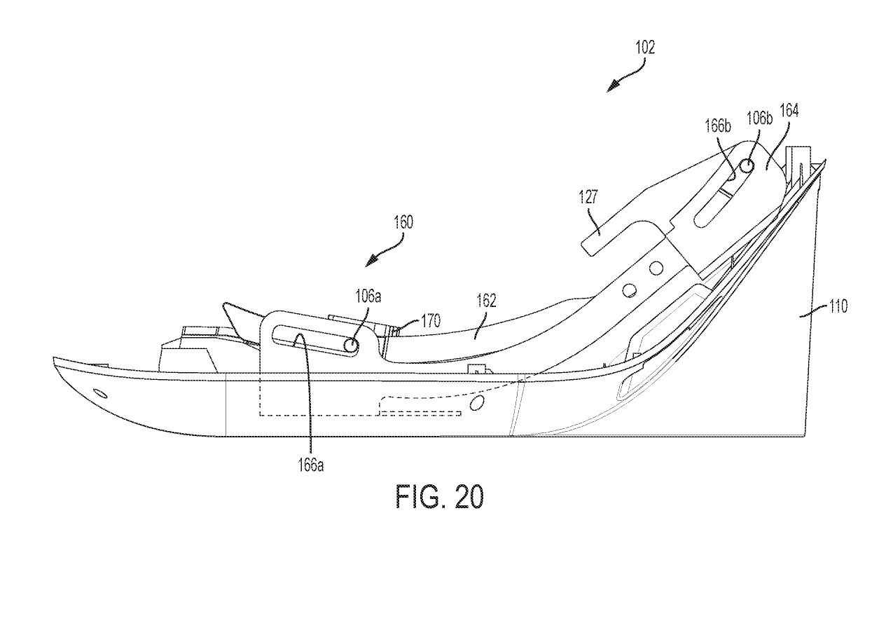

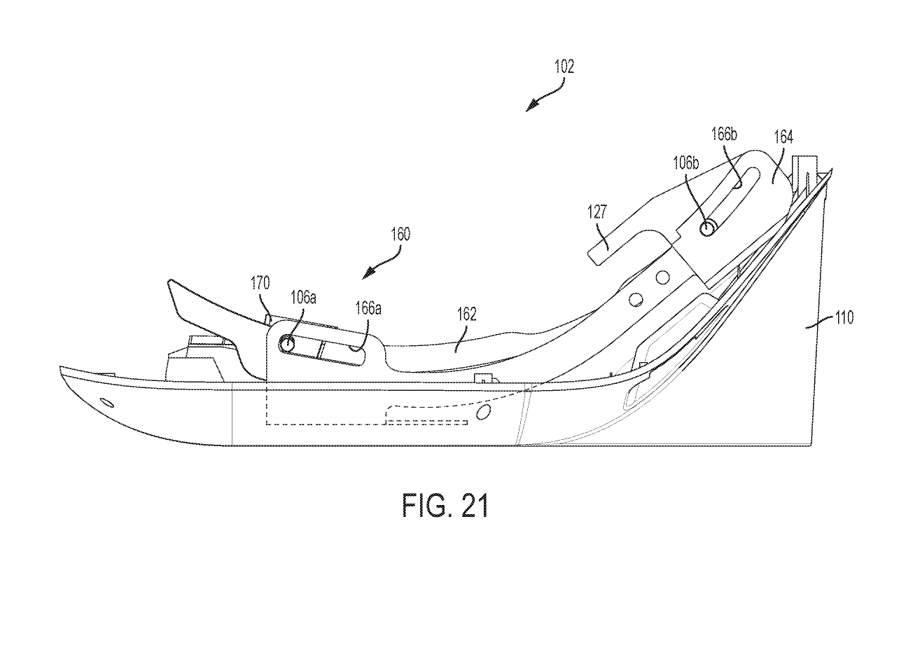

In use, the threaded portion 172 of the nut 170 is configured to move along the drive screw 168, such that the body portion 174 of the nut 170 moves within the base 102. Moreover, because the nut 170 is coupled to the coupling rods 106a, 106b via the rails 162, the coupling rods 106a, 106b also move within the base 102. As a result, the rails 162 move in the tracks 164. Referring primarily to FIGS. 20 and 21, the rails 162 are configured to move between a first, rearward-most position (FIG. 20) and a second, forward-most position (FIG. 21). As further described herein, the angle of the seat 104 relative to the base 102 is configured to change depending on the longitudinal position of the nut 170 and the corresponding position of the coupling rods 106a, 106b. The nut 170 can be supported by a guide 161 (FIGS. 14 and 15), which is secured to the shell 110 of the base 102. For example, the guide 161 can include a pathway through which the nut 170 can travel. In various instances, the guide 161 can be connected to the gear train shroud 183.

Referring primarily to FIGS. 20 and 21, the guide tracks 164 define an arcuate or bowed profile. As further described herein, the rails 162 are configured to slide along the curved profile of the guide tracks 164 to adjust the angle of the seat 104 relative to the base 102. The guide tracks 164 include slots 166a, 166b defined therein. For example, each guide track 164 includes forward slots 166a and rearward slots 166b. The slots 166a, 166b define an arcuate or bowed profile. The radius of curvature of the slots 166a, 166b is selected to provide sufficient leveling of the seat 104 relative to the base 102 within the confined footprint of the base 102. In other instances, the slots 166a, 166b can be straight or substantially straight.

The rails 162 also define an arcuate or bowed profile. The contour of the rails 162 is selected to complement the contours of the guide tracks 164. In other words, the rails 162 and the tracks 164 define complementary profiles. Owing to the complementary profiles of the rails 162 and the guide tracks 164, the rails 162 are configured to glide within the guide tracks 164.

The guide tracks 164 are configured to guide movement of the rails 162. For example, the guide tracks 164 are sized and configured to restrain movement of the rails 162 and, thus, movement of the coupling bars 106a, 106b. For example, the guide tracks 164 prevent lateral movement of the rails 162. Additionally, the range of motion of the rails 162 is restrained by the pin-in-slot coupling arrangement. More particularly, the coupling bars 106a, 106b extend into the slots 166a, 166b, respectively, defined in the guide tracks 164. As the coupling bars 106a, 106b move relative to the guide tracks 164 and the base 102, the attachment points or mounts for the seat 104 also move relative to the base 102. As a result, the position of the seat 104 relative to the base 102 changes based on the position of the rails 162 within the tracks 164.

In certain instances, it may be desirable to manually operate the leveler 160. In such instances, an operator can manually drive the central drive screw 168 with the manual override knob 182. The manual override knob 182 of the child restraint system 100 is accessible through the front access door 112 (FIGS. 11 and 12) in the shell 110 of the base 102. Rotation of the manual override knob 182 is configured to rotate the drive screw 168 to move the nut 170, which moves the rails 162 and the coupling bars 106a, 106b relative to the tracks 164, as further described herein. In the depicted embodiment, the knob 182 comprises a grip for manual operation.

In other instances, the manual override knob 182 can be rotatable with a tool. In various instances, a tool configured to rotate the knob 182 can be housed in the base 102. For example, a hex wrench or other suitable tool can be housed in the base 102, and can be accessible via the access door 112, 114 and/or by removing the rear cover over the microcontroller 118 (FIG. 13).

It can be necessary to move the motor 184 out of engagement with the gear assembly 181 in order to manually rotate the drive screw 182. For example, to prevent damage to and resistance by the motor 184, the motor 184 can be moved out of driving engagement with at least a portion of the gear assembly 181. In particular, the shiftable support 186 that holds the motor 184 can be configured to shift such that the motor 184 moves out of driving engagement with the gear assembly 181.

Referring primarily to FIG. 17, the shiftable support 186 is supported about a pivot point 187. For example, the shiftable support 186 can be pivotably supported in the gear housing 183. When the shiftable support 186 sufficiently pivots about the pivot point 187, the motor 184 is shifted out of driving engagement with at least a portion of the gear assembly 181. For example, the motor 184 and the worm gear 188 can shift such that the worm gear 188 is moved out of driving engagement with the worm wheel 190a. In such instances, rotation of the motor shaft will not drive the worm wheel 190he, first output gear 190b, or the speed-reducing, torque-increasing gear train that includes the first driven gear 192a, the first driving gear 192b, the second driven gear 194c, the second driving gear 192d, and the third driven gear 192e, which drives the output drive shaft 194 and the drive screw 168. Moreover, rotation of the drive screw 168 will not be transferred back to the motor 184.

In various instances, the motor 184 can be mechanically moved out of driving engagement with the gear assembly 181 when an operator accesses the manual override knob 182. The override knob 182 is accessible through the front access door 112 (FIGS. 11 and 12). The front access door 112 can be linked to the motor support 186 such that, when the front access door 112 is opened, the motor support 186 shifts to move the motor 184 out of driving engagement with the gear assembly 181.

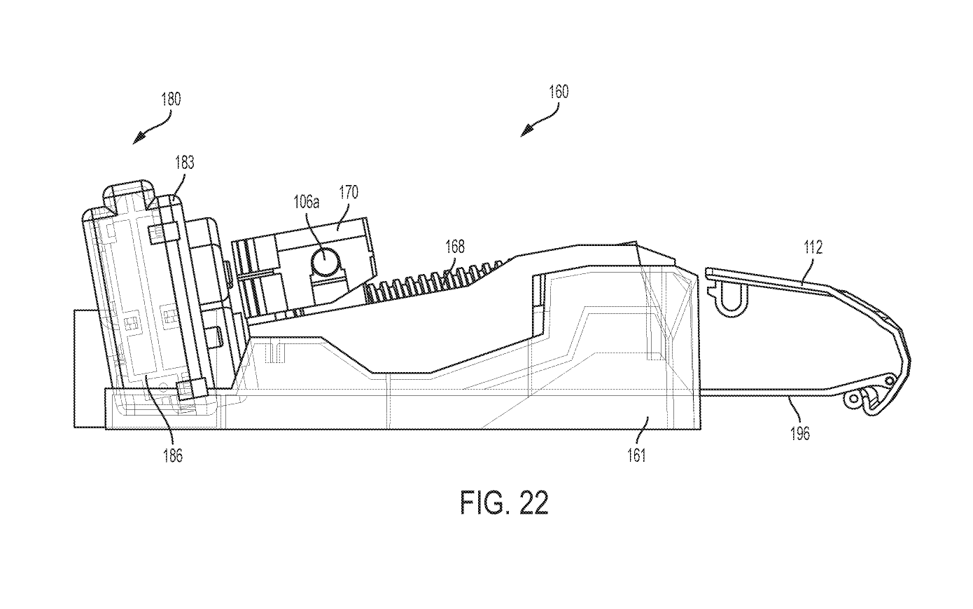

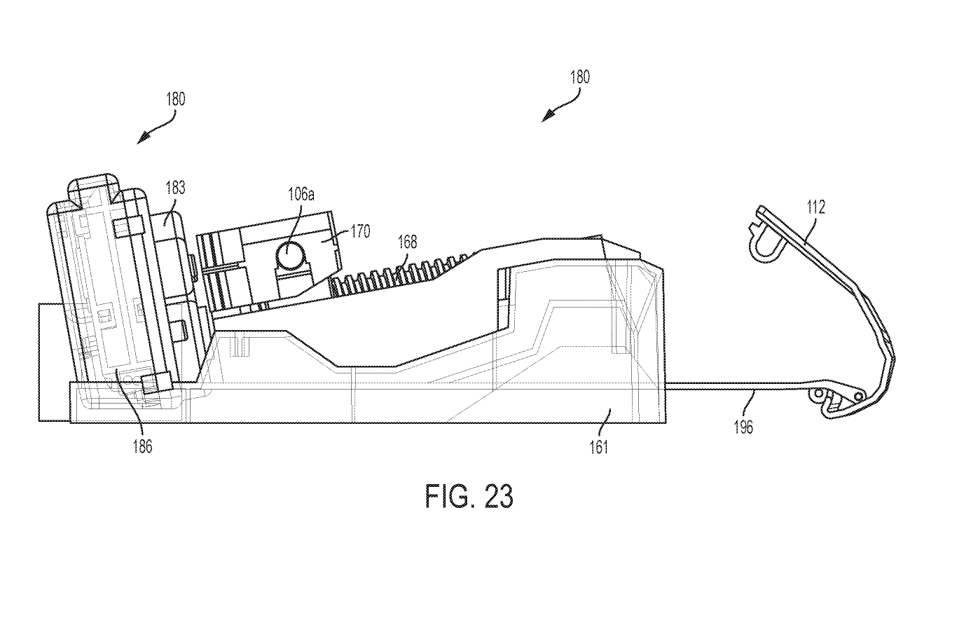

Referring primarily to FIGS. 22 and 23, a linkage 196 extends between the motor support 186 and the front access door 112. When the front access door 112 is moved from a closed position (FIG. 22) to an open position (FIG. 23), the linkage 196 is configured to pull the motor support 186. As a result, the motor support 186 can pivot at the pivot point 187 (FIGS. 16-18) which tilts the motor support 182 and the motor 184 supported thereon. Movement of the linkage 196 is configured to shift the motor 184 out of driving engagement with the gear assembly 181. The manual override knob 182 (FIGS. 14-16) is accessible through the access door 112.

As a result of this arrangement, in the event of a power failure, for example, an operator can manually adjust the leveler 160. Moreover, manual rotation of the drive screw 168 will not damage and/or meet resistance from the motor 184.

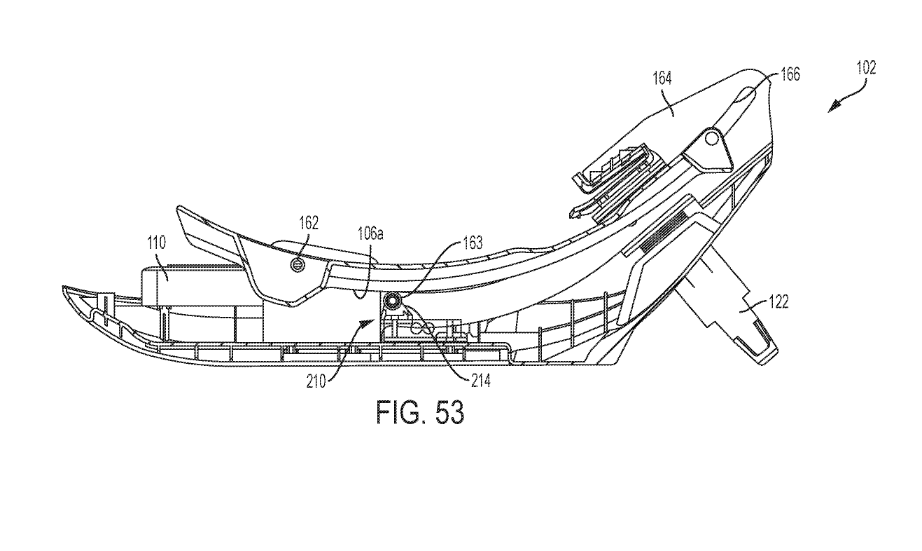

In various instances, the leveler 160 can include at least one sensor for detecting a condition or state of the leveler 160 and/or of the child restraint system 100. For example, the leveler 160 can include sensors for detecting the angle of the seat 104 relative to the base 102, the vehicle, and/or the ground. Additionally, the leveler 160 can include and/or interface with a weight sensor. Referring now to FIG. 53, the base 102 includes a weight sensor 210, which is configured to determine the weight of a child positioned in the seat 104 of the child restraint system 100. The weight sensor 210 can detect the combined weight of the seat 104 and a child therein. As described in greater detail herein, the weight determined by the weight sensor 210 can be provided to the microcontroller 118 (FIG. 13) and/or operator of the system 100, and may be used to determine a recommended installation parameter of the system 100. For example, the recommended facing orientation of the seat 104 and/or the suggested belt system for installing the system 100 in a vehicle seat can depend on the weight determined by the weight sensor 210.

Referring still to FIG. 53, because the rails 162 are configured to move within the tracks 164, the weight sensor 210 is configured to slidably interface with different points along the length of the rails 162. The weight sensor 210 includes a roller 212, which is supported by a roller mount 214. The roller mount 214 can be fixed within the base 102. For example, the roller mount 214 can be fastened or otherwise mounted to the outer shell 110 of the base. As a result of this arrangement, the weight sensor 210 can rollingly engage the rails 162.

The leveler 160 can include additional sensors for detecting an installation condition and/or parameter. For example, the leveler 160 can include a motor current sensor, which is configured to detect the current drawn by the motor 184. If the microcontroller 118 (FIG. 13) determines that the current drawn by the motor 184 is too high, the microcontroller 118 can instruct the operator to operate the leveler 160 manually. The leveler 160 can also include at least one seat angle measurement sensor and at least one base angle measurement sensor. The seat angle measurement sensor(s) can comprise a position sensor on the nut 170, for example, and the base angle position measurement sensor(s) can comprise an accelerometer in the base 102, for example. The microcontroller 118 can be configured to determine the angle of the seat 104 relative to the base 102 based on the measurements from such sensors.

A child restraint system, such as the system 100, can be designed for installation in a vehicle in different ways. For example, the base 102 of the child restraint system 100 can be installed with an integral belt system (e.g. LATCH belts or ISOFIX belts) or a vehicle belt system (e.g. a lap and shoulder belt). The tensioner 130 in the base 102 is configured to tension the engaged belt—either the integral belt system or a vehicle belt system—to securely install the base 102 in the vehicle.

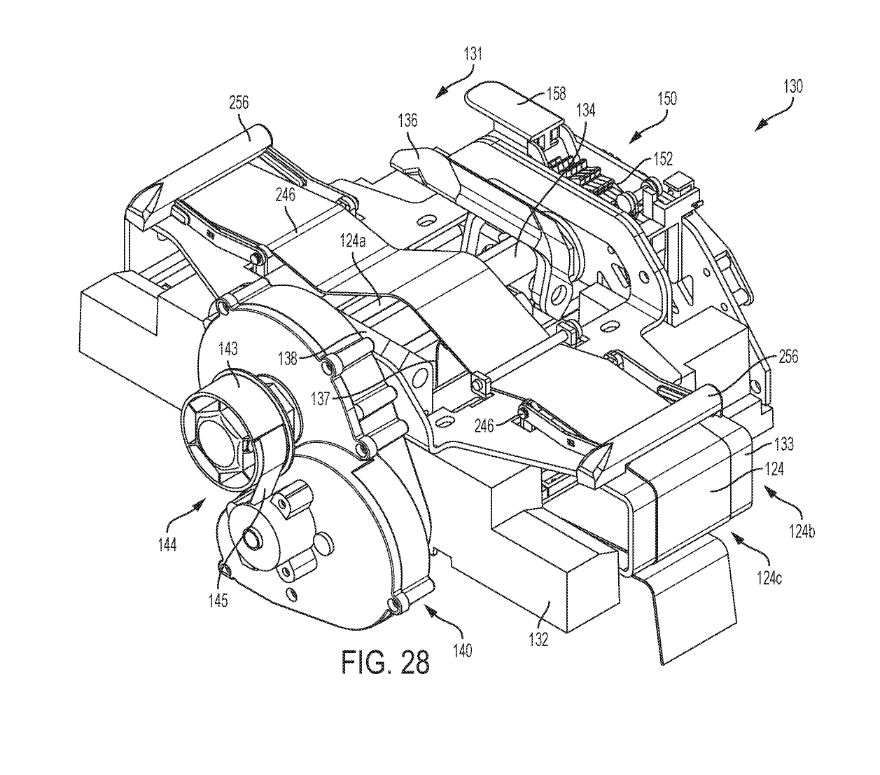

Referring primarily to FIGS. 28-30, the tensioner 130 includes a lock off mechanism 131, a drive system 140, and a ratchet assembly 150. The drive system 140 is configured to drive rotation of the lock off mechanism 131, and the ratchet assembly 150 is configured to releasably restrain rotation of the lock off mechanism. The tensioner 130 also includes a housing 132, which supports the lock off mechanism 131, the drive system 140, and the ratchet assembly 150. The housing 132 is mounted to the base 102. For example, the housing 132 can be fastened to the outer shell 110.

In various instances, the housing 132 can include a body portion and arms 133 extending therefrom. The arms 133 can be configured to guide the integral belt 124 between the rotatable spool 134 and the spring supports 129. In certain instances, the body portion can be comprised of a first material and the arms 133 can be comprised of a second material. For example, the body portion can be comprised of plastic, and the arms 133 can be comprised of metal. The arms 133 can be connected to the body portion of the housing 132 with fasteners, for example.

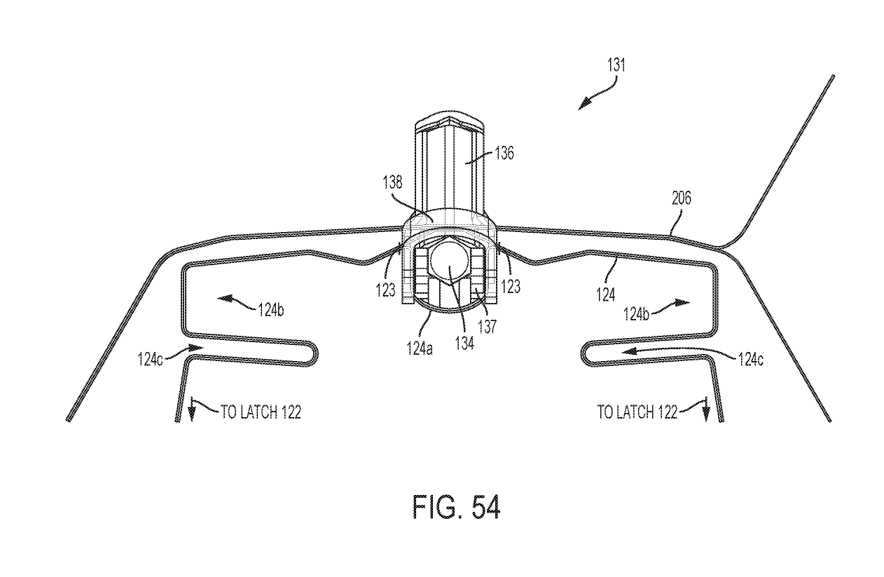

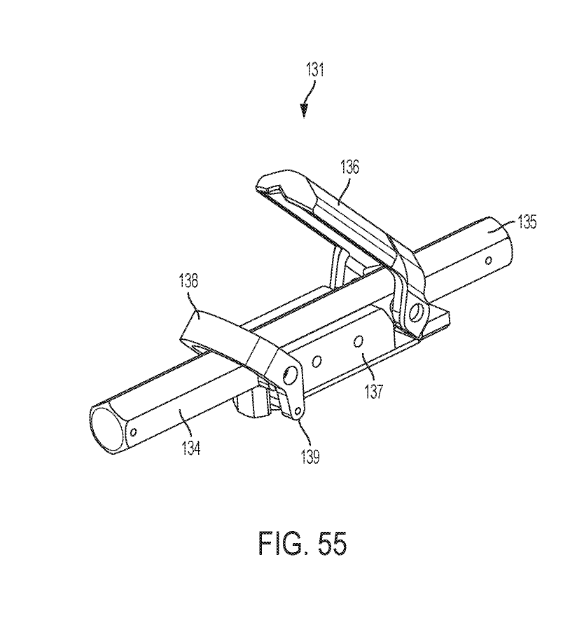

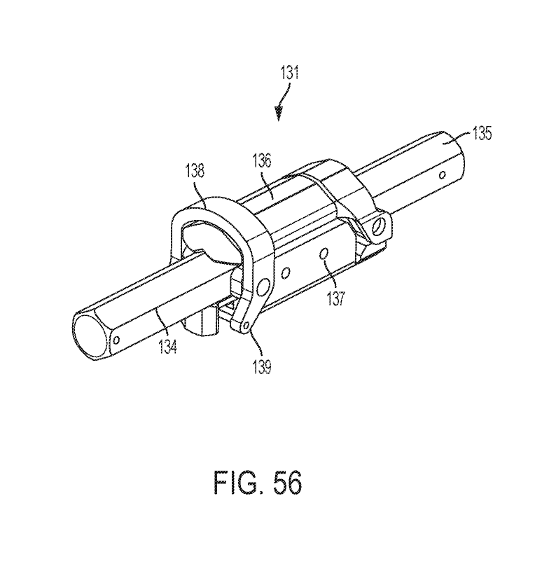

The lock off mechanism 131 of the tensioner 130 is depicted in FIGS. 54-56. The lock off mechanism 131 includes the rotatable spool or tensioning shaft 134 and a support member 137, which defines a channel dimensioned to receive the spool 134. The rotatable spool 134 is secured within the channel of the support member 137. The rotatable spool 134 is rotatably mounted in the housing 132 of the tensioner 130 such that the spool 134 can rotate relative to the housing 132.

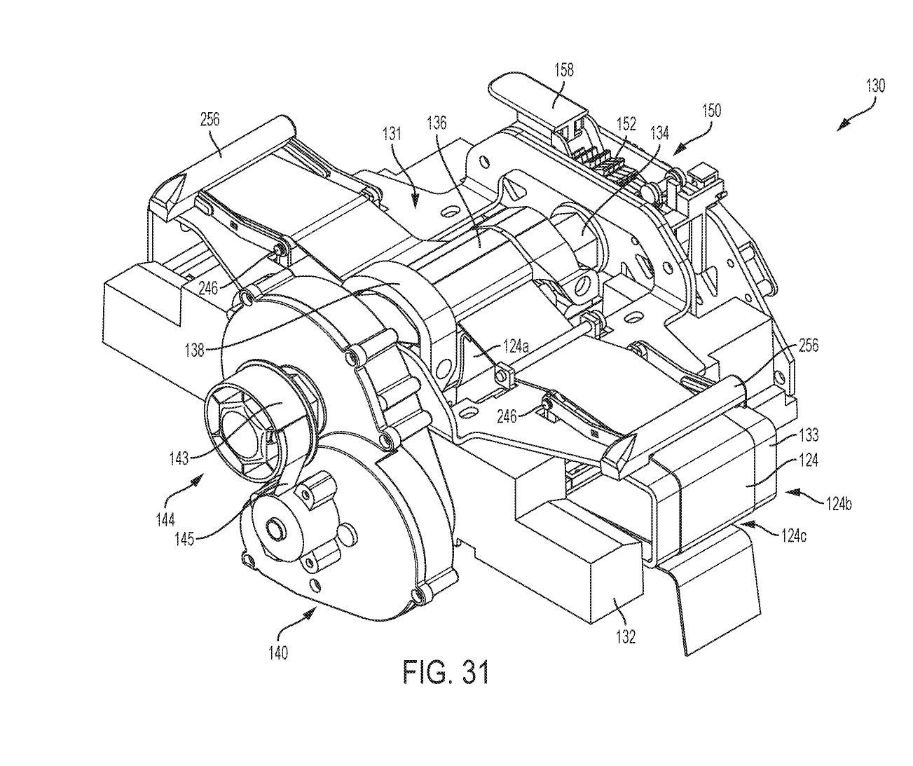

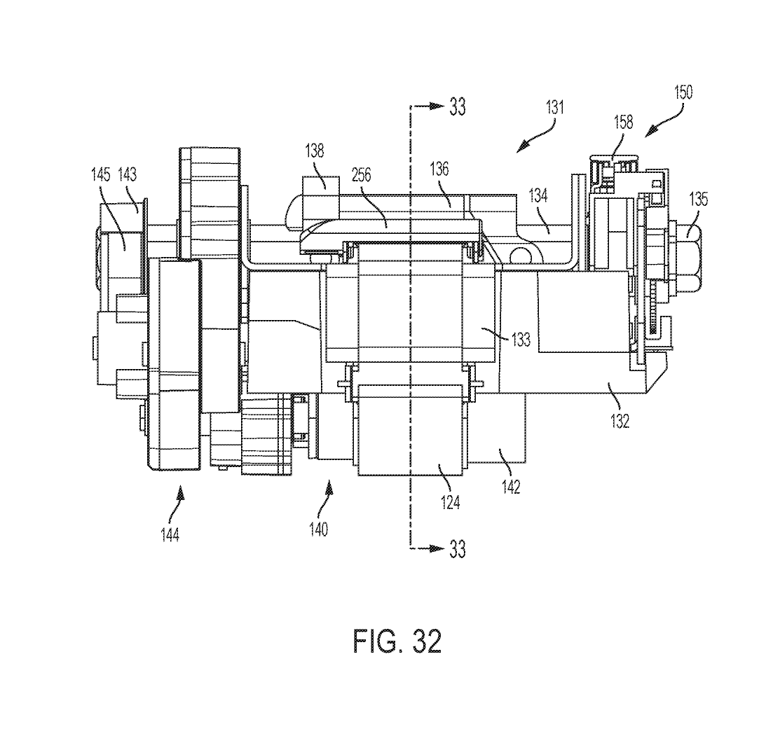

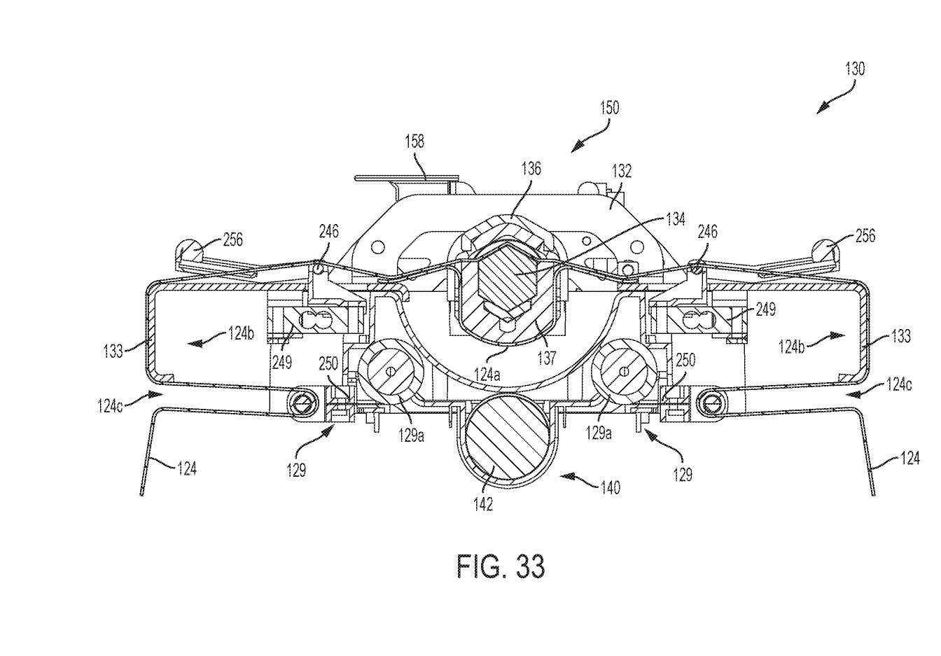

The lock off mechanism 131 also includes a clamp arm 136, which is pivotable relative to the spool 134. As further described herein, the clamp arm 136 can pivot from an unclamped position (see, e.g., FIGS. 28-30) to a clamped position (see, e.g., FIGS. 31-33) to clamp the integral belt 124 and, optionally, the vehicle belt 206. The lock off mechanism 131 also includes a lock 138 for locking the clamp arm 136 in the clamped position. The lock 138 is connected to the support member 137 at a pivot pin 139, and the lock 138 can pivot relative to the support member 137 and the clamp arm 136. When the rotatable spool 134 is rotatably driven by the drive system 140, the support member 137, the clamp arm 136, and the lock 138 are configured to rotate along with the rotatable spool 134.

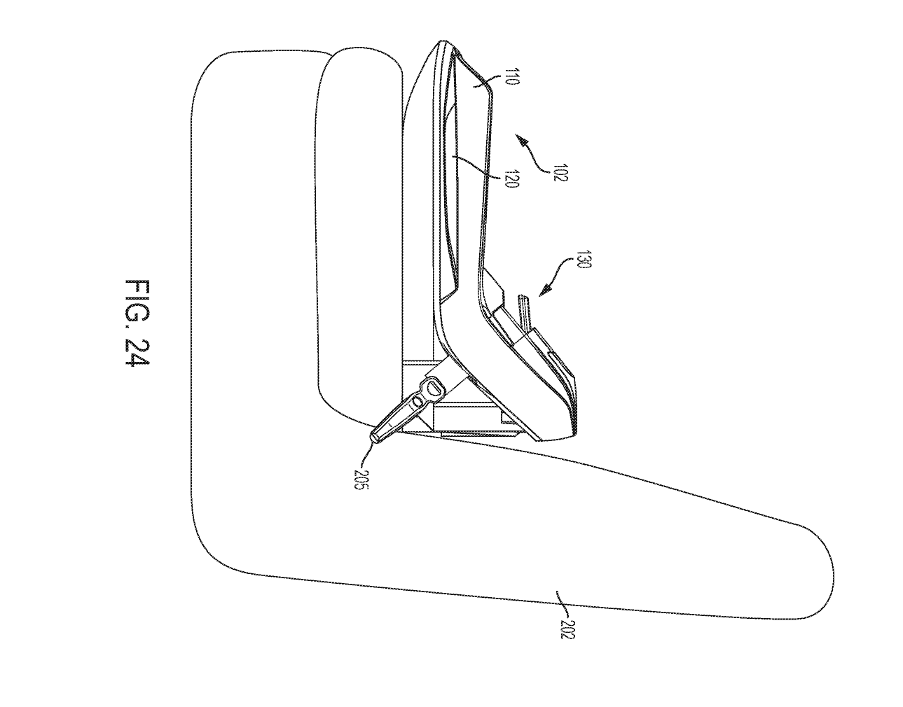

Referring primarily to FIG. 24, the base 102 is depicted on the seat 202 of a vehicle. The base 102 is attached to an anchor 205 in the seat 202. More particularly, the integral belt 124 of the base 102 includes a latch 122 at the end of the integral belt 124. In fact, the base 102 includes two latches 124, and a latch 122 extends from each end of the integral belt 124. The integral belt 124 is fixed to the base 102. As further described herein, the integral belt 124 is mounted to the rotatable spool 134 (see, e.g., FIGS. 28-30) in the base 102. Rotation of the spool 134 affects extension or retraction of the integral belt 124 and the latches 122 from the base 102. The integral belt 124 is configured to retractably extend from the base 102 such that the latches 122 can be fasten to anchors 205 in the vehicle seat.

The integral belt 124 can be fixed to the base 102 in a variety of ways. For example, the integral belt 124 can be permanently attached to the rotatable spool 134 in the base 102. Referring primarily to FIG. 54, the integral belt 124 is attached to the lock off mechanism 131 in the tensioner 130. More specifically, the integral belt 124 is attached to the spool 134 and to the support member 137 of the lock off mechanism 131.

Referring still to FIG. 54, the integral belt 124 includes a sewn-on portion 124a that is attached with at least two rows of stitching 123. The sewn-on portion 124a forms a loop of material, and the support member 137 and the rotatable spool 137 are threaded through the loop of material between the rows of stitching 123. The lock off mechanism 131 also includes the clamp arm 136. When the clamp arm 136 is moved to a clamped position, as further described herein, a portion of the integral belt 124 is held between the clamp arm 136 and the spool 134. The rows of stitching 123 forming the loop of material 124a around the lock off mechanism 131 can hold the integral belt 124 to the lock off mechanism 131 such that a portion of the integral belt is drawn around the rotatable spool 134 as the lock off mechanism 131 rotates.

In various instances at least a portion of the integral belt 124 can include multiple layers of material that are sewn together. In such instances, the support member 137 and/or the rotatable spool 134 can be positioned between the layers of the integral belt 124. In other instances, a portion of the integral belt 124 could extend through a slot 134 in the rotatable spool. The integral belt 124 can be permanently attached to the rotatable spool 134. For example, the integral belt 124 can be clamped and/or fastened to the rotatable spool with a suitable fastener, such as a screw, rivet, and/or adhesive.

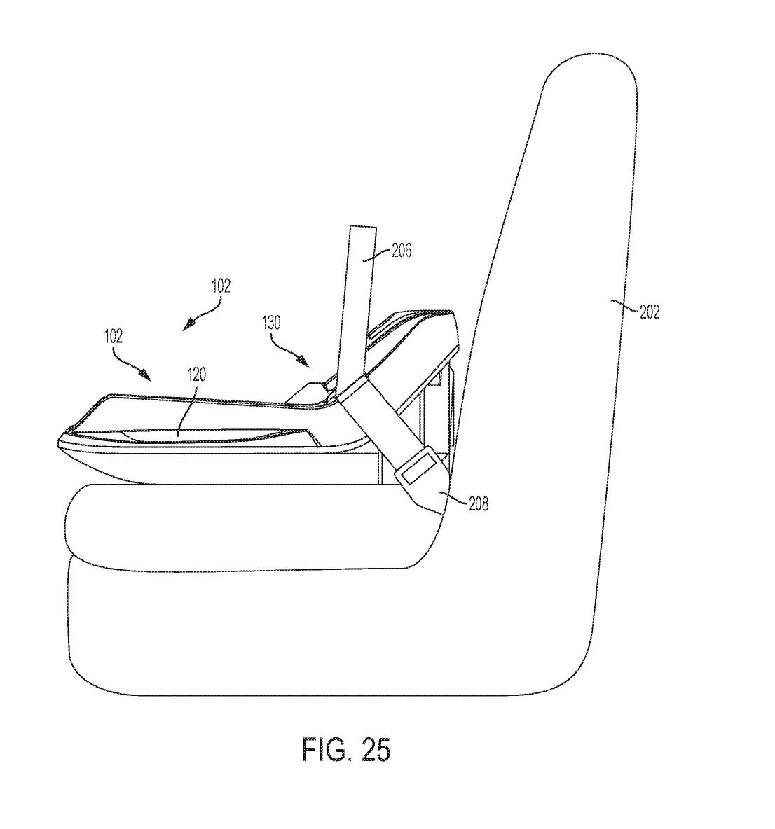

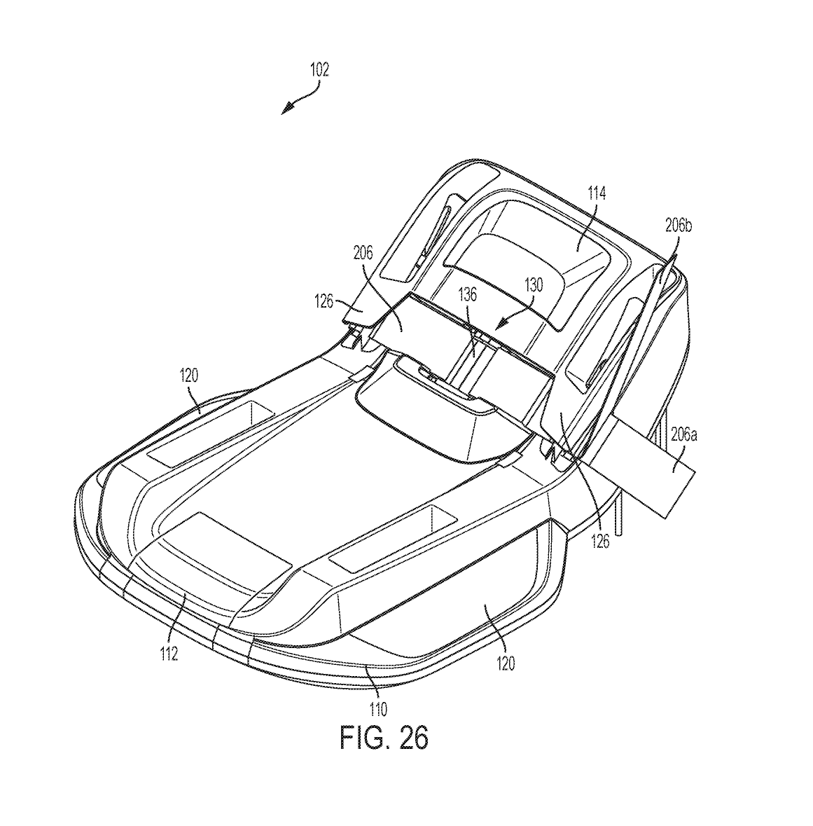

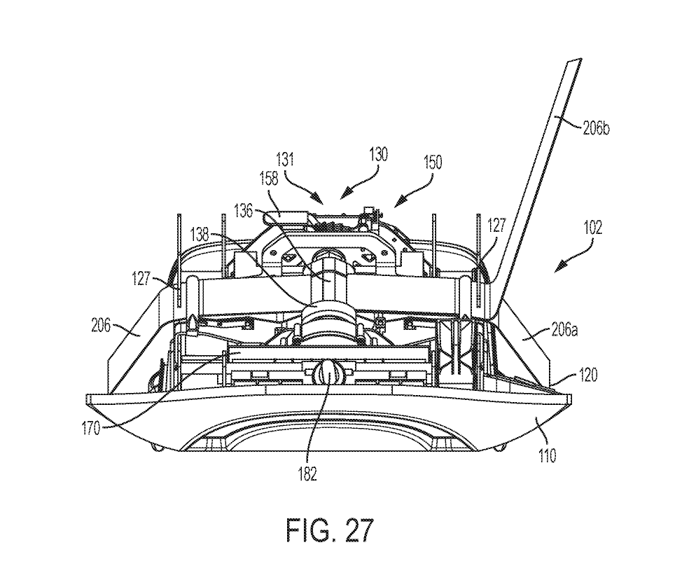

Referring now to FIGS. 25-27, the base 102 of the child restraint system 100 can also be attached to the seat 202 by a vehicle belt 206. The vehicle belt 206 can include a lap belt 206a and a shoulder belt 206b. In various instances, the vehicle belt 206 can be used instead of the integral belt 124. The vehicle belt 206 is configured to engage a belt buckle 208 mounted to the seat 202. Moreover, the vehicle belt 206 is positionable through hooks 126 on the base 102. For example, the outer shell 110 of the base 102 includes a pair of hooks 126 on either side thereof. Moreover, the tracks 164 include hooked portions 127, which correspond to the hooks 126 on the outer shell 110. The vehicle belt 206 can be threaded through the hooks 126 in the base 102 and the hooked portions 127 of the tracks 164 and fastened to the seat 202 of the vehicle with the belt buckle 208 to mount the base 102 to the seat 202.

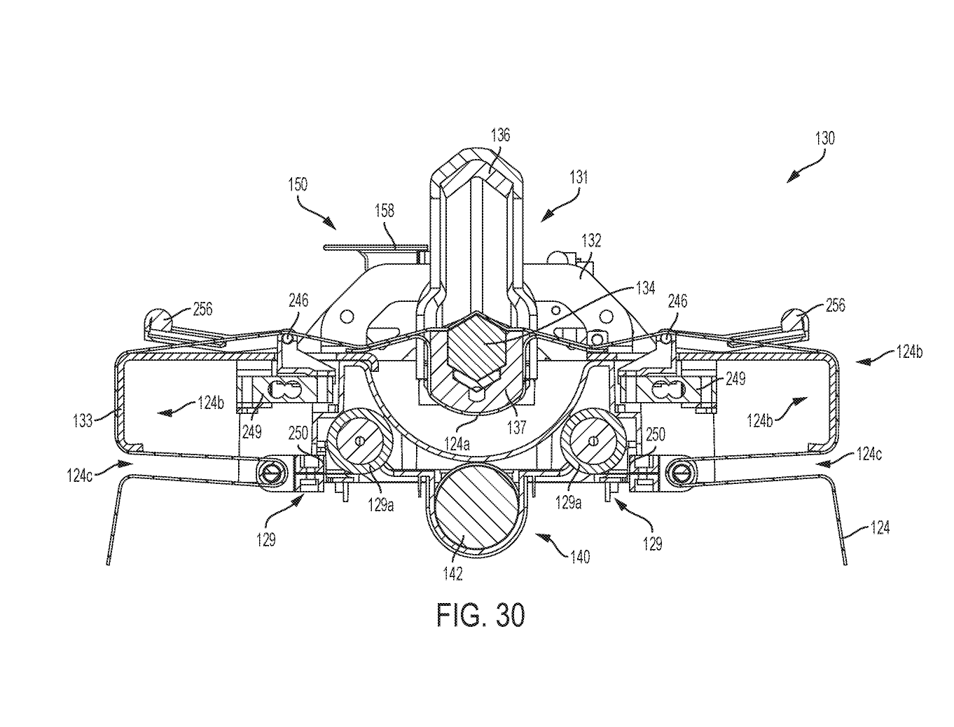

As further described herein, the vehicle belt 206 can be clamped to the rotatable spool 134 (see, e.g., FIG. 30) in the base 102 by the lock off mechanism 131. In such instances, the vehicle belt 206 can retractably extend from the base 102 to connect the vehicle belt 206 to the buckle 208 of the seat 202. When the vehicle belt 206 is engaged with the base portion 102, a portion of the vehicle belt 206 can be positioned between the clamp arm 136 and the rotatable spool 134 of the lock off mechanism 131 (see, e.g., FIG. 54). The vehicle belt 206 can be positioned over the integral belt 124, for example. When the clamp arm 136 is moved to the clamped position, as further described herein, a portion of the vehicle belt 206 is clamped between the clamp arm 136 and the spool 134. Friction between the clamping surfaces is configured to hold the vehicle belt 206 relative to the support member 137, the clamp arm 136, and the spool 134. In such instances, the vehicle belt 206 and the integral belt 124 can be drawn around the clamp arm 136 when the lock off mechanism 131 is rotated, as further described herein.

In other instances, the lock off mechanism 131 can include more than one rotatable spool. For example, the integral belt 124 can be mounted to a first rotatable spool, and the vehicle belt 206 can operably engage a second rotatable spool. The spools can rotate independently. In other instances, the spools can rotate together.

Referring again to FIG. 54, the pathway of the integral belt 124 is shown. A central portion of the integral belt 124 is attached to the lock off mechanism 131, as described herein. For example, the belt extension 124a forms a portion of a loop, which is positioned around the rotatable spool 134. From the lock off mechanism 131, the integral belt 124 extends in a first direction toward a first latch 122 and in a second direction toward a second latch 122.

Between the lock off mechanism 131 and each latch 122, the integral belt 124 forms an S-shaped path. A first portion 124b of the belt 124 on each side of the lock off mechanism 131 extends around arms 133 (see, e.g., FIG. 30) of the housing 132. A second portion 124c of the belt 124 on each side of the lock off mechanism 131 extends around spring supports 129 (see, e.g., FIG. 30) on the housing 132. The spring supports 129 are configured to absorb slack in the integral belt 124 during a tensioning operation, as further described herein. The spring supports 129 include springs 129a. The springs 129a can be constant force springs, for example.

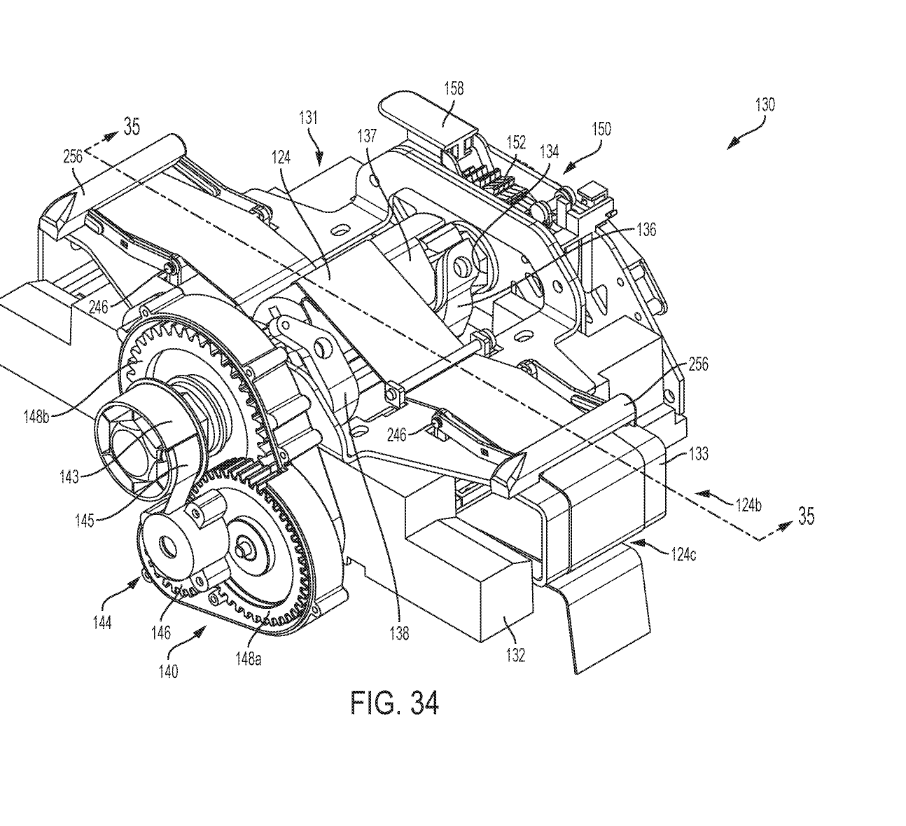

Referring now to FIG. 34, the drive system 140 is configured to drive the rotation of the rotatable spool 134. The drive system 140 includes a motor 142 and a gear assembly 144 mounted to the housing 132. The motor 142 is operably configured to drive the gear assembly 144, which is connected to the rotatable spool 134. In such instances, operation of the motor 142 is configured to rotate the spool 134, as well as the rest of the lock off mechanism 131, relative to the housing 132. Referring primarily to FIG. 34, the gear assembly 144 includes an input gear 146 coupled to the motor 142, and a plurality of drive gears 148a, 148b. The drive gears 148a, 148b are configured to reduce the rotational speed and increase the output torque applied to the spool 134. In various instances, the gear reduction ratio of the gear assembly 144 can be 4:1. In other instances, the gear reduction ratio can be greater than 4:1 or less than 4:1. In various instances, the tensioner 130 may not include a motor. For example, the tensioner 130 can be manually operated.

Referring again to FIGS. 28-30, the clamp arm 136 is depicted in an unclamped position relative to the spool 134. The clamp arm 136 is configured to pivot about a pivot joint 137 to move toward the clamped position (see, e.g., FIGS. 31-33) relative to the spool 134. The clamp arm 136 is biased toward the unclamped position. For example, a spring can act on the clamp arm 136 to bias the arm 136 toward the unclamped position. In at least one instance, the spring can be a torsion spring. In other instances, additional and/or different springs and/or biasing arrangements can be utilized. The lock 138 is configured to pivot about the pivot pin 139 to hold the clamp arm 136 in the clamped position. When the lock 138 is holding the clamp arm 136 in the clamped position, frictional forces between the clamp arm 136 and the lock 138 can resist disengagement of the lock 138 from the clamp arm 136. Alternatively, a cam can be used to hold the lock 138 in the locked or engaged position, and can release the lock 138 when a user pushes the lock 138 to the disengaged or unlocked position.

In certain instances, a cam can be configured to hold the lock 138 in the unlocked position when the clamp arm 136 is in the unclamped position. In such instances, the cam can be configured to release the lock 138 when the clamp arm 136 is moved to the clamped position. As a result, when the clamp arm 136 is moved to the clamped position, the lock 138 can be released by the cam such that the lock 138 can move to the locked or engaged position to hold the clamp arm 136 in the clamped position.

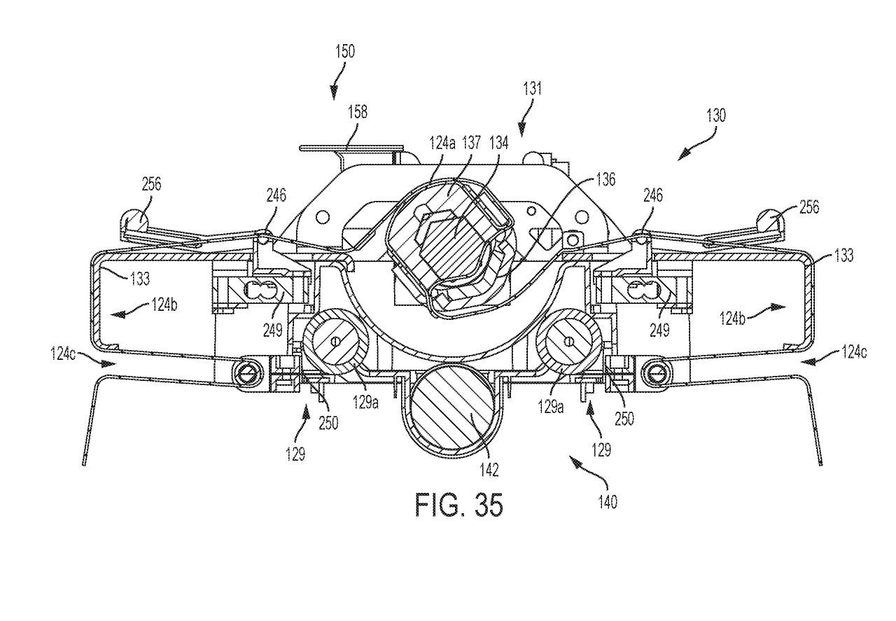

When the clamp arm 136 is moved to the clamped position, referring now to FIGS. 31-33, the integral belt 124 is positioned between the clamp arm 136 and the spool 134. The clamping force generated by the clamp arm 136 and the lock 138 are configured to prevent slippage of the integral belt 124 relative to the spool 134. Referring now to FIGS. 34 and 35, the drive system 140 can rotate the spool 134 to retract a portion of the integral belt 124 into the base 102. As a result, the latches 122 extending from the ends of the integral belt 124 can be retracted toward the spool 134. In such instances, when the latches 122 are secured to the anchor 205 in the seat 202 (FIG. 24), the integral belt 124 can be tensioned to pull the base 102 closer toward the anchor 205 and the seat 202 (see FIG. 24).

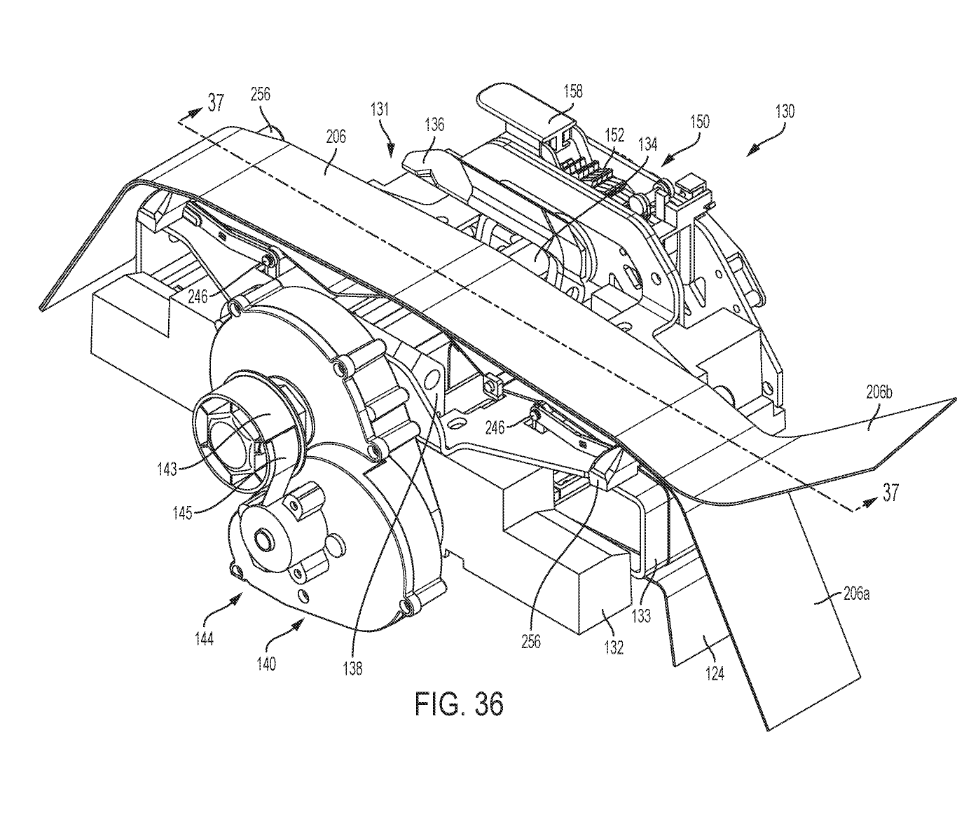

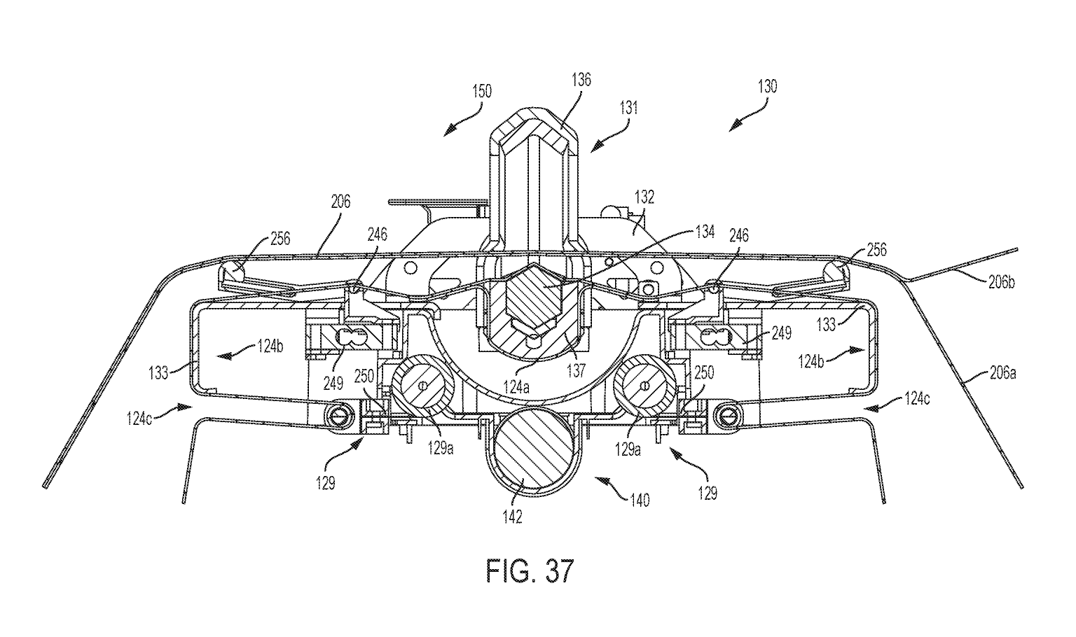

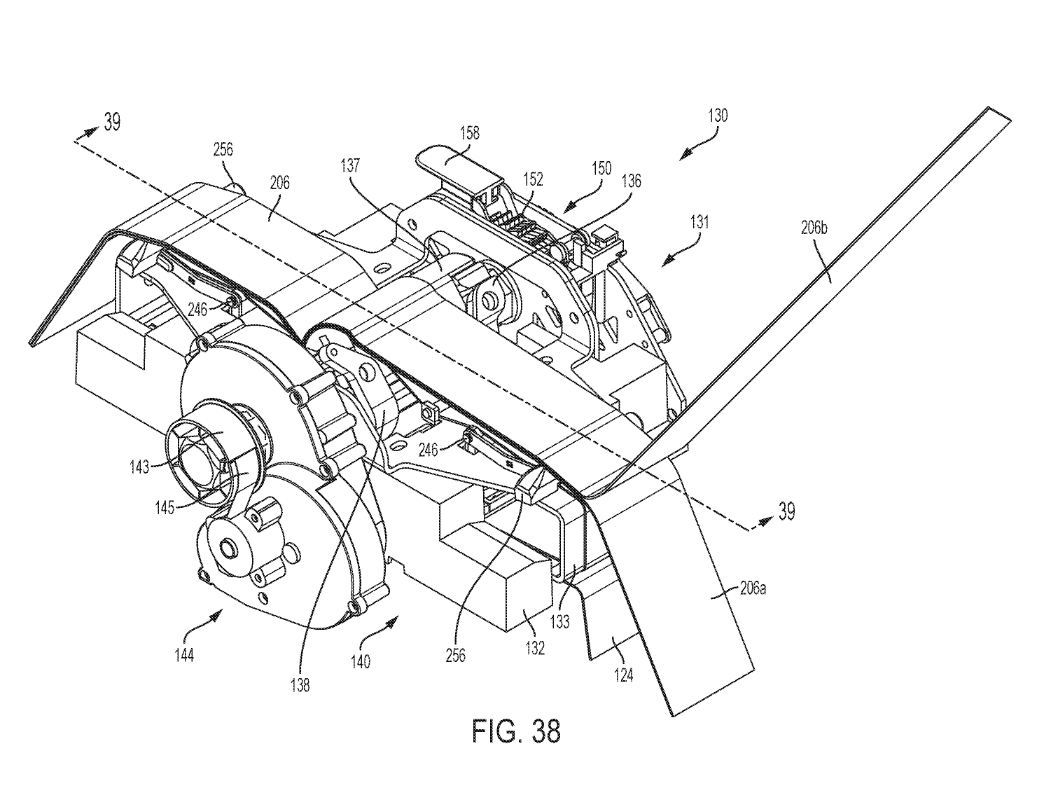

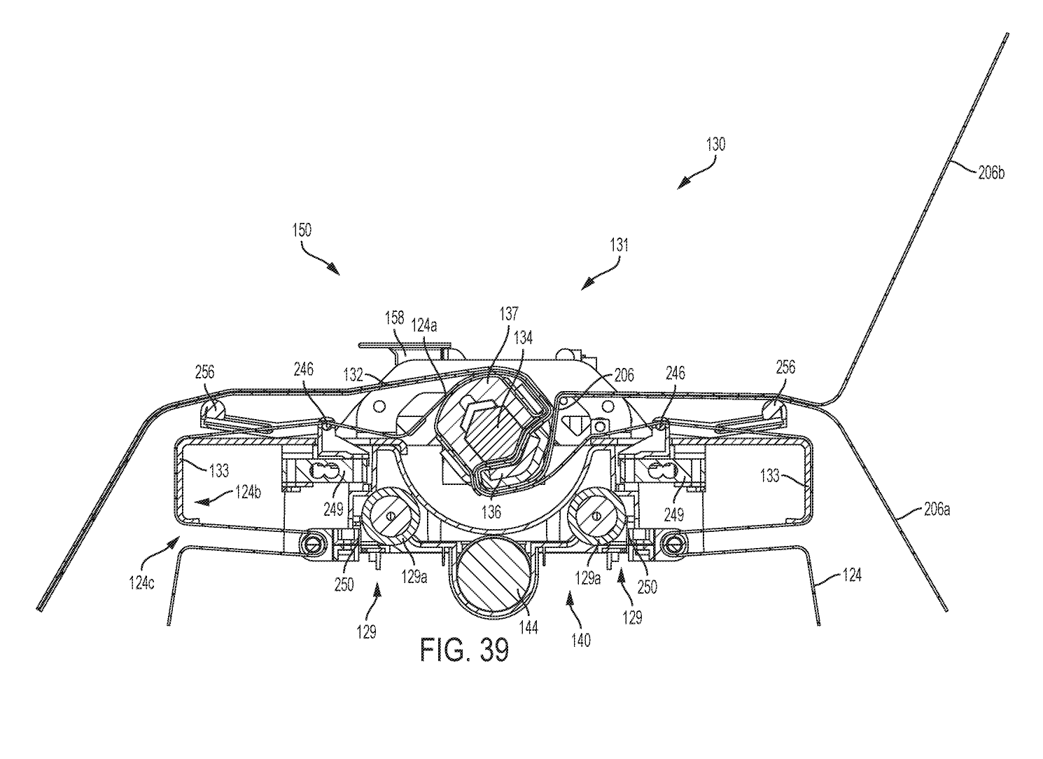

Similarly, when the vehicle belt 206 is engaged with the base 102 and the buckle 208 in a vehicle (FIG. 25), the tensioner 130 can tension the vehicle belt 206. In such instances, the vehicle belt 206 can extend through the hooks 126 of the outer shell 110. Referring primarily to FIGS. 36 and 37, the vehicle belt 206 can be threaded under the clamp arm 136 and positioned over the integral belt 124. Thereafter, referring to FIGS. 38 and 39, the clamp arm 136 can be moved to the clamped position such that the vehicle belt 206 is clamped to the spool 134. The clamping force generated by the clamp arm 136 and the lock 138 can prevent rotational movement of the vehicle belt 206 relative to the spool 134. The drive system 140 can rotate the spool 134 to retract a portion of the vehicle belt 206 into the base 102. As a result, the vehicle belt 206 can be tensioned to pull the base 102 closer toward the buckle 208 and the seat 202.

When the tensioner 130 winds the vehicle belt 206 around the rotatable spool 134, the tensioner 130 is also configured to wind the integral belt 124 around the rotatable spool 134. As the integral belt 124 is retracted into the base 102, the S-shaped pathways of the integral belt 124 are configured to change. More particularly, the force in the integral belt 124 is applied to the spring supports 129, which causes the spring supports 129 to deform. For example, the spring supports 129 are deformed outwardly by the tensioning forces in the integral belt 124. Because of the deformation of the spring supports 129, the latches 122 at the ends of the integral belt 124 are not retracted toward the base 102 when the rotatable spool 134 is rotated a first amount. Rather, the spring supports 129 absorb or accommodate the first amount of rotation.

As a result of this arrangement, the vehicle belt 206 can be tensioned by the tensioner 130 without retracting the latches 122. For example, when the rotatable spool 134 is rotated a first amount to tension the vehicle belt 206, the spring supports 129 can deform to accommodate the first amount of rotation. To tension the integral belt 124, the rotatable spool 134 can be rotated beyond the first amount of rotation. In such instances, the spring supports 129 can reach a maximum deformation such that rotation of the spool 134 beyond the first amount of rotation results in retractions of the latches 122 toward the base 102.

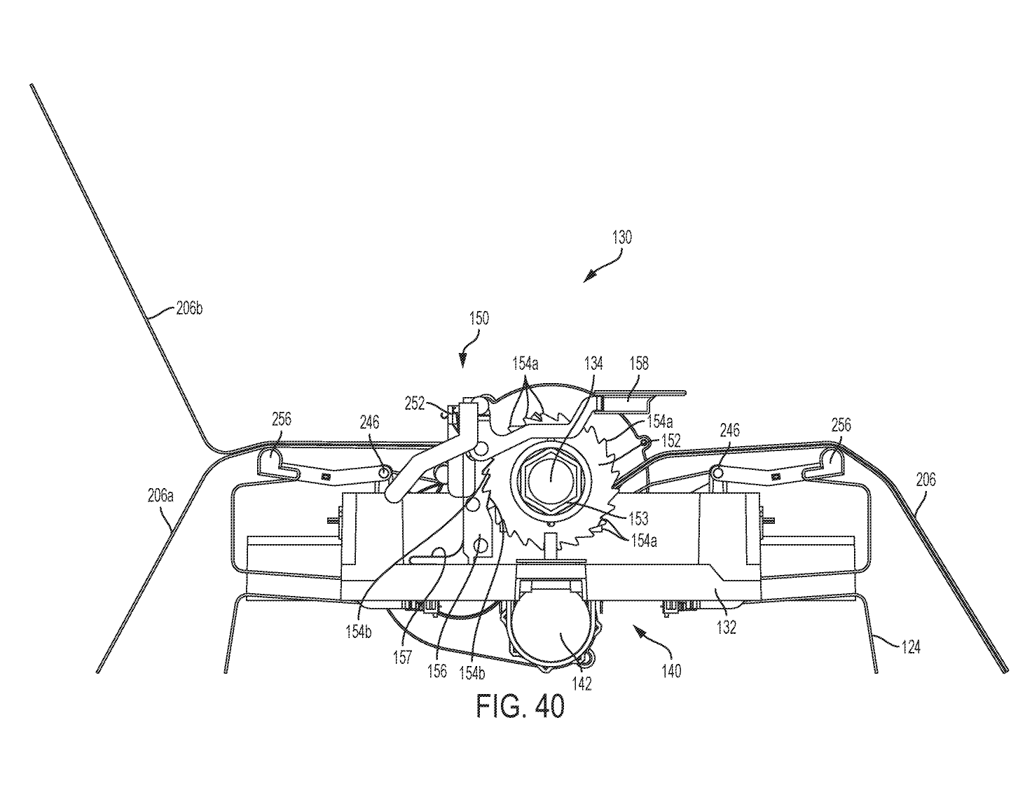

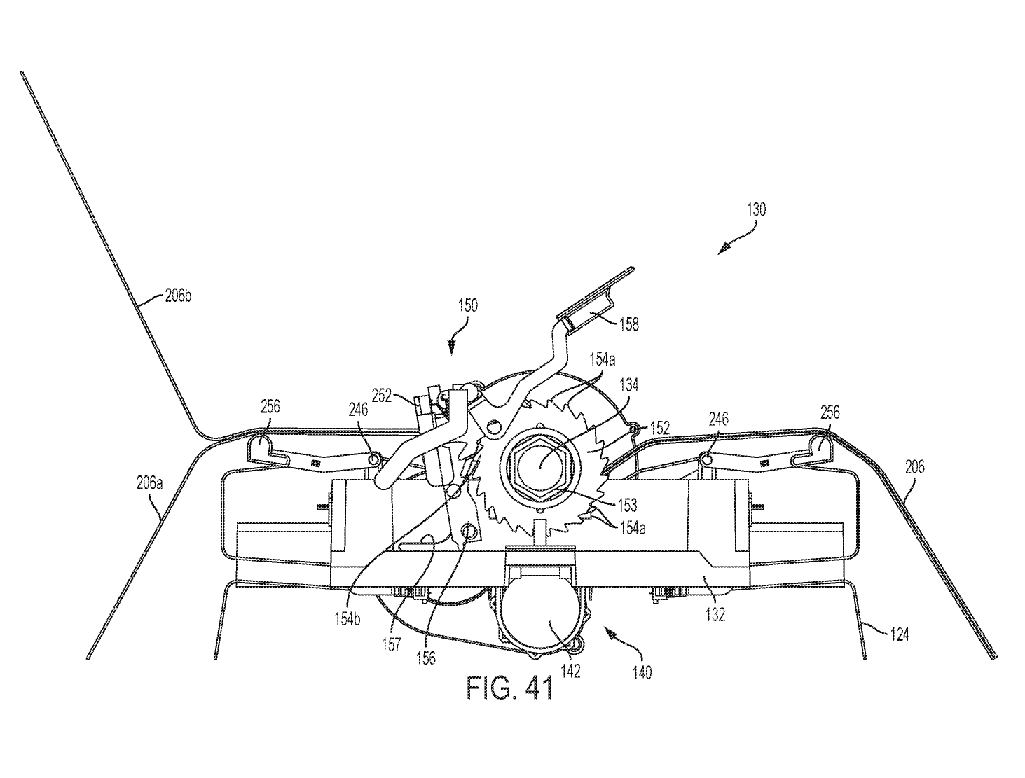

The ratchet assembly 150 is configured to releasably lock the spool 134 in position. Referring primarily to FIGS. 40 and 41, the ratchet assembly 150 includes a ratchet wheel 152 comprising a plurality of teeth 154a and a pawl 156 comprising a plurality of complementary teeth 154b. The ratchet assembly 150 also includes a spring 157, which is positioned to bias the pawl 156 into engagement with the ratchet wheel 152. The spring 157 can be a leaf spring, for example. The ratchet assembly 150 also includes a handle 158 for moving the pawl 156.

The ratchet wheel 152 is mounted to the rotatable spool 134. In the depicted embodiment, the rotatable spool 134 defines a hexagonal perimeter and the ratchet wheel 152 defines an aperture 153 having a complementary hexagonal perimeter. The spool 134 can be positioned within the aperture 153, such that the ratchet wheel 152 and the spool 134 are configured to rotate together. In such instances, when the tensioner 130 tensions one of the integral belt 124 or the vehicle belt 206, the ratchet wheel 152 can rotate with the spool 134. Referring still to FIGS. 40 and 41, the spool 134 and the ratchet wheel 152 can rotate clockwise to tension the engaged belt.

The engaged configuration of the ratchet assembly 150 is depicted in FIG. 40. When the ratchet assembly 150 is in the engaged configuration, the ratchet wheel 152 can rotate clockwise. Counterclockwise rotation is prevented by the spring-loaded pawl 156 in locking engagement with the ratchet wheel 152. In such instances, the spool 134 can rotate to tension the engaged belt; however, the spool 134 cannot be unwound to release the tension in the engaged belt.

The disengaged configuration of the ratchet assembly 150 is depicted in FIG. 41. When the ratchet assembly 150 is moved to the disengaged configuration, the ratchet wheel 152 is free to rotate relative to the pawl 156. As a result, rotation of the spool 134 is not constrained by the ratchet assembly 150. Referring still to FIGS. 40 and 41, the ratchet pawl 156 can be clamped or biased toward engagement with the ratchet wheel 152. For example, the handle 158, the ratchet lever 156, and the housing 132 can form a toggle clamp mechanism, which is moveable between an unclamped position (FIG. 41) and an over-center, clamped position (FIG. 40). The toggle clamp mechanism can hold the ratchet assembly 150 in the engaged configuration until a user lifts the handle 158 and overcomes the clamp to move the ratchet assembly 150 to the disengaged configuration.

In various instances, a spring can act on the rotatable spool 134 to bias the spool 134 toward a home or non-tensioned position. Referring to FIG. 28, a constant force spring 145 is engaged with a fixture 143 on the rotatable spool 134. For example, an end of the spring 145 is fixed in a slot in the fixture 143 and another end of the spring 145 is fixed to the housing of the gear assembly 144. The fixture 143 is configured to rotate with the spool 134. As the spool 134 and the fixture 143 rotate, the end of the spring 145 is drawn around the fixture 143 and a rebounding spring force is generated. As a result, when the driving force is removed from the rotatable spool 134 and when the ratchet system 150 is disengaged, the spring 145 is configured to draw the fixture 143 and the spool 134 back to the home or non-tensioned position.

The ratchet system 150 is configured to provide a mechanical backup to the motor-driven system 140. For example, in the event of a power failure, the ratchet system 150 is configured to prevent backward rotation or unwinding of the spool 134 and, thus, to maintain the tension in the engaged belt system. For example, the toggle clamp mechanism of the ratchet assembly 150 is configured to hold the teeth 154b of the ratchet pawl 156 in engagement with the complementary teeth 154a of the ratchet wheel 152. If the motor 142 became disabled or if manual operation of the tensioner 130 was desired, as further described herein, the foregoing mechanical backup is configured to maintain the tension in the engaged belt system.

In certain instances, it may be desirable to manually operate the tensioner 130. In such instances, an operator can manually rotate the spool 134 with a manual override knob 135. In the depicted embodiment, the knob 135 defines an end portion of the spool 134. The knob 135 defines a hexagonal perimeter, and can be rotated by hand and/or with a tool, such as a hex wrench. The manual override knob 135 is accessible through the rear access door 114 (FIG. 12) in the shell 110 of the base 102. Rotation of the manual override knob 135 is configured to rotate the spool 134 to adjust the tension in the engaged belt system. The ratchet assembly 150 can prevent unwinding of the spool 134. In various instances, a tool can be housed in the base 102 and the tool can be configured to rotate the knob 135. For example, a hex wrench or other suitable tool can be housed in the base 102, and can be accessible via the access door 112, 114 and/or by removing the rear cover over the microcontroller 118 (FIG. 13).

As described herein, the spool 134 is configured to tension multiple belt systems. For example, in a first instance, the spool 134 can tension an integral belt 124 that is engaged with the anchor 205 in a vehicle (FIG. 24). In another instance, the spool 134 can tension a vehicle belt 206 that is engaged with the buckle 208 in a vehicle (FIG. 25). Such a spool 134 provides a common bobbin or reel for multiple belt systems.

In various instances, the tensioner 130 can include at least one sensor for detecting a condition of the tensioner 130. For example, the tensioner 130 can include tension sensors 246 (see, e.g., FIGS. 28 and 30). The tension sensors 246 are positioned to contact the integral belt 124. For example, the integral belt 124 can extend across the tension sensors 246. The tension sensor 246 can detect if the belt has been tensioned. The tension sensors 246 are coupled to a load cell 249, which is configured to detect the amount of tension in the belt 124.

The tensioner 130 can also include vehicle belt tension sensors 256, which can be positioned to contact the vehicle belt 206 when the vehicle belt 206 is engaged with the base 102. For example, when the vehicle belt 206 is engaged with the base 102, the vehicle belt 206 can be positioned across the vehicle belt tension sensors 256, and the sensors 256 can determine the tension in the belt 206. The tension sensors 256 are coupled to the load cell 249, which is configured to detect the amount of tension in the belt 206.

The tensioner 130 also includes switches 250 (see, e.g., FIG. 30), which are configured to detect if the spring supports 129 have reached their maximum deformation. For example, when the spring supports 129 have reached their maximum deformation, the spring supports 129 can contact the switch 250. The tensioner also includes a switch 252 (FIGS. 40 and 41), which is configured to detect if the ratchet assembly 150 is in the engaged or disengaged configuration. The sensors 246, 256, 250, 252 can be in communication with the microcontroller 118 (FIG. 13), which is configured to issue commands during a startup and/or installation sequence based on the feedback from the sensors 246, 256, 250, and 252.

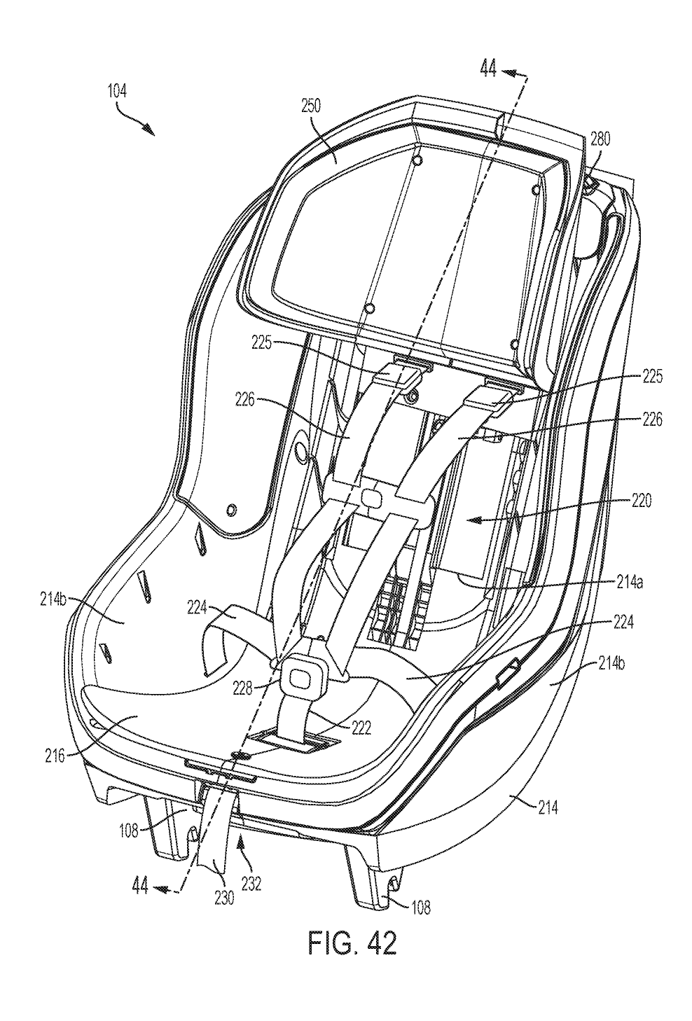

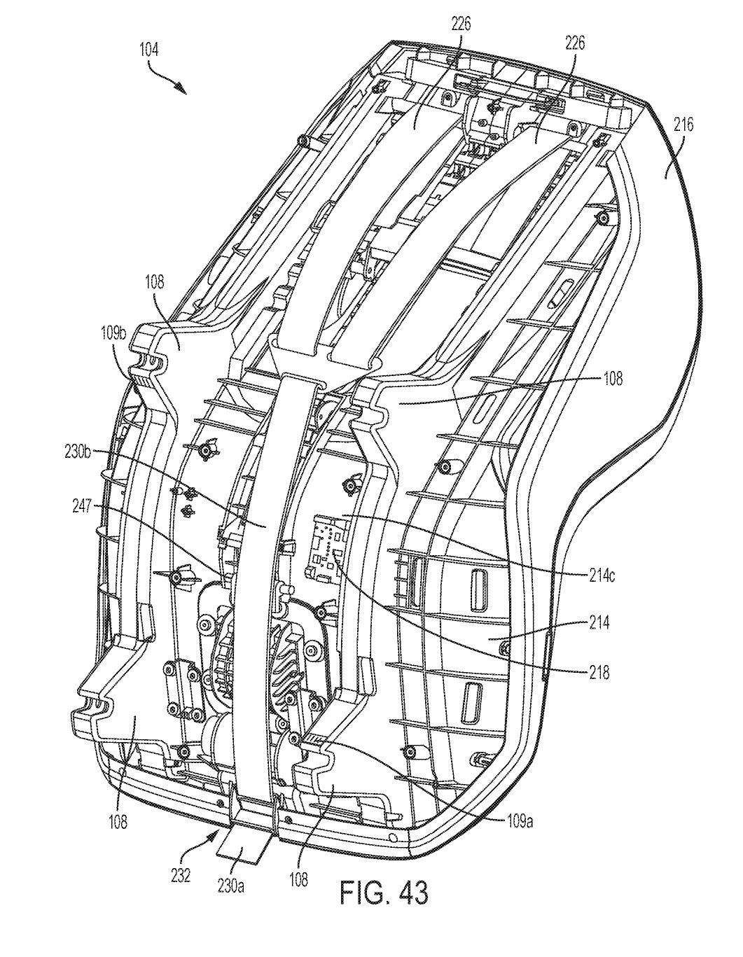

Referring primarily to FIGS. 42 and 43, the seat 104 of the child restraint system 100 includes a frame 214 and a cushioned support 216. The frame 214 defines a seat in which a child can sit. The frame 214 defines a back support 214a and two armrests or sides 214b. The frame 214 also includes a base 214c (see, e.g., FIG. 43). The back support 214a and the sides 214b extend from the base 214c. The frame 214 is rigid, and the cushioned support 216 is yielding or soft. The cushioned support 214 is configured to provide a comfortable layer between the child and portions of the frame 214.

The seat 104 includes a harness 220, which is configured to restrain a child positioned in the seat 104. The harness 220 is a five-point harness, which includes five straps including a central strap 222, two lap straps 224, and two shoulder straps 226. The harness 220 also includes a central buckle 228 at which the straps 222, 224, and 226 meet. In various instances, the harness 220 is adjustable to accommodate a size range of children. The harness 220 can be tightened around a child by pulling on a tensioning strap 230a, 230b that extends from the seat 104. The tensioning strap 230a, 230b can be pulled through a locking slot 232, which permits one-way travel of the tensioning strap 230a, 230b to tighten the harness 220. A first portion 230a of the strap can protrude from the seat 104 through the locking slot 232, and a second portion 230b of the strap can be contained within the seat 104. In various instances, the locking slot 232 can a include ratchet mechanism. An operator can unlock the locking slot 232 to retract the tensioning strap 230a, 230b and loosen the harness 220. For example, an operator can press a button and/or lift a lever to unlock the ratchet mechanism in the locking slot 232.

In certain instances, the seat 104 can include one or more harness tension sensors 247 (FIG. 43), which can determine if the harness 220 has been tensioned. A harness tensioner sensor can be positioned against the second portion 230b of the tensioning strap, and/or at a location along the straps 222, 224, and/or 226. Such a sensor 247 can comprise a spring-loaded paddle and a switch. In other instances, the harness tension sensor 247 can comprise a load cell. When the harness 220 has been tensioned, the second portion of the strap 230b can compress the spring-loaded paddle 247, which can trigger the switch. The harness tension sensor 247 and/or other harness tension sensors can be in communication with the microcontroller 118 (FIG. 13), and the sensor(s) can communicate the tensioned state to the microcontroller 118.

In various instances, the seat 104 can include a child detection sensor, which is configured to detect if a child is present. For example, the base 214c of the frame 214 can include a spring-loaded pad, which is configured to move when a child is positioned in the seat 104. As described in greater detail herein, the output from the child detection sensor can be provided to the microcontroller 118 (FIG. 13) and/or an operator of the child restraint system 100, and may be used to determine a recommended installation parameter of the system 100. For example, it may be recommended to perform certain steps of the installation sequence before a child is positioned in the seat 104 and/or other steps of the installation after a child is positioned in the seat 104.

In various instances, the harness 220 can include at least one sensor. For example, the harness 220 includes shoulder strap exit angle sensors 225, which are configured to detect the exit angle of the shoulder straps 226 from the back support 214a of the frame 214. The sensors 420 can comprise an accelerometer, for example, which can detect the exit angle of the shoulder straps 226. The exit angles of the shoulder straps 226 can be compared with the angle of the back support 214a, which can be measured by a separate accelerometer.

In other instances, a mechanical element can be used to measure the exit angle of the shoulder straps 226 from the back support 214a. For example, a potentiometer can be positioned in register with both the shoulder straps 226 and the back support 214a. Alternatively, the seat 104 can include a sensor that is configured to measure that the shoulder strap 226 is within a specified range of positions. For example, a sensor may be activated when the shoulder strap 226 is at an upward or inclined angle.

In various instances, certain exit angles or ranges thereof can be recommended based on the facing orientation of the seat 104 and/or based on the size and/or age of a child positioned in the seat 104. For example, it may be recommended to achieve an upward sloping exit angle from the frame 214 when the seat 104 is in a rearward-facing position, and it may be recommended to achieve a downward sloping exit angle from the frame 214 when the seat 104 is in a forward-facing position, for example.

The harness 220 may also include a buckle sensor, which can be configured to determine if the harness 220 has been buckled. Such a sensor can include switches, magnetic sensors, and/or optical sensors. For example, the seat 102 can include at least one magnet, which can detect if the buckle 228 has been engaged. In at least one instance, at least one magnet can be positioned on the tongue of the buckle 228, and a sensing element can be placed on the receptacle and/or sleeve of the buckle 228, which is configured to receives the tongue when the buckle 228 is engaged. For example, the tongue can include a plastic portion and magnets can be embedded therein. In certain instances, a metallic portion of the tongue can be magnetized.

In other instances, a magnet and a sensing element can be positioned inside the receptacle or sleeve of the buckle 228, and the tongue can include a metallic portion. When the buckle 228 has been engaged, the metallic portion of the tongue can sit between the magnet and the sensor to nullify the magnetic field as seen by the sensor. In still other instances, the cushioned portion 216 of the seat 104 can include a magnet and/or sensor for detecting if the buckle 228 has been engaged.

Referring to FIG. 43, the seat 104 may include a microcontroller 218. The microcontroller 218 can communicate with the microcontroller 118 (FIG. 13) in the base 102, for example. In certain instances, the seat 104 can include additional and/or different sensors, which are further described herein. The sensors in the seat 104 can communicate with the microcontroller 118 and/or the microcontroller 218. In various instances, the sensors in the seat 104 can be coupled to a power source, such as the battery pack 116 in the base 102 via the electrical connections 107a, 107b, 109a, and 109b, for example. In other instances, the seat 104 can include a battery. In certain instances, the seat 104 may not include sensors. For example, the seat 104 may not include an electrical or powered component.

In certain instances, a seat of a child restraint system can include an adjustable mount for connecting the harness to the seat. For example, at least one strap of the harness can be connected to an adjustable mount that is adjustably supported on the frame of the seat. The adjustable mount can include a lock for holding the adjustable mount in a selected position.

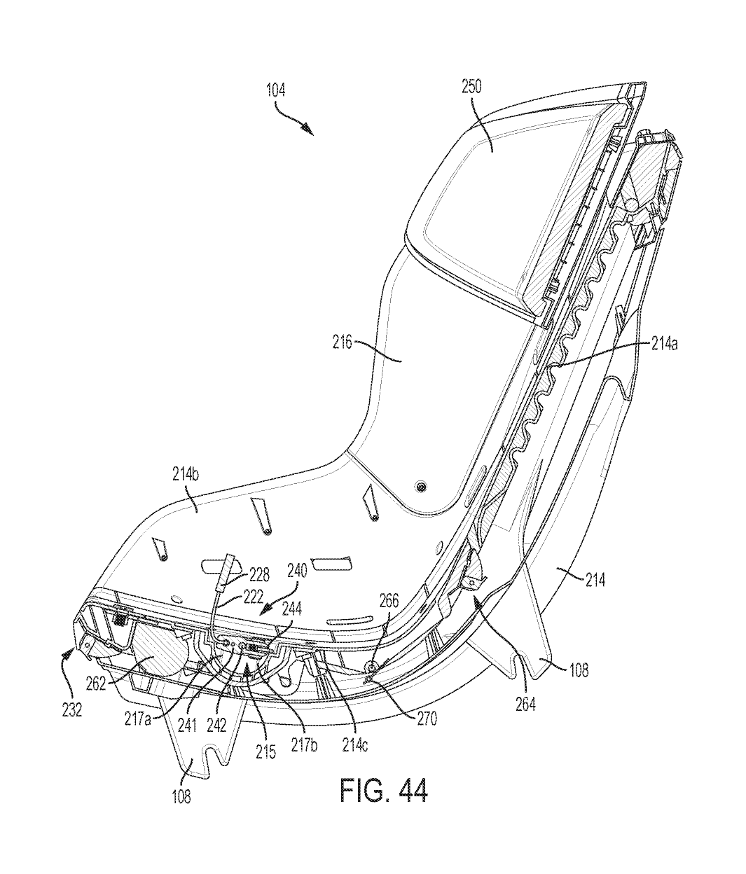

Referring now to FIGS. 44-47, the seat 104 includes an adjustable mount 240 for the central strap 222 of the harness 220 (FIG. 42). The adjustable mount 240 includes a rotatable body 241, which is connected to an end of the central strap 222. The rotatable body 241 is rotatably supported on the frame 214 of the seat 102 by a pivot pin 242. The frame 214 includes a notch 215 dimensioned to receive the rotatable body 241. The pivot pin 242 suspends the rotatable body portion 241 of the mount 240 in the notch 215. The rotatable body 241 is configured to pivot about the pivot pin 242 to move within a range of positions in the notch 215.

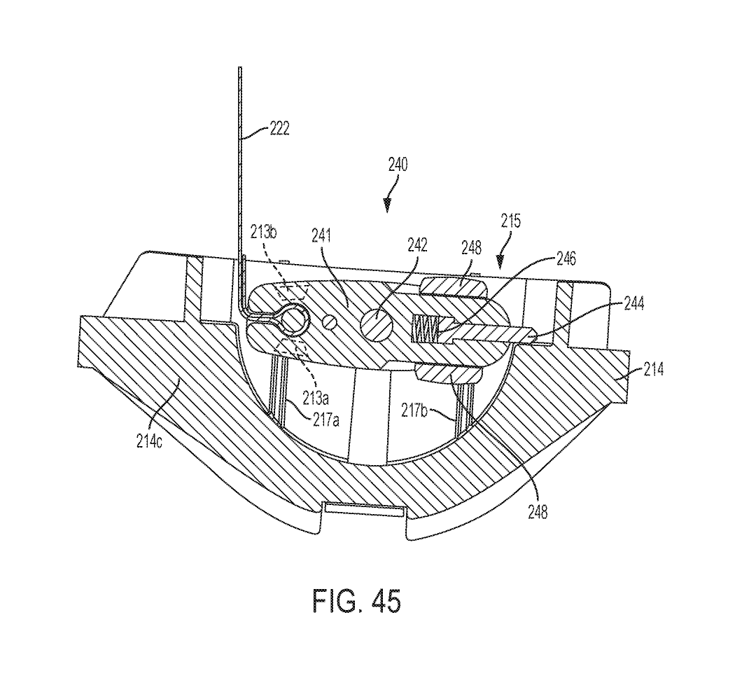

Referring primarily to FIG. 45, the adjustable mount 240 is depicted in a first, locked position. In the first, locked position, the rotatable body 241 is positioned entirely within the notch 215. In various instances, a portion of the rotatable body 241 can be flush with the base 214c of the frame 214. Such an arrangement is configured to provide a comfortable, flat, and/or substantially planar surface upon which a child can sit. Moreover, in the first, locked position of the adjustable mount 240, the central strap 222 of the harness 220 is positioned closer to the front of the seat 104 and farther from the back support 214a of the seat 104. As a result, a greater distance is defined between the back support 214a of the seat 104 and the central strap 222, such that the seat 104 can comfortably and securely receive a larger child.

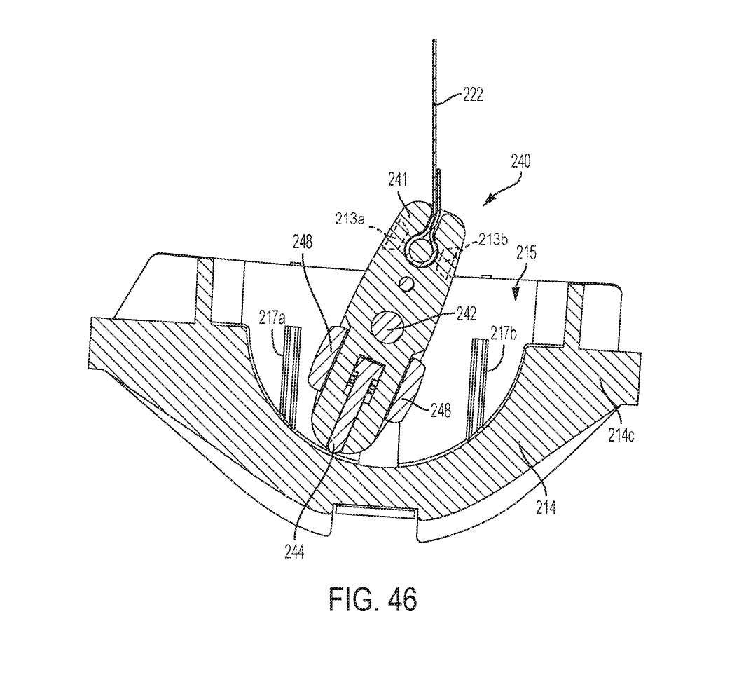

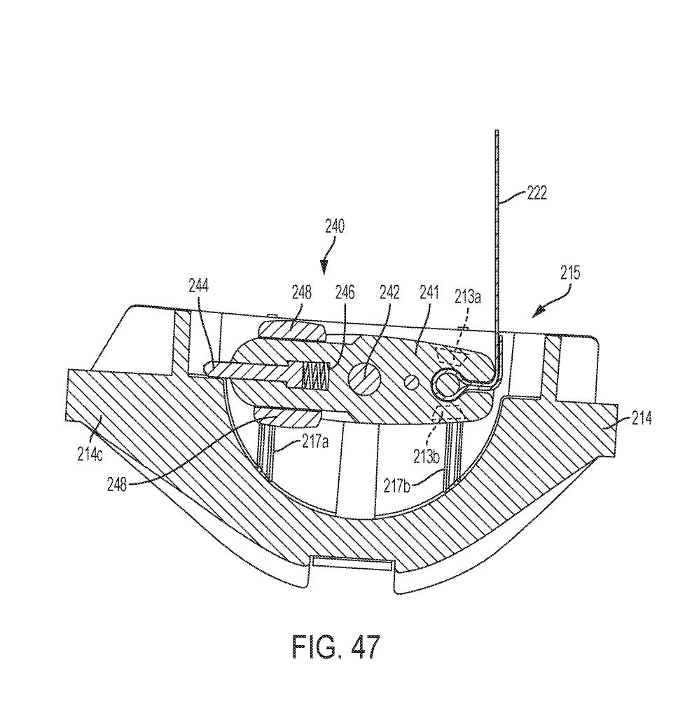

The adjustable mount 240 is depicted in an intermediate, unlocked position in FIG. 46 and in a second, locked position in FIG. 47. To move between the first, locked position (FIG. 45) and the second, locked position (FIG. 47), the rotatable body 241 is rotated through a range of positions including the intermediate, unlocked position (FIG. 46).

In the second, locked position, the rotatable body 241 is positioned entirely within the notch 215. In various instances, a portion of the rotatable body 241 can be flush with the base 214c of the frame 214. Such an arrangement is configured to provide a comfortable, flat, and/or substantially planar surface upon which a child can sit. Moreover, in the second, locked position of the adjustable mount 240, the central strap 222 of the harness 220 is positioned farther from the front of the seat 104 and closer to the back support 214a of the seat 104 than when the adjustable mount 240 is in the first, locked position. As a result, a smaller distance is defined between the back support 214a of the seat 104 and the central strap 222, such that the seat 104 can comfortably and securely receive a smaller child.

The rotatable body 241 includes a lock 244, which is configured to releasably hold the rotatable body 241 in one of two predefined positions relative to the frame 214. In other instances, the lock 244 can be configured to hold the rotatable body 241 in a single position and, in still other instances, the lock 244 can be configured to hold the rotatable body 241 in more than two predefined positions.

The lock 244 includes a spring 246 that biases the lock 244 toward the locked position (FIGS. 45 and 47). When in the locked position, the lock 244 is positioned in abutting contact with the base 214c of the frame 214. As a result, rotation of the rotatable body 241 is restrained. When the lock 244 is moved to the unlocked position (FIG. 46), the lock 244 is retracted such that a clearance is provided between the lock 244 and the frame 214. For example, the lock 244 can clear the frame 214 to rotate the body portion 241 within the notch 215. The spring 246 is deformed (e.g. compressed) to move the lock 244 to the unlocked position.

The adjustable mount 240 includes a release button 248, which operably moves the lock 244 between the locked positions (FIGS. 45 and 47) and the unlocked position (FIG. 46). The release button 248 can be slid along the adjustable mount 240, as depicted in FIG. 46, to compress the spring 246 and move the lock 244 to the locked position. The release button 248 is a two-sided button. A user can access a first side of the button 248 when the adjustable mount 240 is in the first, locked position, and can access a second side of the button 248 when the adjustable mount 240 is in the second, locked position. In certain instances, the adjustable mount 240 can include one or more buttons on each side of the body portion 241 for unlocking the lock 244.

Referring still to FIGS. 44-47, the frame 214 includes a plurality of ribs 217a, 217b, which extend along an inner surface of the notch 215. The ribs 217a, 217b are configured to interact with features on the central strap 222 and/or the body portion 241 to restrain the rotation of the adjustable mount 240. For example, the body portion 241 includes interference features 213a, 213b that are configured to contact a rib 217a, 217b when the adjustable mount 240 is in one of the locked positions. The interference features 213a, 213b can be plastic, molded-in features that extend from the central strap 222. In various instances, the interference features 213a, 213b can be spring-loaded tabs that protrude from the body portion 241 and/or the central strap 222.

Referring primarily to FIG. 45, when the adjustable mount 240 is in the first, locked position, interference between the lock 244 and the frame 214 can prevent further clockwise rotation of the rotatable body 241 and interference between the interference feature 213a and the rib 217a can prevent further counterclockwise rotation of the rotatable body 241. Referring primarily to FIG. 47, when the adjustable mount 240 is in the second, locked position, interference between the lock 244 and the frame 214 can prevent further counterclockwise rotation of the rotatable body 241 and interference between the interference feature 213b and the rib 217b can prevent further clockwise rotation of the rotatable body 241.

In at least one example, the range of motion of the adjustable mount 240 may be 180 degrees. More particularly, the body portion 241 is configured to rotate 180 degrees between the first, locked position and the second, locked position. In other instances, the range of motion of the adjustable mount 240 can be less than 180 degrees or more than 180 degrees. The range of motion of the adjustable mount 240 can depend on the geometry of the frame 214 including the notch 215 thereof and features of the adjustable mount 240 and/or the harness 220, which can interfere with the adjustable mount 240.

In various instances, additional and/or different straps of the harness 220 can be adjustably mounted to the frame 214. For example, in other instances, at least one of the lap straps 224 and/or the shoulder straps 226 (FIG. 42) can be adjustably mounted to the frame 214 of the seat 104 by adjustable mounts, which can be similar to the adjustable mount 240, for example. In still other instances, each strap of the harness 220 can be non-adjustably mounted to the frame 214.

In certain instances, a child restraint system can include additional and/or different attachment belts. For example, a child restraint system can include tether belt for securing a top portion of the child restraint system. More particularly, a seat of a child restraint system can include a top tether belt, which can be attached to an anchor or buckle in a vehicle. The top tether belt can be configured to engage an anchor on the ceiling, floor, or rear shelf of a vehicle. Such a tether belt can extend over and/or around the vehicle seat to which the child restraint system is installed.

A tether belt can include a hook or latch for attachment to an anchor in the vehicle. The tether belt can extend from the hook or latch to a spool or reel positioned within the seat of the child restraint system. When the hook or latch is attached to the anchor in the vehicle, the tether belt can be tensioned to pull the child restraint system closer and/or tighter into the vehicle seat. A tether belt system can include a ratchet reel and/or a clamp for restraining the tensioned tether belt. Moreover, the tether belt system can include a release for releasing the ratchet reel and/or the clamp.

In various instances, belt surplus can extend and/or protrude outside the child restraint system. For example, a tether belt can originate in a seat of a child restraint system and terminate outside of the seat. In various instances, to tension the belt, an operator can pull on the tether belt to retract a surplus length of the belt outside the seat. In various instances, the seat can include a receptacle or cubby for storing the surplus length of the tether belt.

In certain instances, it can be desirable to retain the surplus length of the tether belt inside the seat of a child restraint system. For example, a tether belt can be wound around a reel within the seat of a child restraint system, and the belt surplus can be retracted around the reel and/or otherwise retained within the seat.

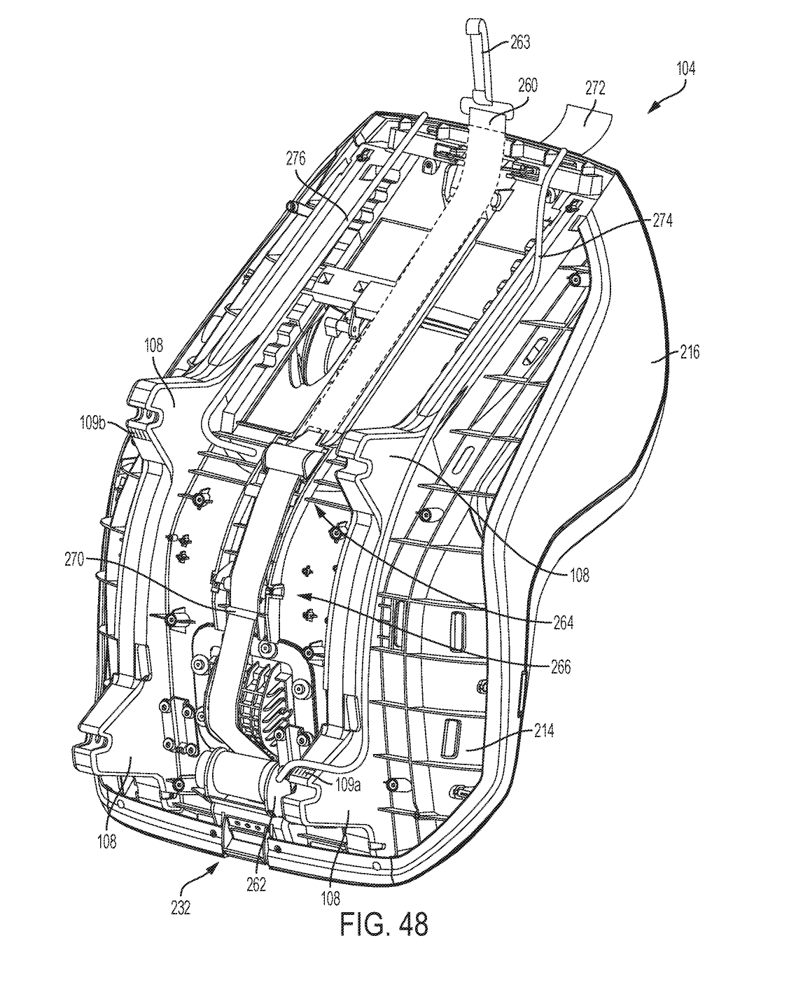

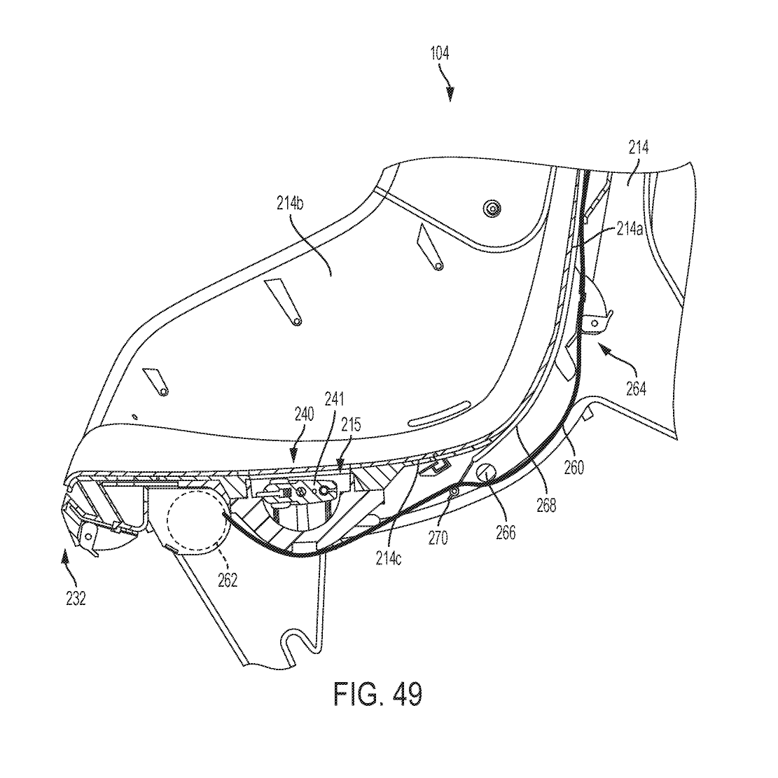

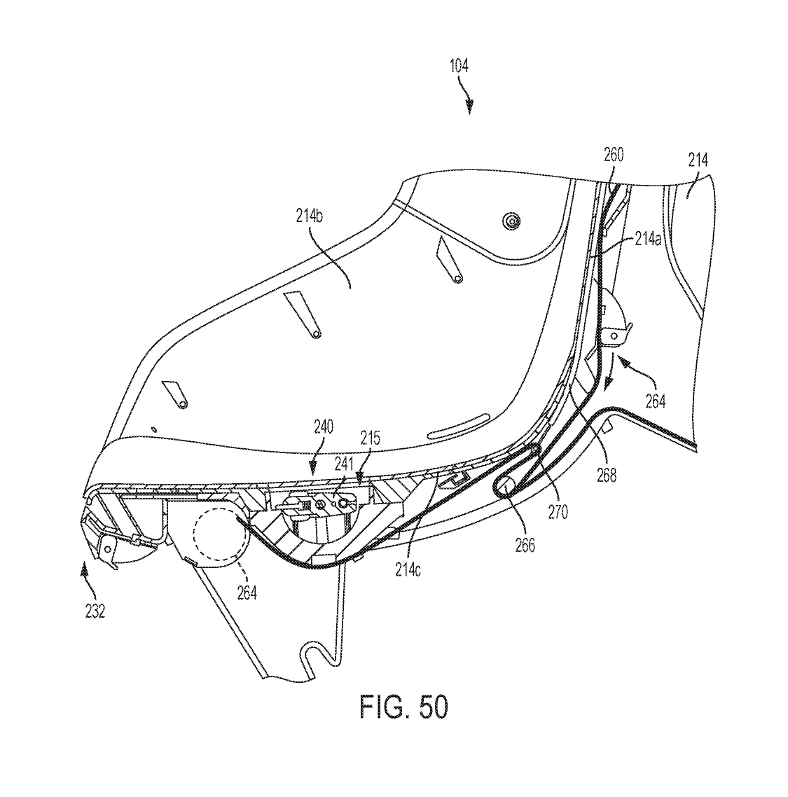

Referring now to FIGS. 48-50, a tether belt 260 extends from the seat 104 of the child restraint system 100. The tether belt 260 includes a hook 263 at an end of the belt 260, which can be pulled over and/or around the vehicle seat to which the child restraint system 100 is installed. The hook 263 can be attached to an anchor in the vehicle. The tether belt 260 extends from the hook 263 to a spring-loaded ratchet spool 262 positioned in the seat 104. The ratchet spool 262 is mounted to the frame 214 of the seat 104 and is configured to wind the tether belt 260 in a tensioning direction (e.g. counterclockwise in FIGS. 49 and 50). To release a wound portion of the tether belt 260, an operator can engage an actuator on the seat 104, such as the button 280 (see, e.g., FIG. 42), to disengage the ratchet mechanism in the ratchet spool 262 and permit retraction of the tether belt 260 from the spool 262. For example, a linkage system and/or a pulley system can couple the button 280 to the ratchet spool 262.

A portion of the tether belt 260 is on a first side of the frame 214 and a portion of the tether belt 260 is on a second side of the frame 214. For example, the tether belt 260 can extend through a slot in the frame 214. At and/or near the top of the back support 214a, the tether belt 260 is configured to extend around a rod or post across the back support 214a. The post can extend perpendicular or substantially perpendicular to the tether belt 260, which can extend upward from the base 214c along the back support 214a.

Between the hook 263 and the ratchet spool 262, the tether belt 260 extends between a guide member 266 and a retractable rod 270. The retractable rod 270 is connected to a secondary belt 268, which extends to a handle or pull strap 272 (FIG. 48). Actuation of the pull strap 272 is configured to retract the rod 270, which is configured to pull the tether belt 260 engaged with the rod 270. For example, referring to FIG. 49, prior to actuation of the pull strap 272, the tether belt 260 is in a pre-tensioned configuration in the seat 104. Upon actuation of the pull strap 272, referring now to FIG. 50, the tether belt 260 is in a tensioned configuration in the seat 104. The surplus length of the tether belt 260 has been drawn into the seat 104 to tighten the tether belt 260 relative to the vehicle and the anchor. In various instances, when the pull strap 272 has been released, the ratchet spool 262 can retract the surplus length of the belt 260. For example, the surplus length of the belt 260 can be wound around the ratchet spool 262.

The tether belt 260 also extends through a clamping member 264 in the base 104. The clamping member 264 is configured to releasably clamp down on the tether belt 260 to prevent movement of the tether belt 260 relative to the clamping member 264. In various instances, when in the clamped position, the clamping member 264 can permit one-way travel of the tether belt 260. For example, the clamping member 264 can permit tensioning of the tether belt 260. In various instances, the clamping member 264 can include a cam-lock mechanism. Additionally or alternatively, the clamping member 264 can include a ratchet mechanism, for example. To unclamp the clamping member 264, an operator can engage an actuator on the seat 104, such as the button 280 (see, e.g., FIG. 42). For example, a linkage system and/or pulley system can couple the button to the clamping member 264, as well as to the ratchet spool 262. In various instances, a tension sensor can be engaged with the tether belt 260 and/or a component of the tensioning system for the tether belt 260. For example, the ratchet spool 262 and/or the clamping member 272 can include a tension sensor. Such a tension sensor can be configured to determine if the tether belt 260 has been tensioned. In other instances, the tension sensor can determine the tension in the belt 260.

In certain instances, the child restraint system 100 can include an adjustable headrest. For example, the seat 104 can include an adjustable headrest 250. In various instances, the adjustable headrest 250 can be coupled to the harness 220 such that adjustments to the headrest 250 move the shoulder straps 226 of the harness 250.

In various instances, a child restraint system can include a power source, a microcontroller, and at least one powered subsystem. For example, the child restraint system 100 can include a battery pack 116 (FIGS. 14 and 15), a microcontroller 118 (FIG. 13), a motor-driven tensioner 130, and a motor-driven leveler 160. The tensioner 130 and the leveler 160 can include a plurality of sensors, as further described herein. The child restraint system 100 can also include a user interface 120, which includes at least one screen, light, speaker, and/or button. The microcontroller 118 is powered by the battery 116 and is configured to communicate with the powered subsystems 130, 160, as well as the user interface 120. The child restraint system 100 can also include a communications module for communicating information beyond the microcontroller 118. For example, a communications module can communicate with a microcontroller in the seat 104 of the child restraint system 100 and/or with another control system, such as the control system in a vehicle and/or mobile device.

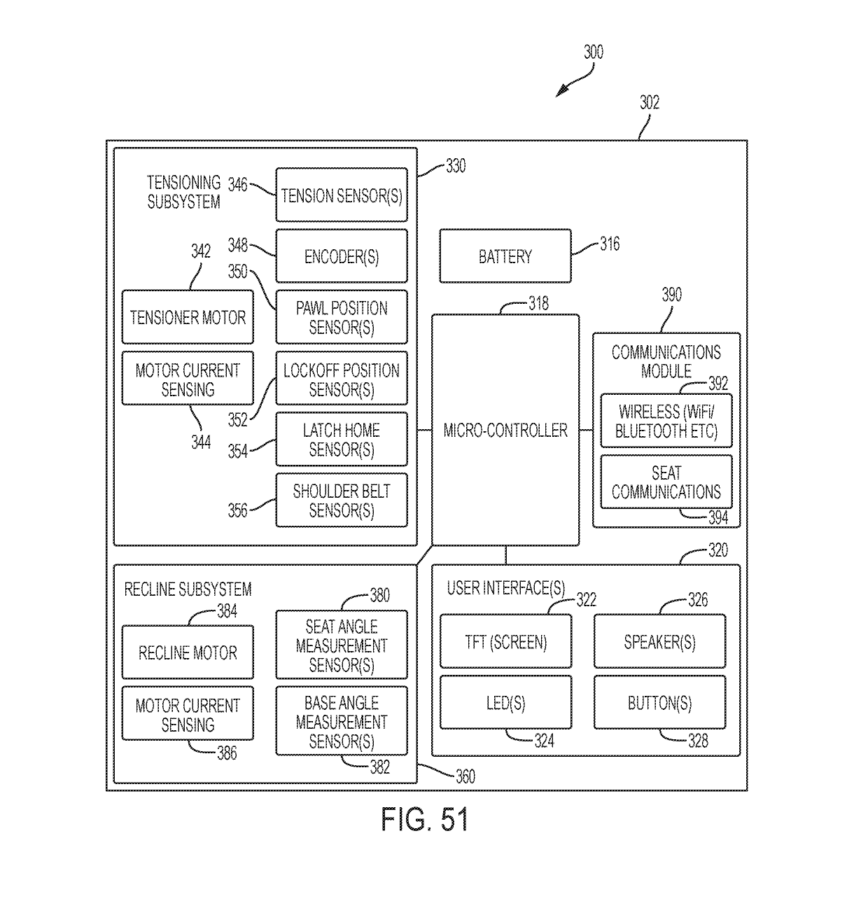

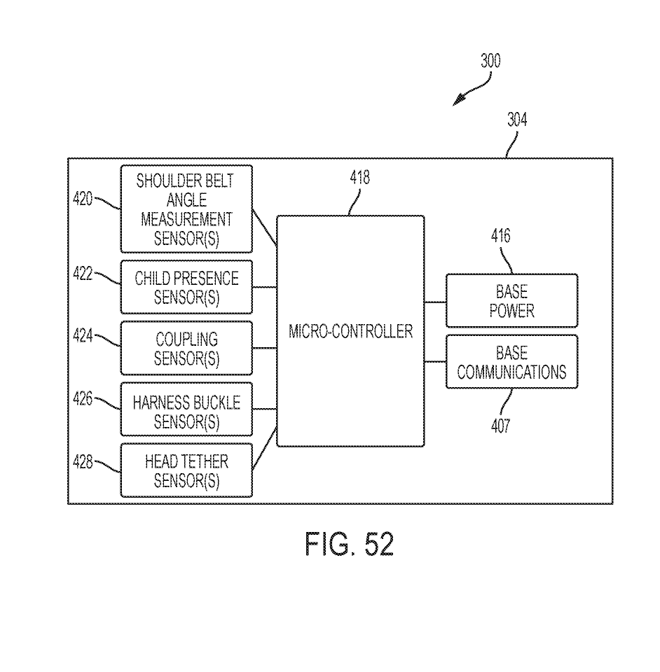

A control schematic for a child restraint system 300 is depicted in FIGS. 51 and 52. The reader will appreciate that various features of the control schematic depicted in FIGS. 51 and 52 can be incorporated into the child restraint system 100. For example, the child restraint system 300 can include a base 302 (FIG. 51) and a seat 304 (FIG. 52). The child restraint system 300 can be similar in many respects to the child restraint system 100. More particularly, the base 302 can be similar in many respects to the base 102, and the seat 304 can be similar in many respects to the seat 104. In other instances, a different child restraint system can utilize at least portions of the control schematic depicted in FIGS. 51 and 52.

Referring primarily to FIG. 51, the base 302 includes a battery pack 316, a microcontroller 318, a motor-driven tensioning system 330, and a motor-driven leveling system 360. The tensioning system 330 and the leveling system 360 include a plurality of sensors, as further described herein. The microcontroller 318 is configured to control the operations of the subsystems based on input to the microcontroller 318 from a user interface 320, a communications module 390, and/or based on conditions detected by the sensors in the subsystems.

The base 302 includes at least one user interface 320, which includes at least one screen 322, at least one light 324, such as an LED, for example, at least one speaker 326, and/or at least one button 328. The microcontroller 318 is powered by the battery 318 and is configured to communicate with the powered subsystems 330, 360, as well as the user interface 320. The base 302 also includes a communications module 390 for communicating information beyond the base 302, such as to a microcontroller 418 (FIG. 52) in the seat 304 of the child restraint system 300, and/or to another control system, such as the control system in a vehicle and/or a mobile device. For example, the communications module 390 can include a wireless and/or Bluetooth terminal 392 and/or can include electrical connections 394, such as contact pads, between the base 302 and the seat 304 of the child restraint system 300.

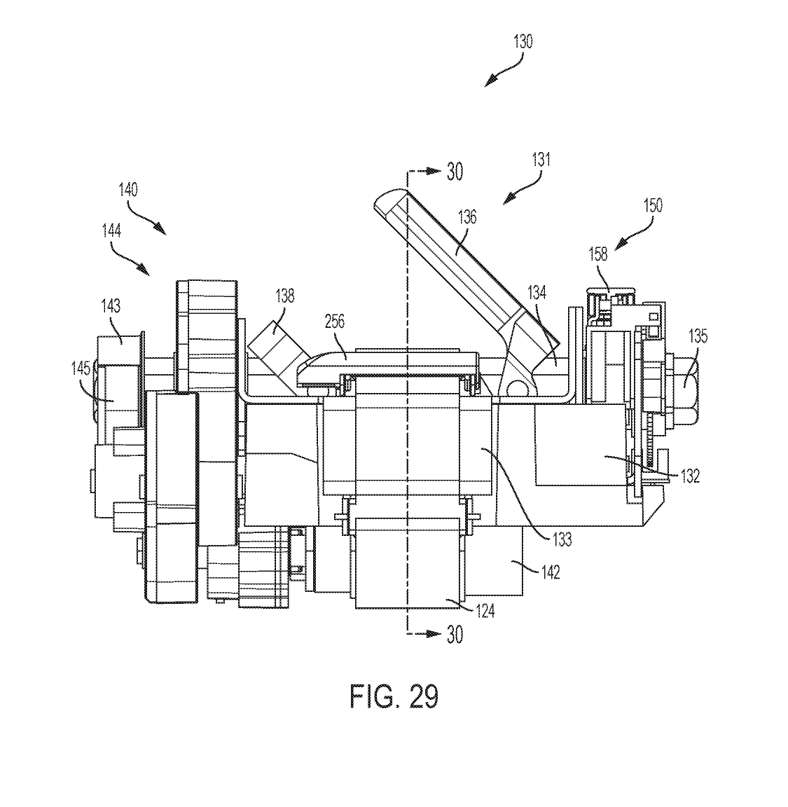

The tensioning system 330 can be similar in many respects to the tensioning system 130 (see, e.g., FIGS. 14 and 15). The tensioning system 330 includes a motor 342, which can be similar in many respects to the motor 142 (see, e.g., FIGS. 29 and 30). The motor 342 can be configured to operably impart a tensioning force on an engaged belt system. For example, the motor 342 can be configured to rotate a spool to which a belt system is clamped in order to tension the belt system. The tensioning system 330 also includes a motor current sensor 344, which is configured to measure the current drawn by the motor 342. Based on the current draw, the microcontroller 318 can determine if the engaged belt system has been tensioned.

The tensioning system 330 can also include at least one tension sensor 346. The tension sensors 346 can be positioned to contact the engaged belt systems. For example, at least one tension sensor 346 can be positioned to contact an integral belt system of the base 302. For example, an integral belt of the base 302 can extend across at least one of the tension sensors 346. Additionally, when a vehicle belt is engaged with the base 302, at least one tension sensor 246 can contact the vehicle belt. For example, the vehicle belt can be positioned across at least one of the tension sensors. The tension sensors 246 can detect if the engaged belt has been tensioned. In various instances, the tension sensor 246 can include a load cell, which is configured to detect the amount of tension in the engaged belt.

The tensioning system 330 also includes a shoulder belt sensor 356. The shoulder belt sensor 356 can be positioned to contact a vehicle belt when the vehicle belt is engaged with the base 302. For example, when a vehicle belt is engaged with the base 302, the vehicle belt 206 can be positioned across the shoulder belt sensor 356. In such instances, the sensor 356 can detect if a vehicle belt is being utilized to install the base 302 in a vehicle.

The tensioning system 330 can also include at least one encoder 348. The encoder 348 is configured to determine the rotational position of the lock off. The tensioning system 330 also includes at least one pawl position sensor 350, which is configured to determine whether a locking pawl of a ratchet system is engaged with a ratchet wheel. The tensioning system 330 further comprises at least one lockout position sensor 352. The lockout position sensor 352 is configured to determine if the belt lockout of the tensioning system 330 is in the clamped or locked position. The tensioning system 330 also includes a latch home sensor 354, which is configured to determine if the tensioning system 330 is in the home position or a tensioned position.

The leveling system 360 can be similar in many respects to the leveling system 130 (see, e.g., FIGS. 14 and 15). In various instances, the leveling system 360 includes a motor 384, which can be similar in many respects to the motor 184 (see, e.g., FIGS. 17 and 18). The motor 384 is configured to generate a driving motion in order to level a portion of the child restraint system 300. For example, the motor 384 can be configured to rotate a central drive screw in order to move a nut along the screw. The nut can be configured to move mounts for the seat 304 of the child restraint system 300.

The leveling system 360 includes a motor current sensor 386, which is configured to measure the current drawn by the motor 384. The tensioning system 360 also includes at least one seat angle measurement sensor 380 and at least one base angle measurement sensor 382. The seat angle measurement sensor 380 can comprise a position sensor on the nut, for example, and the base angle position measurement sensor 380 can comprise an accelerometer in the base 302 of the system 300, for example. The microcontroller 318 is configured to determine the angle of the seat 304 based on the measurements from the sensors 380, 382.

In various instances, the microcontroller 318 can be in communication with a personal electronic device, such as a software program installed on a “smart” mobile phone or tablet. In certain instances, the microcontroller 318 can receive input detected by the personal electronic device to determine the angle of the seat 304. A system for determining the angle of at least a portion of a child restraint system based on input from a personal electronic device is described in U.S. Provisional Patent Application No. 62/273,608, filed Dec. 31, 2015, entitled CHILD RESTRAINT SYSTEM ADJUSTMENT MOBILE APP, which is hereby incorporated by reference herein in its respective entirety.

Referring primarily to FIG. 52, the seat 304 includes a power source 416, a microcontroller 418, a communications module 407 and a plurality of sensors 420, 422, 424, 426, and 428. The power source 416 for the seat 304 can be the battery pack 316 in the base 302. For example, electrical connections between the base 302 and the seat 304 can provide a current pathway from the battery pack 316 to the powered components in the seat 304. The electrical connections can be contact pads, such as the electrical connections 109a and 109b (FIG. 13) in the seat 104, for example.

The microcontroller 418 is configured to send and/or receive commands based on input to the microcontroller 418 from the communications module 407 and/or based on conditions detected by the sensors 420, 422, 424, 426, and 428. In certain instances, the communications module 407 is configured to communicate with the base 302. For example, the base 302 and the seat 304 can communicate across the electrical connections. In certain instances, the communications can be wirelessly. The communications module 407 can be configured to communicate information to the microcontroller 318 (FIG. 51) in the base 302 of the child restraint system 300. Additionally or alternatively, the communications module 407 can communicate with another control system, such as the control system in a vehicle and/or a mobile device. In certain instances, the communications module 407 can include a wireless and/or Bluetooth terminal, for example.

In various instances, the communications module 390 and/or the communications module 407 can be configured to receive software updates and/or upgrades from a remote server. Such updates and/or upgrades can be communicated to the microcontroller. In such instances, it can be necessary to upgrade the software when new safety guidelines are released, for example. Software updates and/or upgrades can occur automatically. For example, the updates and/or upgrades can be communicated across a wireless, Bluetooth and/or cellular connection. In other instances, the upgrades and/or updates can be transferred to the microcontroller via a wired and/or physical connection, such as a port and/or dock for a “smart” mobile phone and/or tablet.

The seat 304 includes a plurality of sensors. For example, the seat 304 includes a shoulder belt angle measurement sensor 420, which is configured to detect the exit angle of the shoulder straps of a harness of the seat. The sensor 420 can be similar in many respects to the sensors 225 (FIG. 42), for example. The seat 304 also includes a child detection sensor 422, which is configured to detect whether a child is positioned in the seat 304 of the child restraint system 300. The child detection sensor 422 can include a spring-loaded pad upon which a child can sit, for example. The seat 304 also includes coupling sensors 424, which are configured to detect if the seat 304 is properly coupled to the base 302. The seat 304 also includes a head tether sensor 428, which is configured to detect if a top tether strap of the seat 304 has been engaged with an anchor in the vehicle. The seat 304 also includes a harness buckle sensor 426, which is configured to determine if the harness has been buckled.

In certain instances, the child restraint system 300 can include one or more of the sensors 420, 422, 424, 426, and 428. Additionally or alternatively, the child restraint system 300 can additional sensors, such as include a harness tension sensor, which can determine if the harness for the seat 304 has been tensioned.

An operational sequence for a child restraint system is described below. In various instances, the child restraint system 100 and/or the child restraint system 300 can utilize the operational sequence described below.

To initiate an installation sequence, a user can press a button on a user interface of the child restraint system. During the installation sequence, the user interface is configured to display icons and/or produce sounds and/or lights to aid the user through the installation sequence.

First, the user can be instructed to ensure that the vehicle is parked on level ground. In other instances, the installation sequence can be initiated when the vehicle is not parked on level ground, as described in U.S. Provisional Patent Application No. 62/273,608, filed Dec. 31, 2015, entitled CHILD RESTRAINT SYSTEM ADJUSTMENT MOBILE APP, which is hereby incorporated by reference herein in its respective entirety.

Thereafter, the user can be instructed to place the base of the child restraint system on the seat of the vehicle. The user interface can then prompt the user to select whether an integral belt or a vehicle belt is being utilized for the base installation. Additionally or alternatively, a sensor can detect if a vehicle belt has been engaged with the base. For example, such a sensor can be used to confirm the user's selection and/or can automatically progress the sequence to a subsequent step.

Thereafter, if the vehicle belt has been selected and/or detected, the user interface can prompt the user to position the vehicle belt in the proper position relative to the base. For example, the user interface can prompt the user to extend the vehicle belt, place the vehicle belt along a belt path and through a lock off mechanism in the base, to engage the vehicle belt with a buckle in the vehicle, and/or to close the lock off mechanism.

If the integral belt has been selected, the user interface can prompt the user to extend the integral belt and attach the latches thereof to the vehicle anchors. Additionally or alternatively, the user interface can prompt the user to close the lock off mechanism.

After the belt system has been properly engaged, the user can be prompted to initiate an auto-tensioning operation. Tension sensors in the base can confirm that an appropriate tension level has been achieved in the engaged belt.

Thereafter, the user interface can indicate that a correct base installation has been achieved. Alternatively, if the auto-tensioning operation is incomplete and/or unsatisfactory, the user interface can indicate to the user that the tensioner of the child restraint system needs to be manually operated and adjusted.

Once the base of the child restraint system has been properly installed, the user interface can prompt the user to mount the seat of the child restraint system to the base. In various instances, coupling sensors can confirm that the seat is properly mounted to the base.

Thereafter, the user can be prompted to initiate an auto-leveling operation. During the auto-leveling operation, sensors in the child restraint system can confirm that the seat of the system is at an appropriate angle relative to the base and/or the ground. For example, the child restraint system can utilize an angle sensor in the base, a position sensor on the nut in the leveler, and/or an orientation sensor, which determines whether the seat has been installed in a forward-facing orientation or a rearward-facing orientation, to automatically determine and position the seat at the correct angle.

If the orientation sensor of the child restraint system indicates that the seat has been installed in a forward-facing orientation, the user can be prompted to attach a top tether belt to an anchor in the vehicle. In various instances, because certain vehicles may not provide an anchor for the top tether belt, the user interface can permit the user to opt-out of the top tether belt attachment. In certain instances, a sensor can confirm that an appropriate tension level has been achieved in the top tether belt.

Thereafter, the user interface can indicate that a correct seat installation has been achieved. If the auto-leveling operation is incomplete and/or unsatisfactory, the user interface can indicate to the user that the leveler of the child restraint system needs to be manually operated and adjusted.

Thereafter, the user interface can prompt the user to place a child into the seat of the child restraint system. In various instances, a child presence sensor can confirm that a child has been positioned in the seat.

Thereafter, the user interface can prompt the user to adjust a head rest of the seat to a proper position based on the detected orientation of the seat.

Thereafter, the user interface can prompt the user to restrain the child with a harness of the seat. The user interface can instruct the user on how to properly secure and buckle the harness around the child. In various instances, sensors can confirm that the buckle of the harness has been engaged and/or that the harness has been tensioned. Additionally or alternatively, a sensor can confirm that the exit angle of the shoulder straps is appropriate for the child positioned in the seat and/or for the detected orientation of the seat.

Thereafter, the user interface can indicate that the child has been properly secured in the seat or can indicate to the user that the child is improperly secured and needs to be reevaluated.

Thereafter, the child restraint system can conduct a final system sensor check and provide an indication to the user via the user interface that the installation is complete.

To accomplish the foregoing installation sequence, the microcontroller of the child restraint system can be in communication with various sensors in the base and the seat. Additionally, information can be provided to the microcontroller by the user.

During use of the child restraint system, the system can be configured to confirm that a proper installation has been achieved and maintained. For example, the system can periodically conduct automatic system checks. Additionally or alternatively, the user can initiate a system check at any time. In various instances, the system can conduct a system check each time a child is positioned in the seat. In certain instances, the system check can be the operational sequence, described herein. In other instances, an abbreviated system check can be conducted. For example, the system can proceed through certain steps each time a child is detected in the seat, and can proceed through all of the steps less frequently.

Continually monitoring of the child restraint system can confirm that the system is properly installed for a growing child and/or for different children using the system. For example, when a child surpasses a predefined size and/or age, the installation requirements can change. In various instances, a user can provide up-to-date information regarding the child to the system. For example, the child restraint system can communicate with a mobile device, which, for example, can prompt the user to provide up-to-date statistics on the child, or any other available information on the child restraint system.

### EXAMPLES

### Example 1

A child restraint system comprises a base portion that comprises a rotatable spool, a motor configured to rotate the rotatable spool, a first belt attached to the rotatable spool, and a portion configured to receive a second belt. A first degree of rotation of the rotatable spool is configured to draw the first belt and the second belt at least partially around the rotatable spool.

### Example 2

The child restraint system of Example 1, further comprising a controller in communication with the motor.

### Example 3

The child restraint system of Example 2, wherein the motor further comprises a current sensor in communication with the controller, wherein the base portion further comprises a tension sensor in communication with the controller, wherein the tension sensor is configured to detect a tension in the first belt, and wherein the controller is configured to control the motor based on the tension detected by the tension sensor.

### Example 4

The child restraint system of Examples 1, 2, or 3, wherein the first belt comprises an integral belt, and wherein the second belt comprises a vehicle belt.

### Example 5

The child restraint system of Example 4, wherein the integral belt further comprises a first length extending from the rotatable spool in a first direction, and a second length extending from the rotatable spool in a second direction.

### Example 6

The child restraint system of Example 5, wherein the first length further comprises a first end comprising a first latch, and wherein the second length further comprises a second end comprising a second latch.

### Example 7

The child restraint system of Example 6, wherein the base portion further comprises a spring support assembly, wherein the first length and the second length of the integral belt extend through the spring support assembly, wherein the spring support assembly is configured to deform when the rotatable spool is rotated through the first degree of rotation such that the first latch and the second latch are not retracted toward the rotatable spool, and wherein the first latch and the second latch are retracted toward the rotatable spool during a second degree of rotation of the rotatable spool.

### Example 8

The child restraint system of Examples 1, 2, 3, 4, 5, 6 or 7, wherein the base portion further comprises a spring-loaded clamp arm biased toward an unclamped position, wherein the spring-loaded clamp arm is moveable between the unclamped position and a clamped position, and wherein the spring-loaded clamp arm is configured to clamp the second belt to the rotatable spool when in the clamped position. The base portion further comprises a lock configured to pivot between an unlocked position and a locked position, wherein the lock is configured to hold the spring-loaded clamp arm in the clamped position when the lock is in the locked position.

### Example 9

The child restraint system of Examples 1, 2, 3, 4, 5, 6, 7, 8, or 9, further comprising a seat portion, wherein the seat portion is releasably coupled to the base portion.

### Example 10

The child restraint system of Examples 1, 2, 3, 4, 5, 6, 7, 8, or 9, wherein the base portion further comprises a ratchet assembly that comprises a ratchet wheel rotatable with the rotatable spool, a pawl releasably engaged with the ratchet wheel, wherein the rotatable spool is permitted to rotate in a first direction through the first degree of rotation, and wherein the pawl is configured to resist rotation of the rotatable spool in a second direction.

### Example 11

The child restraint system of Examples 1, 2, 3, 4, 5, 6, 7, 8, 9, or 10, wherein the base portion further comprises a knob for manually rotating the rotatable spool.

### Example 12

A child restraint system comprises a base portion that comprises a fixed track and a rail slidably retained in the track, wherein the rail comprises a mount for interfacing with a seat portion. The base portion further comprises a nut connected to the rail, a drive screw threadably engaged with the nut, and a motor configured to rotate the drive screw, wherein a rotation of the drive screw is configured to move the nut and the rail such that the mount moves relative to the fixed track.

### Example 13

The child restraint system of Example 12, further comprising a controller in communication with the motor.

### Example 14

The child restraint system of Example 13, further comprising the seat portion, wherein the seat portion is releasably coupled to the base portion at the mount.

### Example 15

The child restraint system of Example 14, wherein the fixed track comprises a first curved slot and a second curved slot. The rail comprises a first pin extending into the first curved slot and a second pin extending into the second curved slot. The seat portion is configured to pivot relative to the base portion as the rail slides in the track.

### Example 16

The child restraint system of Examples 14 or 15, wherein the base portion further comprises an accelerometer in communication with the controller, wherein the nut further comprises a position sensor in communication with the controller, and wherein the controller is configured to determine an angle of the seat portion coupled to the mount based on the output from the accelerometer and the position sensor.

### Example 17

The child restraint system of Examples 12, 13, 14, 15, or 16, wherein the rail comprises a first rail and the mount comprises a first mount. The base portion further comprises a second fixed track and a second rail slidably retained in the second fixed track, wherein the second rail comprises a second mount for interfacing with the seat portion, and wherein the nut is connected to the second rail.

### Example 18

The child restraint system of Examples 12, 13, 14, 15, 16, or 17, wherein the base portion further comprises a drive system intermediate the motor and the drive screw, a spring configured to bias the motor into engagement with the drive system, and a lever configured to move the motor, wherein the motor is movable between an engaged position and a disengaged position relative to the drive system.

### Example 19

The child restraint system of Examples 12, 13, 14, 15, 16, 17, or 18, wherein the base portion further comprises a knob for manually rotating the drive screw.

### Example 20

The child restraint system of Example 19, wherein the knob is positioned in a compartment of the base portion, wherein the base portion further comprises a hinged door operably covering the compartment, and wherein the hinged door is coupled to the lever such that movement of the hinged door moves the motor from the engaged position to the disengaged position.

### Example 21

A child restraint system comprises a seat portion that comprises a body and an adjustable mount at least partially embedded in the body, wherein the adjustable mount is rotatable through a range of positions. The seat portion further comprises a lock for securing the adjustable mount in one of at least two positions, and a child-restraining harness comprising a central strap, wherein the central strap extends from the adjustable mount.

### Example 22

The child restraint system of Example 21, wherein a recess is defined in the body, and wherein the adjustable mount comprises a body portion configured to pivot in the recess.

### Example 23

The child restraint system of Example 22, wherein the body portion further comprises a first end and a second end, wherein the first end comprises the lock, and wherein the central strap extends from the second end.

### Example 24

The child restraint system of Examples 21, 22, or 23, wherein the lock further comprises a spring-loaded button.

### Example 25

The child restraint system of Examples 21, 22, 23, or 24 wherein the at least two positions comprises a first position and a second position, and wherein the first position is 180 degrees offset from the second position.

### Example 26

The child restraint system of Examples 21, 22, 23, 24, or 25, wherein the harness comprises a five-point harness.

### Example 27

The child restraint system of Example 26, wherein the five-point harness comprises a first shoulder strap comprising a first accelerometer configured to detect an exit angle of the first shoulder strap from the body. The five-point harness further comprises a second shoulder strap comprising a second accelerometer configured to detect an exit angle of the second shoulder strap from the body.

### Example 28

The child restraint system of Examples 21, 22, 23, 24, 25, 26, or 27, wherein the harness further comprises a buckle, and wherein the buckle comprises a buckle sensor.

### Example 29

The child restraint system of Examples 21, 22, 23, 24, 25, 26, or 27, further comprising a tension sensor engaged with the harness, wherein the tension sensor is configured to detect whether the harness has been tensioned.

### Example 30

The child restraint system of Example 29, wherein the tension sensor comprises a switch.

### Example 31

The child restraint system of Examples 21, 22, 23, 24, 25, 26, 27, 28, 29, or 30, wherein the body further comprises a spring-loaded pad engaged with a sensor for detecting the presence of a child in the seat portion.

### Example 32

A child restraint system comprises a base portion that comprises a first mount, a base electrical connector, and a first circuit device coupled to the base electrical connector. The child restraint system further comprises a seat portion that comprises a second circuit device, a second mount configured to releasably engage the first mount to connect the seat portion to the base portion, and a seat electrical connector configured to mate with the base electrical connector when the second mount is engaged with the first mount to form an electrical path from the first circuit device to the second circuit device.

### Example 33

The child restraint system of Example 32, wherein the first circuit device comprises a sensor.

### Example 34

The child restraint system of Examples 32 or 33, wherein the second circuit device comprises a power supply.

### Example 35

The child restraint system of Examples 32, 33, or 34, wherein the second circuit device comprises a controller.

### Example 36

The child restraint system of Examples 32, 33, 34, or 35, wherein the seat electrical connector comprises a first connector and a second connector. The first connector is configured to mate with the base electrical connector when the seat portion is in a first orientation relative to the base portion. The second connector is configured to mate with the base electrical connector when the seat portion is in a second orientation relative to the base portion.

### Example 37

A child restraint system comprises a seat portion that comprises a frame comprising a back support and a belt extending along the back support, wherein the belt comprising a first end and a second end, wherein the second end comprises a latch, and wherein the latch protrudes from the frame. The seat portion further comprises a spool, wherein the first end of the belt is connected to the spool, wherein a rotation of the spool in a first direction is configured to wind the belt around the spool to retract the latch toward the frame, and wherein a rotation of the spool in a second direction is configured to unwind the belt from the spool to extend the latch from the frame. The seat portion further comprises a lock configured to restrict rotation of the spool in the second direction.

### Example 38

The child restraint system of Example 37, wherein the lock comprises a ratchet engaged with the spool.

### Example 39

The child restraint system of Examples 37 or 38, wherein the seat portion further comprises a clamp, and wherein the belt extends through the clamp.

### Example 40

The child restraint system of Example 39, wherein the seat portion further comprises an actuator configured to release the lock and unclamp the clamp.

### Example 41

The child restraint system of Examples 37, 38, or 39, wherein the seat portion further comprises an actuator, a moveable rod positioned in the seat portion and engaged with the belt, a secondary belt extending between the actuator and the retractable rod, wherein an actuation of the actuator is configured to move the moveable rod within the seat portion to draw the latch toward the spool.

### Example 42

A child restraint system comprises a base portion that comprises a rotatable spool, a first belt attached to the rotatable spool, and a portion configured to receive a second belt. A first degree of rotation of the rotatable spool is configured to draw the first belt and the second belt at least partially around the rotatable spool.

### Example 43

The child restraint system of Example 42, wherein the first belt comprises an integral belt, and wherein the second belt comprises a vehicle belt.

### Example 44

The child restraint system of Example 43, wherein the integral belt further comprises a first length extending from the rotatable spool in a first direction, and a second length extending from the rotatable spool in a second direction.

### Example 45

The child restraint system of Example 44, wherein the first length further comprises a first end comprising a first latch, and wherein the second length further comprises a second end comprising a second latch.

### Example 46

The child restraint system of Example 45, wherein the base portion further comprises a spring support assembly, wherein the first length and the second length of the integral belt extend through the spring support assembly, wherein the spring support assembly is configured to deform when the rotatable spool is rotated through the first degree of rotation such that the first latch and the second latch are not retracted toward the rotatable spool, and wherein the first latch and the second latch are retracted toward the rotatable spool during a second degree of rotation of the rotatable spool.

### Example 47

The child restraint system of Examples 42, 43, 44, 45, or 46, wherein the base portion further comprises a spring-loaded clamp arm biased toward an unclamped position, wherein the spring-loaded clamp arm is moveable between the unclamped position and a clamped position, and wherein the spring-loaded clamp arm is configured to clamp the second belt to the rotatable spool when in the clamped position. The base portion further comprises a lock configured to pivot between an unlocked position and a locked position, wherein the lock is configured to hold the spring-loaded clamp arm in the clamped position when the lock is in the locked position.

### Example 48

The child restraint system of Examples 42, 43, 44, 45, 46, or 47, further comprising a seat portion, wherein the seat portion is releasably coupled to the base portion.

### Example 49

The child restraint system of Examples 42, 43, 44, 45, 46, 47, or 48, wherein the base portion further comprises a ratchet assembly that comprises a ratchet wheel rotatable with the rotatable spool, a pawl releasably engaged with the ratchet wheel, wherein the rotatable spool is permitted to rotate in a first direction through the first degree of rotation, and wherein the pawl is configured to resist rotation of the rotatable spool in a second direction.

### Example 50

The child restraint system of Examples 42, 43, 44, 45, 46, 47, 48, or 49, wherein the base portion further comprises a knob for manually rotating the rotatable spool.

### Example 51

A child restraint system comprises a base portion that comprises a fixed track and a rail slidably retained in the track, wherein the rail comprises a mount for interfacing with a seat portion. The base portion further comprises a nut connected to the rail and a drive screw threadably engaged with the nut, wherein a rotation of the drive screw is configured to move the nut and the rail such that the mount moves relative to the fixed track.

### Example 52

The child restraint system of Example 51, further comprising the seat portion, wherein the seat portion is releasably coupled to the base portion at the mount.

### Example 53

The child restraint system of Examples 51 or 52, wherein the fixed track comprises a first curved slot and a second curved slot. The rail comprises a first pin extending into the first curved slot and a second pin extending into the second curved slot. The seat portion is configured to pivot relative to the base portion as the rail slides in the track.

### Example 54

The child restraint system of Examples 51, 52, or 53, wherein the rail comprises a first rail and the mount comprises a first mount. The base portion further comprises a second fixed track and a second rail slidably retained in the second fixed track, wherein the second rail comprises a second mount for interfacing with the seat portion, and wherein the nut is connected to the second rail.

### Example 55

The child restraint system of Examples 51, 52, 53, or 54, wherein the base portion further comprises a knob for manually rotating the drive screw.

The various features disclosed herein can be incorporated into a variety of different child restraint systems. For example, various features herein are suitable for rearward-facing infant carriers, forward-facing infant carriers, forward-facing convertible child seats, rearward-facing convertible child seats, combination seats, and booster seats. Various child restraint systems are disclosed in the following commonly-owned U.S. patent applications, which are incorporated by reference herein in their respective entireties: U.S. patent application Ser. No. 14/884,933, filed Oct. 16, 2015 entitled CHILD RESTRAINT SYSTEM WITH USER INTERFACE; U.S. patent application Ser. No. 14/718,735, filed May 21, 2015, entitled CHILD RESTRAINT SYSTEM WITH AUTOMATED INSTALLATION; and U.S. patent application Ser. No. 14/514,280, filed Oct. 14, 2014, entitled CHILD RESTRAINT SYSTEM WITH USER INTERFACE, now U.S. Patent Application Publication. No. 2015/0091348.

Some aspects of the present disclosure may be described using the expression “coupled” along with its derivatives. In an example, some aspects may be described using the term “coupled” to indicate that two or more elements are in direct physical or electrical contact. The term “coupled,” however, also may mean that two or more elements are not in direct contact with each other, but yet still co-operate or interact with each other.

Some or all of the aspects described herein may generally comprise technologies for mechanisms for controlling a child restraint system or other technologies described herein. In a general sense, the reader will recognize that the various aspects described herein, which can be implemented, individually and/or collectively, by a wide range of hardware, software, firmware, or any combination thereof, can be viewed as being composed of various types of electrical circuitry and/or various combinations of electrical circuit components. As used herein, an electrical or electronic circuit may refer to a composition of individual electronic components, such as resistors, transistors, capacitors, inductors and diodes, connected by conductive wires or traces through which electric current can flow. Further, as used herein, circuits or circuit devices may refer to, but are not limited to, electrical circuitry having one or more discrete electrical components, integrated circuits, and/or application specific integrated circuits (ASICs), etc. or configuration thereof to perform the indicated function. Additionally, a circuit or circuit device may include electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), a memory device (e.g., forms of random access memory), and/or a communications device (e.g., a modem, communications switch, or optical-electrical equipment), etc. or configuration thereof to perform the indicated function. The reader will recognize that the subject matter described herein may be implemented in an analog or digital fashion or some combination thereof.

The foregoing detailed description has set forth various aspects of the devices and/or processes via the use of examples. Insofar as such examples contain one or more function and/or operation, the reader will understand that each function and/or operation within such examples can be implemented, individually and/or collectively, by a wide range of hardware, software, firmware, or virtually any combination thereof. In one aspect, several portions of the subject matter described herein may be implemented via Application Specific Integrated Circuits (ASICs), Field Programmable Gate Arrays (FPGAs), digital signal processors (DSPs), or other integrated formats. The reader will recognize, however, that some of the aspects disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skilled in the art in light of this disclosure. In addition, the reader will appreciate that the mechanisms of the subject matter described herein are capable of being distributed as a program product in a variety of forms, and that an illustrative aspect of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

Although the various embodiments of the devices have been described herein in connection with certain disclosed embodiments, many modifications and variations to those embodiments may be implemented. Also, where materials are disclosed for certain components, in certain instances, other materials may be used. Furthermore, according to various embodiments, a single component may be replaced by multiple components, and multiple components may be replaced by a single component, to perform a given function or functions. In addition, features disclosed in connection with one embodiment may be employed with other embodiments disclosed herein. The foregoing description and following claims are intended to cover all such modification and variations.

While this invention has been described as having exemplary designs, the present invention may be further modified within the spirit and scope of the disclosure. This application is therefore intended to cover any variations, uses, or adaptations of the invention using its general principles.

Any patent, publication, or other disclosure material, in whole or in part, that is said to be incorporated by reference herein is incorporated herein only to the extent that the incorporated materials do not conflict with existing definitions, statements, or other disclosure material set forth in the disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A child restraint system, comprising:
a base portion, comprising:
a rotatable spool;
a motor configured to rotate the rotatable spool;
a first belt attached to the rotatable spool; and
a portion configured to receive a second belt;
wherein a first degree of rotation of the rotatable spool is configured to draw the first belt and the second belt at least partially around the rotatable spool.

2. The child restraint system of claim 1, further comprising a controller in communication with the motor.

3. The child restraint system of claim 2, wherein the motor further comprises a current sensor in communication with the controller, wherein the base portion further comprises a tension sensor in communication with the controller, wherein the tension sensor is configured to detect a tension in the first belt, and wherein the controller is configured to control the motor based on the tension detected by the tension sensor.

4. The child restraint system of claim 1, wherein the first belt comprises an integral belt, and wherein the second belt comprises a vehicle belt.

5. The child restraint system of claim 4, wherein the integral belt further comprises:
a first length extending from the rotatable spool in a first direction; and
a second length extending from the rotatable spool in a second direction.

6. The child restraint system of claim 5, wherein the first length further comprises a first end comprising a first latch, and wherein the second length further comprises a second end comprising a second latch.

7. The child restraint system of claim 6, wherein the base portion further comprises a spring support assembly, wherein the first length and the second length of the integral belt extend through the spring support assembly, wherein the spring support assembly is configured to deform when the rotatable spool is rotated through the first degree of rotation such that the first latch and the second latch are not retracted toward the rotatable spool, and wherein the first latch and the second latch are retracted toward the rotatable spool during a second degree of rotation of the rotatable spool.

8. The child restraint system of claim 1, wherein the base portion further comprises:
a spring-loaded clamp arm biased toward an unclamped position, wherein the spring-loaded clamp arm is moveable between the unclamped position and a clamped position, and wherein the spring-loaded clamp arm is configured to clamp the second belt to the rotatable spool when in the clamped position; and
a lock configured to pivot between an unlocked position and a locked position, wherein the lock is configured to hold the spring-loaded clamp arm in the clamped position when the lock is in the locked position.

9. The child restraint system of claim 1, further comprising a seat portion, wherein the seat portion is releasably coupled to the base portion.

10. The child restraint system of claim 1, wherein the base portion further comprises a ratchet assembly, comprising:
a ratchet wheel rotatable with the rotatable spool; and
a pawl releasably engaged with the ratchet wheel, wherein the rotatable spool is permitted to rotate in a first direction through the first degree of rotation, and wherein the pawl is configured to resist rotation of the rotatable spool in a second direction.

11. The child restraint system of claim 10, wherein the base portion further comprises a knob for manually rotating the rotatable spool.

12. A child restraint system, comprising:
a base portion, comprising:
a fixed track;
a rail slidably retained in the track, wherein the rail comprises a mount for interfacing with a seat portion;
a nut connected to the rail;
a drive screw threadably engaged with the nut; and
a motor configured to rotate the drive screw, wherein a rotation of the drive screw is configured to move the nut and the rail such that the mount moves relative to the fixed track.

13. The child restraint system of claim 12, further comprising a controller in communication with the motor.

14. The child restraint system of claim 13, further comprising the seat portion, wherein the seat portion is releasably coupled to the base portion at the mount.

15. The child restraint system of claim 14, wherein the fixed track comprises a first curved slot and a second curved slot, and wherein the rail comprises:
a first pin extending into the first curved slot; and
a second pin extending into the second curved slot;
wherein the seat portion is configured to pivot relative to the base portion as the rail slides in the track.

16. The child restraint system of claim 15, wherein the base portion further comprises an accelerometer in communication with the controller, wherein the nut further comprises a position sensor in communication with the controller, and wherein the controller is configured to determine an angle of the seat portion coupled to the mount based on the output from the accelerometer and the position sensor.

17. The child restraint system of claim 12, wherein the rail comprises a first rail and the mount comprises a first mount, and wherein the base portion further comprises:
a second fixed track; and
a second rail slidably retained in the second fixed track, wherein the second rail comprises a second mount for interfacing with the seat portion, and wherein the nut is connected to the second rail.

18. The child restraint system of claim 12, wherein the base portion further comprises:
a drive system intermediate the motor and the drive screw;
a spring configured to bias the motor into engagement with the drive system; and
a lever configured to move the motor, wherein the motor is movable between an engaged position and a disengaged position relative to the drive system.

19. The child restraint system of claim 18, wherein the base portion further comprises a knob for manually rotating the drive screw.

20. The child restraint system of claim 19, wherein the knob is positioned in a compartment of the base portion, wherein the base portion further comprises a hinged door operably covering the compartment, and wherein the hinged door is coupled to the lever such that movement of the hinged door moves the motor from the engaged position to the disengaged position.

21. A child restraint system, comprising:
a seat portion, comprising:
a body; and
an adjustable mount at least partially embedded in the body, wherein the adjustable mount is rotatable through a range of positions;
a lock for securing the adjustable mount in one of at least two positions; and
a child-restraining harness comprising a central strap, wherein the central strap extends from the adjustable mount.

22. The child restraint system of claim 21, wherein a recess is defined in the body, and wherein the adjustable mount comprises a body portion configured to pivot in the recess.

23. The child restraint system of claim 22, wherein the body portion further comprises a first end and a second end, wherein the first end comprises the lock, and wherein the central strap extends from the second end.

24. The child restraint system of claim 23, wherein the lock further comprises a spring-loaded button.

25. The child restraint system of claim 21, wherein the at least two positions comprises a first position and a second position, and wherein the first position is 180 degrees offset from the second position.

26. The child restraint system of claim 21, wherein the harness comprises a five-point harness.

27. The child restraint system of claim 26, wherein the five-point harness comprises:
a first shoulder strap comprising a first accelerometer configured to detect an exit angle of the first shoulder strap from the body; and
a second shoulder strap comprising a second accelerometer configured to detect an exit angle of the second shoulder strap from the body.

28. The child restraint system of claim 21, wherein the harness further comprises a buckle, and wherein the buckle comprises a buckle sensor.

29. The child restraint system of claim 21, further comprising a tension sensor engaged with the harness, wherein the tension sensor is configured to detect whether the harness has been tensioned.

30. The child restraint system of claim 29, wherein the tension sensor comprises a switch.

31. The child restraint system of claim 21, wherein the body further comprises a spring-loaded pad engaged with a sensor for detecting the presence of a child in the seat portion.

32. A child restraint system, comprising:
a base portion, comprising:
a first mount;
a base electrical connector; and
a first circuit device coupled to the base electrical connector; and
a seat portion, comprising:
a second circuit device;
a second mount configured to releasably engage the first mount to connect the seat portion to the base portion; and
a seat electrical connector configured to mate with the base electrical connector when the second mount is engaged with the first mount to form an electrical path from the first circuit device to the second circuit device.

33. The child restraint system of claim 32, wherein the second circuit device comprises a sensor.

34. The child restraint system of claim 33, wherein the first circuit device comprises a power supply.

35. The child restraint system of claim 34, wherein the first circuit device comprises a controller.

36. The child restraint system of claim 35, wherein the seat electrical connector comprises:
a first connector, wherein the first connector is configured to mate with the base electrical connector when the seat portion is in a first orientation relative to the base portion; and
a second connector, wherein the second connector is configured to mate with the base electrical connector when the seat portion is in a second orientation relative to the base portion.

37. A child restraint system, comprising:
a seat portion, comprising:
a frame comprising a back support;
a belt extending along the back support, wherein the belt comprising a first end and a second end, wherein the second end comprises a latch, and wherein the latch protrudes from the frame;
a spool, wherein the first end of the belt is connected to the spool, wherein a rotation of the spool in a first direction is configured to wind the belt around the spool to retract the latch toward the frame, and wherein a rotation of the spool in a second direction is configured to unwind the belt from the spool to extend the latch from the frame; and
a lock configured to restrict rotation of the spool in the second direction.

38. The child restraint system of claim 37, wherein the lock comprises a ratchet engaged with the spool.

39. The child restraint system of claim 38, wherein the seat portion further comprises a clamp, and wherein the belt extends through the clamp.

40. The child restraint system of claim 39, wherein the seat portion further comprises an actuator configured to release the lock and unclamp the clamp.

41. The child restraint system of claim 37, wherein the seat portion further comprises:
an actuator;
a moveable rod positioned in the seat portion and engaged with the belt; and
a secondary belt extending between the actuator and the retractable rod, wherein an actuation of the actuator is configured to move the moveable rod within the seat portion to draw the latch toward the spool.
